(19) United States
(12) Patent Application Publication
(10) Pub. No.: US 2023/0098465 A1
(43) Pub. Date: Mar. 30, 2023

(54) METHOD OF FORMING AN IMPACT WELD

(71) Applicant: Ohio State Innovation Foundation, Columbus, OH (US)

(72) Inventors: Glenn DAEHN, Columbus, OH (US); Anupam VIVEK, Columbus, OH (US); Jackson PECK, Columbus, OH (US); Stanley BOVID, Columbus, OH (US)

(21) Appl. No.: 17/787,001

(22) PCT Filed: Dec. 18, 2020
(86) PCT No.: PCT/US2020/066155

§ 371 Date: Jun. 17, 2022

Related U.S. Application Data
(60) Provisional application No. 62/951,881, filed on Dec. 20, 2019.
(60) Provisional application No. 62/951,882, filed on Dec. 20, 2019.

(51) Int. Cl. B23K 11/11; B23K 20/08; B23K 26/322; B23K 26/323

(52) U.S. Cl. CPC B23K 11/11; B23K 20/08; B23K 26/322; B23K 26/323; B23K 2103/20

(57) ABSTRACT

Disclosed are methods of forming an impact weld between different metal parts. Also disclosed herein are welded products exhibiting high strength. Also disclosed herein are systems for making such welded products.

### CROSS-REFERENCE TO RELATED APPLICATIONS

This application claims the benefit of U.S. Provisional Application No. 62/951,881, filed Dec. 20, 2019, and U.S. Provisional Application No. 62/951,882, filed Dec. 20, 2019, the contents of which are incorporated herein by reference in its entirety.

### STATEMENT REGARDING FEDERALLY SPONSORED RESEARCH OR DEVELOPMENT

This invention was made with government support under Grant No. 06-49-06019, awarded by the Economic Development Administration (EDA) of the U.S. Department of Commerce. The government has certain rights in the invention.

### FIELD

The present invention relates generally to metal welded products and methods for making the same. The present invention also relates to welding systems used to produce the disclosed welded products.

### BACKGROUND

Driven by the need to achieve bodyweight reduction as well as an increasingly more complex design of various vehicles, air- and spacecraft, it is desirable to employ multi-material design, replacing more conventional low-carbon mild steels with a variety of advanced and ultra-high-strength steels including dual-phase, high-strength low-alloy (HSLA), and boron, and also extensively integrating light metals, such as aluminum alloys. The hybrid use of these lighter yet stronger alloys in body-in-white applications has become more relevant and practical in realizing the larger goal of lightweighting without compromising safety and performance. Successful implementation of multi-material construction depends on the development of dependable and strong dissimilar joints.

Heat treatable 6XXX series Al alloys are one of the most widely employed varieties of Al in the automotive industry, propelled by their attractive properties like high strength, good formability and weldability, and corrosion resistance. These alloys typically find applications where high section stiffness and low mass are required, and the alloys are used in sheet and extrusion form. High-pressure vacuum die-cast Al alloys are being increasingly incorporated into vehicle designs as a result of the improved castability of the new high silicon aluminum alloys, enabling lighter weight and stiffer assemblies. High-pressure vacuum die-cast Al alloys are being employed in the front shock tower, hinge pillar and rear mid-rail components. HSLA steels (bare/coated), due to attractive properties like enhanced ductility and high strength-to-weight ratios, are considered perfect candidates for structural material application in vehicles and find applications as front rails for frontal impact.

However, direct welding of Al and steel by conventional fusion welding techniques like resistance spot welding is difficult due to various reasons that are well known in the field. Mechanical fastening techniques like flow drilling screws, self-piercing riveting, etc., have been successfully used for Al-steel joining; but there are stack-up feasibility limitations, and the use of an externally-exposed joining element in the form of screws and rivets can further increase joint susceptibility to galvanic corrosion.

Thus, there is a need for methods to directed welding such materials. Further, there is a need to provide a weld that can withstand harsh operation conditions without failure. These needs and other needs are at least partially satisfied by the present invention.

### SUMMARY

The present disclosure is generally directed to a method for producing an impact weld between a first metal part and a second metal part, comprising: providing the first metal part having a first surface and an opposed second surface; wherein the first metal part has a first central axis positioned along the length of the first metal part; providing the second metal part having a first surface and an opposed second surface; wherein the second metal part has a second central axis positioned along the length of the second metal part; wherein the first metal part has a thickness t₁ and density ρ₁ that are substantially similar or smaller than a thickness t₂ and density ρ₂ of the second metal part respectively; positioning the first surface of the first metal part to overlay the second surface of the second metal part such that i) substantially no gap is formed between at least a first portion of the first surface of the first metal part and at least a second portion of the second surface of the second metal part; or ii) wherein a gap having up a height h₁≤t₁ is formed between the at least the first portion of the first surface of the first metal part and the at least the second portion of the second surface of the second metal part; wherein the first portion is defined by a first dimension and wherein the second portion is defined by a second dimension; positioning an auxiliary multilayer member having a third dimension such that a first layer of the auxiliary multilayer member at least partially overlays at least a portion of the second surface of the first metal part and wherein the third dimension is projected onto a plane parallel to the first surface of the first metal part and is within the first dimension of the first portion; accelerating an outer surface of the first layer of the auxiliary multilayer member that at least partially overlays at least a portion of the second surface of the first metal part, thereby directing the first portion of the first surface of the first metal part toward the second portion of the second surface of the second metal part to form a metallurgical bond; wherein the auxiliary multilayer member is consumable; and wherein the first surface of the second metal part substantially is not altered after the metallurgical bond is formed.

In further aspects, also disclosed herein is a welded product comprising: a first metal part having a first surface and an opposed second surface, and having a thickness from about 1 mm to about 3 mm; a second metal part having a first surface and an opposed second surface, and having a thickness from about 1 mm to about 3 mm; wherein a portion of the first surface of the first metal part is metallurgically welded to a portion of the second surface of the second metal part; wherein the first surface of the second metal part is substantially flat; and wherein the welded product exhibits an average failure load from 10 kN to 50 kN.

Also disclosed herein is an auxiliary multilayer member having an overall predetermined dimension and configured to assist in a welding process comprising: a first layer having a first dimension and comprising an ablating material, wherein the first layer is configured to be positioned on an outermost surface of a first metal part; a second layer having a second dimension and comprising aluminum, steel, copper, magnesium, zinc, or any combination thereof, wherein the second layer is configured to be positioned between an inner surface of the first metal part and an inner surface of a second metal part; and wherein the first layer is configured to absorb the energy needed to form a metallurgical bond between the inner surface of the first metal part and the inner surface of the second metal part.

Still further, also disclosed herein is a system comprising: a first member comprising: a body having a central axis along a length of the body and a first surface, wherein at least a portion of the surface defines a recess having a first dimension and comprising two or more segments, wherein the segments are not substantially symmetrical to each other in a plane bisecting the recess; and a second member comprising: a mount having a second dimension configured to be substantially fit within the recess; a first metal part and a second metal part wherein the second metal part has at least a portion positioned within the recess and having a third dimension substantially identical to the first dimension; and wherein the first metal part is positioned on a surface of the body such that it has at least one point of contact with the surface of the body outside of the recess; and wherein at least a portion of the first metal part is disposed above at least a portion of the second metal part that is positioned within the recess; an auxiliary multilayer member having a fourth dimension such that a first layer of the auxiliary multilayer member at least partially overlays at least a portion of an outermost surface of the first metal part; and wherein the second member is configured to be positioned such that it overlays the first member. In still further aspects, the systems disclosed herein can also comprise an energy source configured to be in electrical communication with at least an auxiliary multilayer member.

Also disclosed herein is a system comprising: a) a first metal part having a first surface and an opposed second surface; wherein the first metal part has a first central axis positioned along the length of the first metal part; b) a second metal part having a first surface and an opposed second surface; wherein the second metal part has a second central axis positioned along the length of the second metal part; wherein the first metal part has a thickness t₁ and density ρ₁ that are substantially similar or smaller than a thickness t₂ and density ρ₂ of the second metal part respectively; wherein the first surface of the first metal part overlays the second surface of the second metal part such that i) substantially no gap is formed between at least a first portion of the first surface of the first metal part and at least a second portion of the second surface of the second metal part; or ii) wherein a gap having up a height h₁≤t₁ is formed between the at least the first portion of the first surface of the first metal part and the at least the second portion of the second surface of the second metal part; wherein the first portion is defined by a first dimension and wherein the second portion is defined by a second dimension; c) an auxiliary multilayer member having a third dimension such that a first layer of the auxiliary multilayer member at least partially overlays at least a portion of the second surface of the first metal part and wherein the third dimension is projected onto a plane parallel to the first surface of the first metal part and is within the first dimension of the first portion; and d) an energy source configured to accelerate an outer surface of the first layer of the auxiliary multilayer member that at least partially overlays at least a portion of the second surface of the first metal part and to direct the first portion of the first surface of the first metal part toward the second portion of the second surface of the second metal part and thereby to form a metallurgical bond.

Also disclosed herein is a method for producing an impact weld between a first metal part and a second metal part, comprising: providing a first metal part having a first surface and an opposed second surface and a second metal part having a first surface and an opposed second surface; positioning the first metal part and the second metal part such that the first surface of the first metal is facing the second surface of the second metal part and wherein a first portion of the first surface of the first part and a first portion of the second surface of the second metal part form a gap; wherein the first portion of the first surface is defined by a first area and the first portion of the second surface is defined by a second area; directing an energy source to the second surface of the first metal part at a predetermined location, such that the energy emitted from the energy source is applied to a second portion of the second surface of the first metal part, wherein the second portion of the second surface is defined by the first area when it is projected to the second surface; and accelerating the first a portion of the first surface across the gap to form a metallurgical bond with the first portion of the second surface of the second metal part.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### BRIEF DESCRIPTION OF FIGURES

FIGS. 1A-1E depict (FIG. 1A) welding setup depicting arrangement for welding in lap-shear configuration, (FIG. 1B) geometry and dimensions of the foil actuator used and (FIG. 1C), (FIG. 1D) and (FIG. 1E) schematic cross-sections depicting welding configurations for the different material pairs. (Schematics not drawn to scale).

FIG. 2 depicts an optical micrograph depicting damage to the flyer in the machined pocket region for a square shape during trials.

FIGS. 3A-3C depict (FIG. 3A) weld spot and foil orientation for lap-shear and coach peel samples (FIG. 3B), (FIG. 3C) shape and dimensions of the spot weld geometries for lap-shear and coach peel samples, respectively.

FIGS. 4A-4C depict representative load-displacement curves for (FIG. 4A) lap-shear samples for AA61111-T4-HSLA 340 material pairs, (FIG. 4B) coach peel samples for AA6111-T4-HSLA 340 material pairs and (FIG. 4C) lap-shear samples for Aural 2-HSLA 340 material pair. (The load-displacement curves for the similar Al—Al joints have also been provided in the figures).

FIGS. 5A-5D depict load-displacement curves in the lap-shear configuration for (FIG. 5A) AA6111-T4-AA6111-T4pair, (FIG. 5B) AA6111-T4-HSLA 340 bare pair, (FIG. 5C) AA6111-T4-HSLA 340 HDGI pair and (FIG. 5D) AA6111-T4-HSLA 340 e-coated pair.

FIGS. 6A-6C depict load-displacement curves in the lap-shear configuration for (FIG. 6A) Aural 2-Aural 2 pair with no interlayer, (FIG. 6B) Aural 2-Aural 2 pair with interlayer, and (FIG. 6C) Aural 2-HSLA 340 HDGI pair.

FIGS. 7A-7D depict load-displacement curves in coach peel configuration for (FIG. 7A) AA6111-T4-AA6111-T4 pair, (FIG. 7B) AA6111-T4-HSLA 340 bare pair, (FIG. 7C) AA6111-T4-HSLA 340 HDGI pair and (FIG. 7D) AA6111-T4-HSLA 340 e-coated pair.

FIGS. 8A-8F depict representative failure modes for the welded material pairs in the lap-shear configuration.

FIGS. 9A-9D depict representative failure modes for the welded material pairs in coach peel configuration.

FIGS. 10A-10C depict failure load and energy absorption summary for (FIG. 10A), (FIG. 10B) AA6111-T4-HSLA 340 material pairs for lap-shear and coach peel configurations, respectively and (FIG. 10C) Aural 2-HSLA 340 material pair in the lap-shear configuration. (The strength of the similar Al—Al joint has also been compared).

FIGS. 11A-11C depict micrographs of the weld cross-section for (FIG. 11A) AA6111-T4-AA6111-T4 pair, (FIG. 11B) Aural 2-Aural 2 pair (without interlayer), and (FIG. 11C) Aural 2-Aural 2 pair (with interlayer).

FIGS. 12A-12E depict (FIG. 12A) a schematic diagram depicting the direction in which the welded samples were cross-sectioned (FIG. 12B) to (FIG. 12E) macrographs of the weld cross-section for the different material pairs.

FIGS. 13A-13B depict views of the welded specimens depicting the damage-free top and bottom surfaces post welding for (FIG. 13A) AA6111-T4-HSLA 340 e-coated pair and (FIG. 13B) Aural 2-HSLA 340 HDGI stack up.

FIGS. 14A-14D depict (FIG. 14A) schematic cross-section depicting the welding configuration along with the arrangement of the foil, materials, and the asymmetric backing die, (FIG. 14B) schematic showing an arrangement for welding in lap-shear configuration, and (FIG. 14C), (FIG. 14D) representative images of welded samples in lap-shear and coach-peel configuration respectively. (Schematics not drawn to scale)

FIGS. 15A-15D depict (FIG. 15A), (FIG. 15B) representative load-displacement curves and photographs of corresponding failed samples for lap-shear and coach-peel configuration, respectively, and (FIG. 15C), (FIG. 15D) failure load summary for the welded material pairs for lap-shear and coach-peel configuration, respectively. (The strength of the similar Al—Al joint has been compared and represented by horizontal lines in (FIG. 15C) and (FIG. 15D).

FIGS. 16A-16C depict load-displacement curves in the lap-shear configuration for (FIG. 16A) AA 6022 T4-HSLA 350 pair, (FIG. 166) AA 6022 T4-DP 590 pair and (FIG. 16C) AA 6022 T4-AA 6022 T4 pair.

FIGS. 17A-17C depicts load-displacement curves in peel configuration for (FIG. 17A) AA 6022 T4-HSLA 350 pair, (FIG. 17B) AA 6022 T4-DP 590 pair and (FIG. 17C) AA 6022 T4-AA 6022 T4 pair.

FIGS. 18A-18B depict comparison of failure loads of VFAW spot joints with other joining techniques for lap-shear and coach-peel configurations, respectively (numbers on top of the bars indicate thickness (in mm) of the Al sheet).

FIGS. 19A-19D depict (FIG. 19A), (FIG. 19C) macrographs of the AA 6022 T4-HSLA 350 and AA 6022 T4-DP 590 weld cross-sections respectively depicting the hierarchical structure of the welded interface and (FIG. 19B), (FIG. 19D) sectional micrographs of different positions of the welded members marked in (FIG. 19A) and (FIG. 19C).

FIGS. 20A-20D depict (FIG. 20A) schematic cross-section depicting the welding configuration employed, (FIG. 20B), (FIG. 20C) geometry and dimensions of the foil actuator and weld specimen, respectively and (FIG. 20D) weld spot and foil orientation for lap-shear samples.

FIGS. 21A-21B depict (FIG. 21A) load-displacement curves for tested samples and (FIG. 21B) tested samples depicting the failure modes.

FIG. 22 depicts a comparison of failure loads of VFAW spot joints with other joining techniques.

FIG. 23 depicts a schematic view of one exemplary system for producing the disclosed weld in one embodiment.

FIG. 24 depicts a schematic view of one exemplary system for producing the disclosed weld in one aspect.

FIG. 25 depicts a schematic view of one exemplary system for producing the disclosed weld in one aspect.

FIG. 26 depicts a photograph of parts of an exemplary system in one aspect.

FIG. 27 depicts a schematic of parts of an exemplary system in one aspect.

FIG. 28 depicts a schematic of parts of an exemplary system in one aspect.

FIG. 29 depicts a schematic of exemplary method variations.

FIG. 30 depicts a schematic of an exemplary method in one aspect and a photograph of welded parts in one aspect.

FIG. 31 depicts a schematic view of one exemplary system for producing the disclosed weld in one aspect.

FIG. 32 depicts a schematic view of one exemplary system for producing the disclosed weld in one aspect.

FIG. 33 depicts a schematic view of one exemplary system for producing the disclosed weld in one aspect.

FIG. 34 depicts photographs of exemplary welds obtained by the disclosed herein methods.

FIG. 35 depicts a schematic view of an exemplary auxiliary multilayer member in one aspect.

FIG. 36 depicts a schematic view of one exemplary system for producing the disclosed weld in one aspect.

FIG. 37 depicts a schematic view of an exemplary process of making an exemplary flyer.

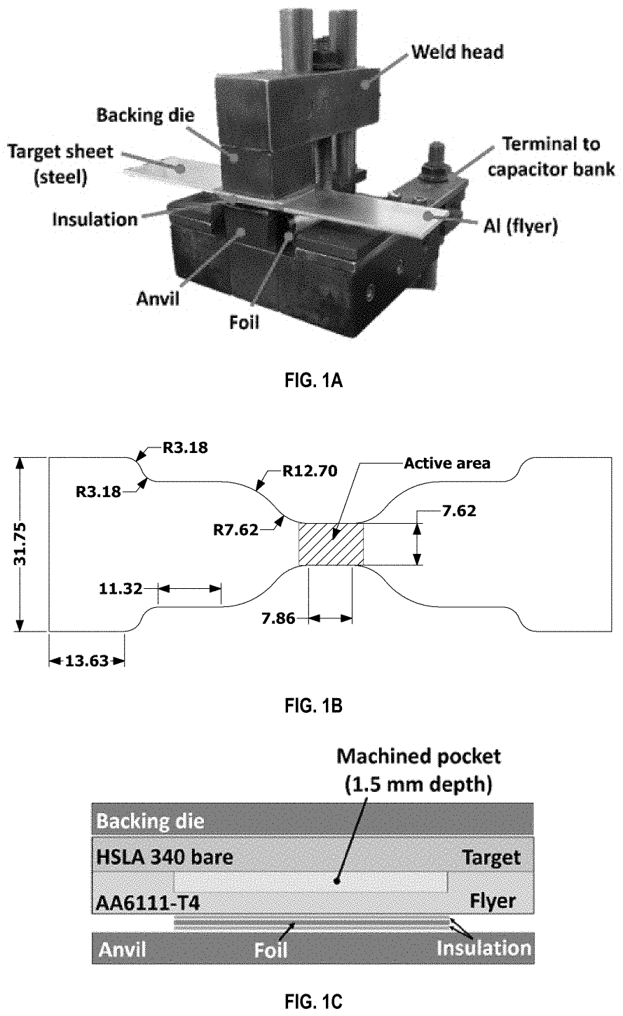

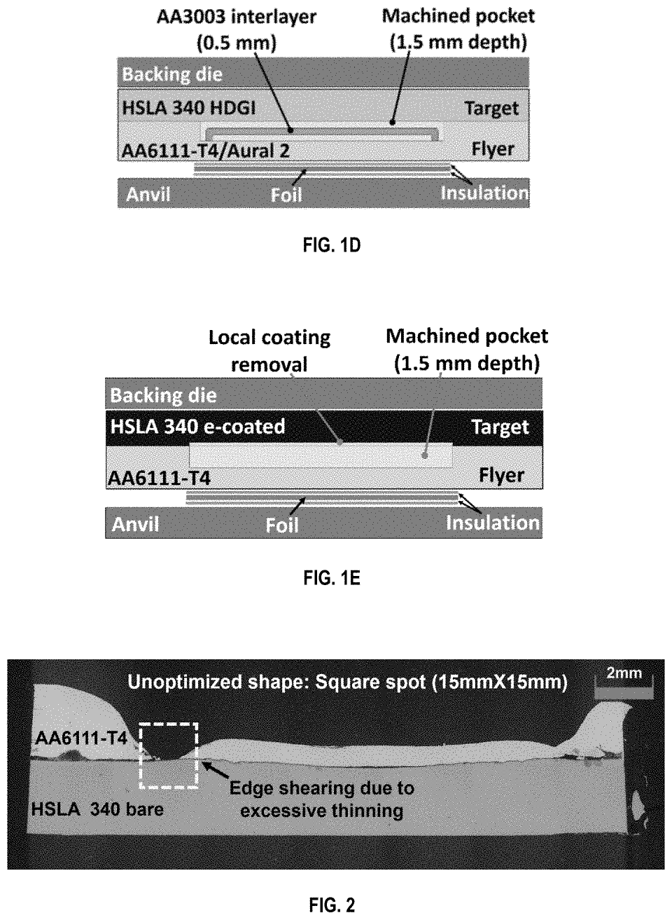

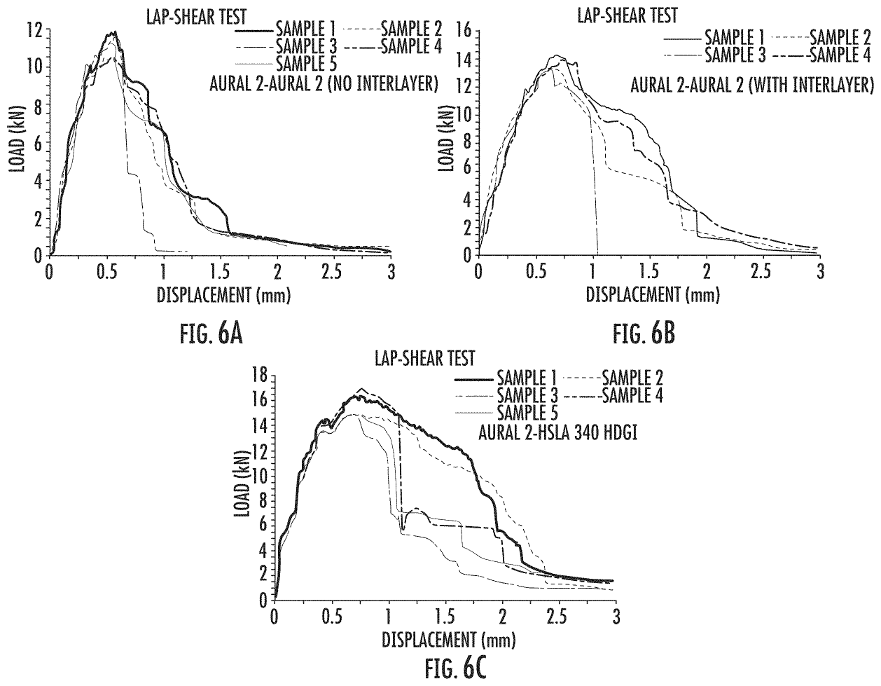

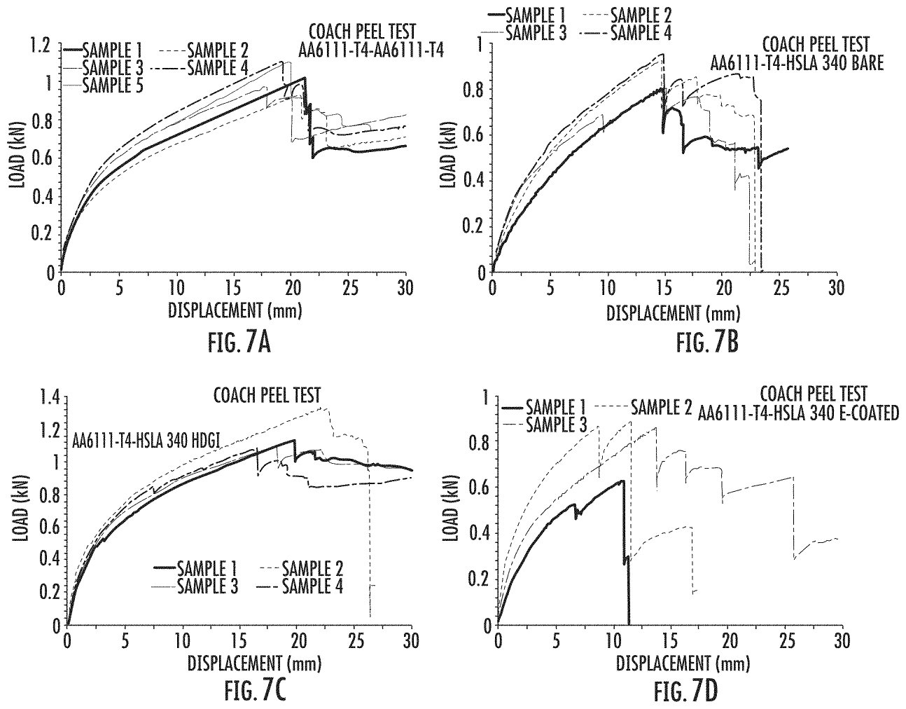

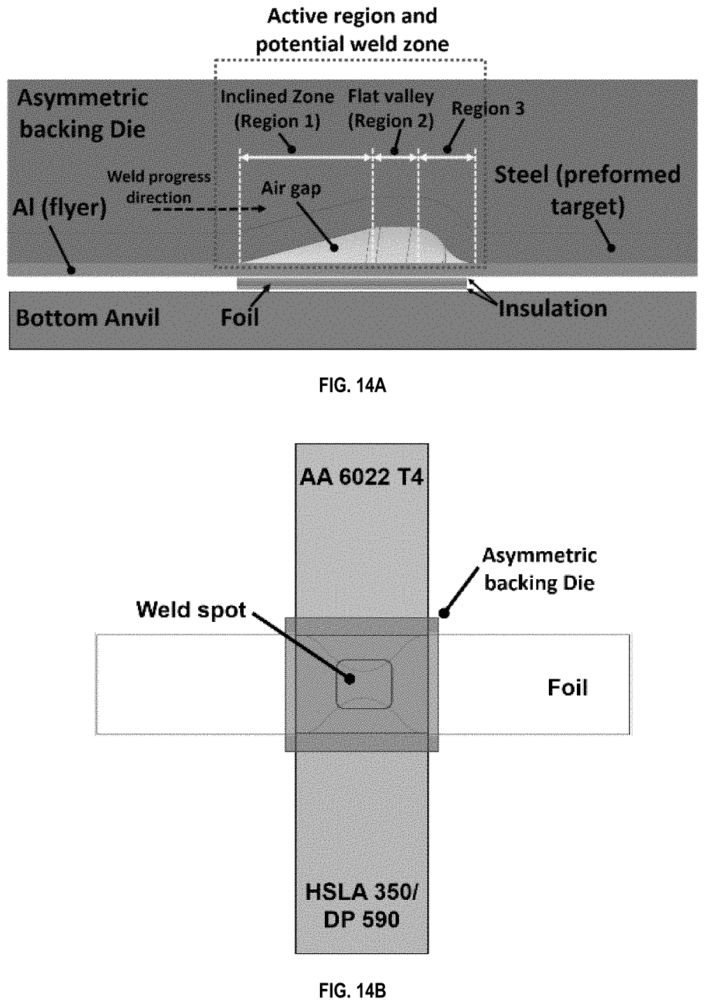

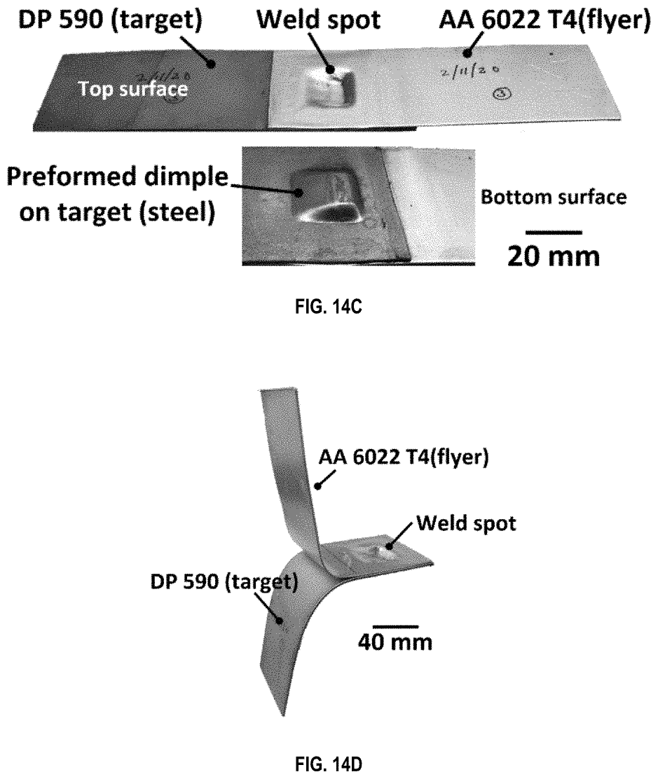

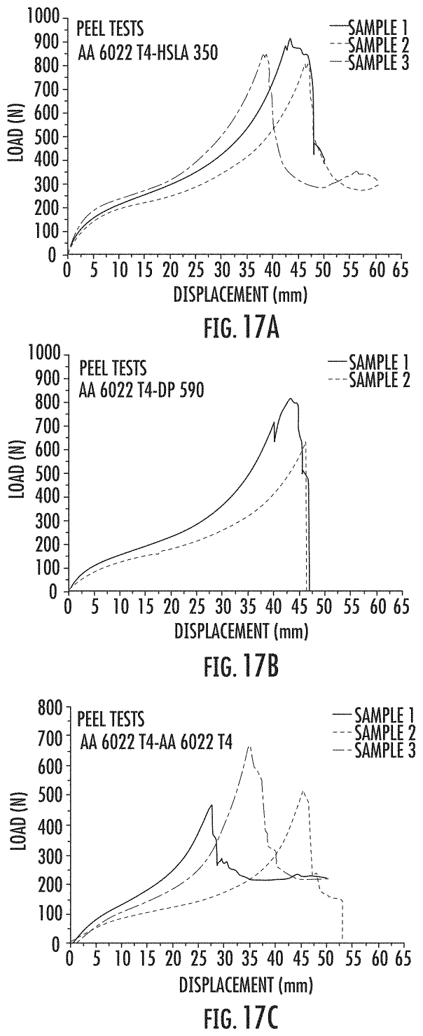

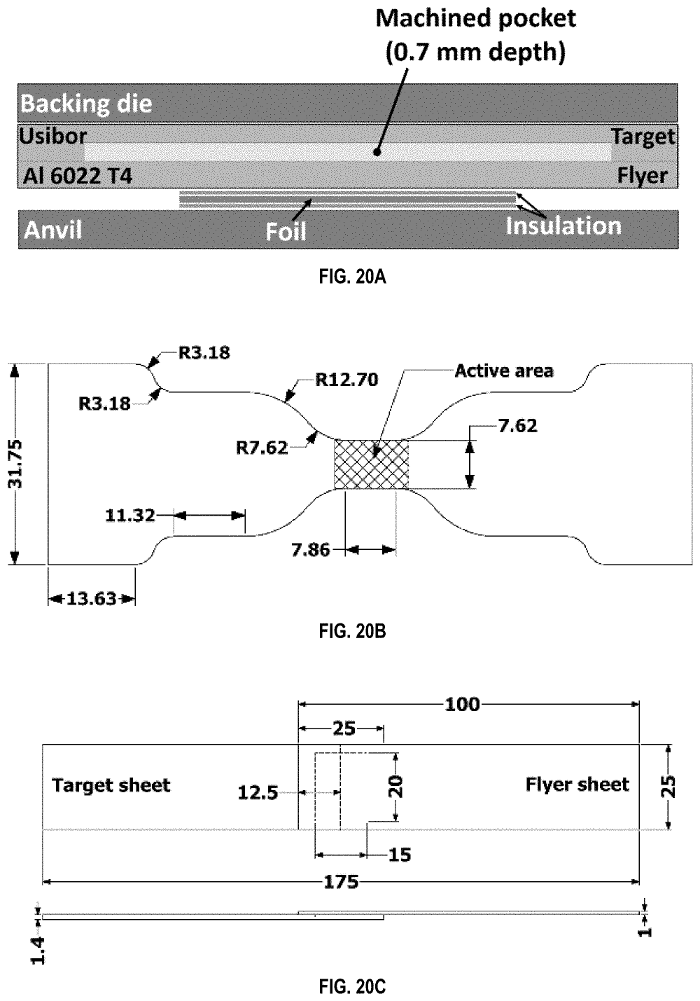

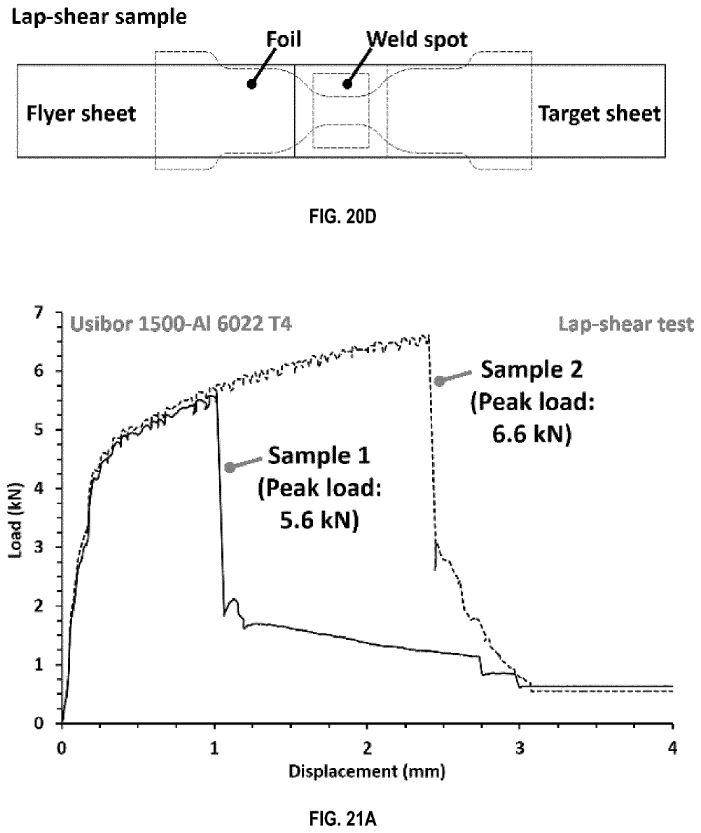

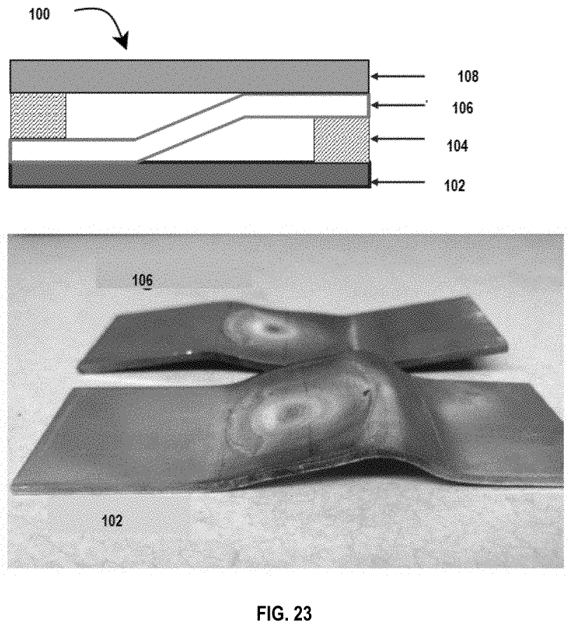

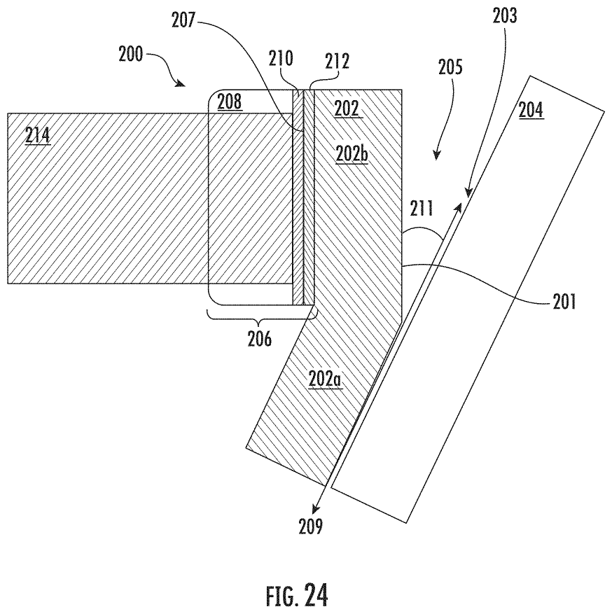

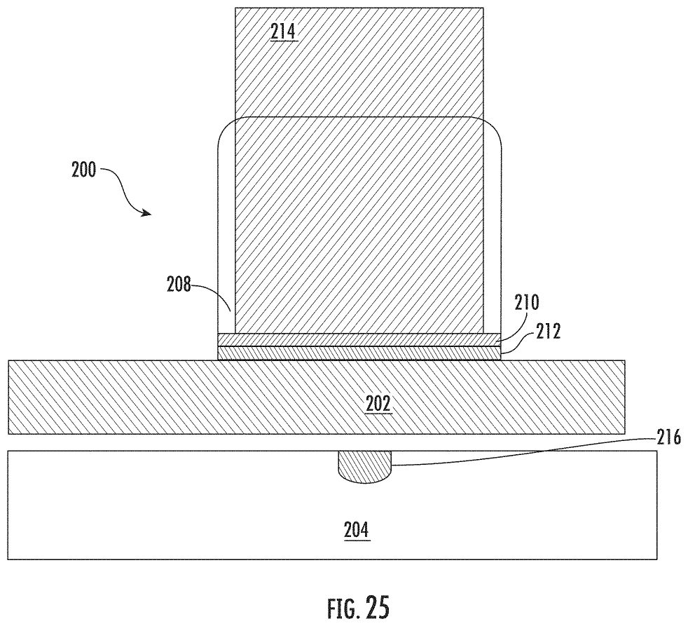

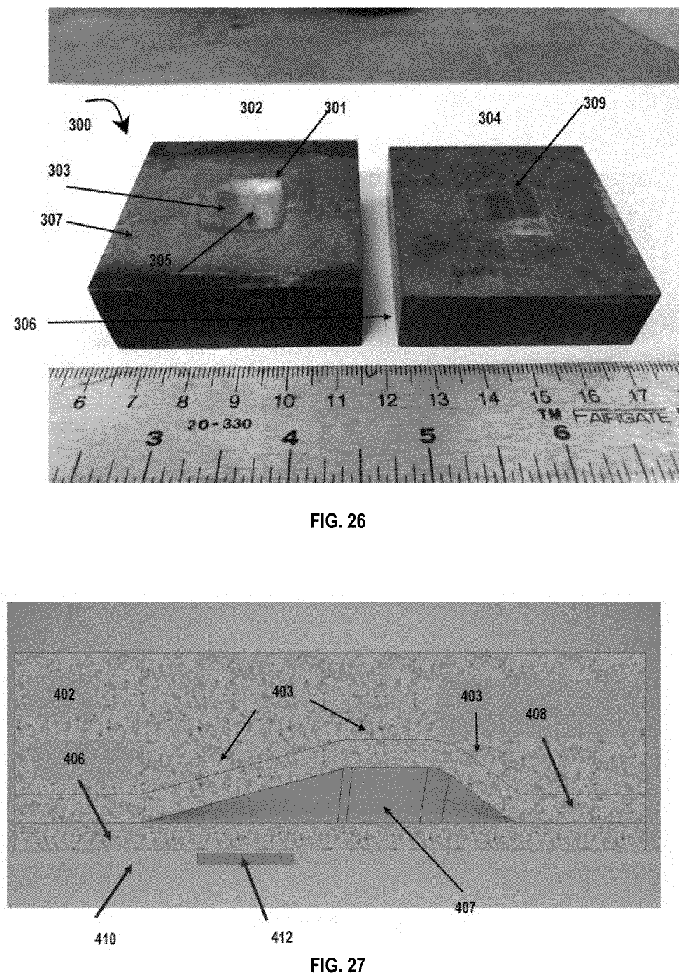

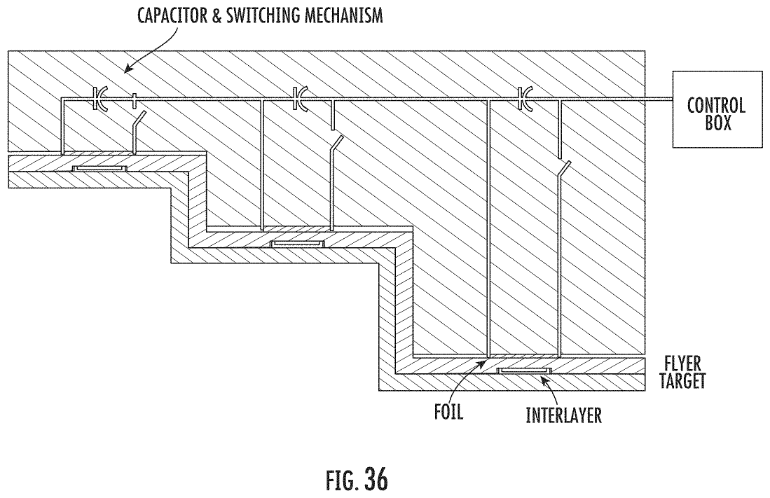

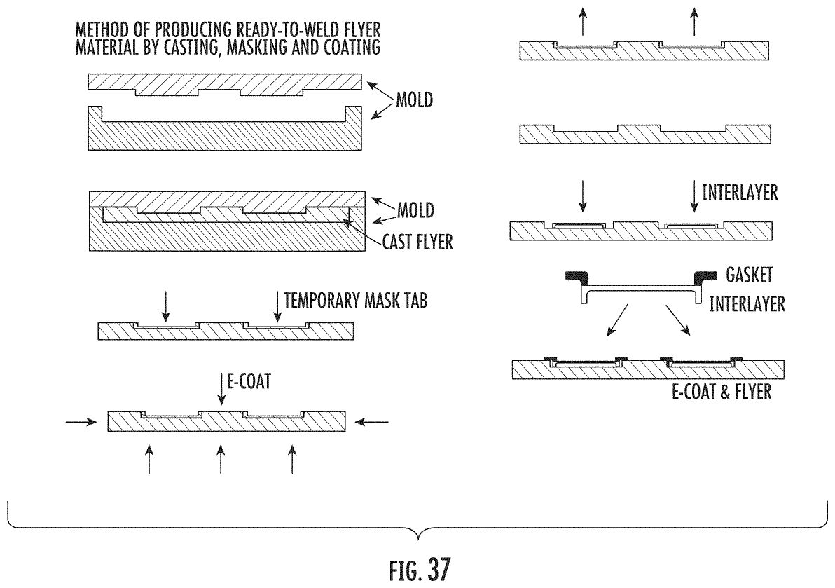

FIGS. 1A-13B are directed to Example 1, a new approach for dissimilar aluminum-steel impact spot welding using vaporizing foil actuators. FIGS. 14A-19D are directed to Example 2, enabling dissimilar joining of coated steels to aluminum through impact spot welding. FIGS. 20A-22 are directed to Example 3, joining aluminum alloy to ultrahigh-strength boron steel through an impact welding approach. FIG. 23 is directed to Example 4, FIGS. 24 and 25 are directed to Example 5, FIGS. 26-34 are directed to Example 6, FIG. 35 is directed to Example 7 and FIGS. 36 and 37 are directed to Example 8.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

In this specification and in the claims that follow, reference will be made to a number of terms, which shall be defined to have the following meanings:

As used herein, the terms “optional” or “optionally” means that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a metal part” includes two or more such metal parts, reference to “an energy source” includes two or more such energy sources and the like.

Throughout the description and claims of this specification, the word “comprise” and other forms of the word, such as “comprising” and “comprises,” means including but not limited to, and is not intended to exclude, for example, other additives, components, integers, or steps. Furthermore, it is to be understood that the terms comprise, comprising and comprises as they related to various aspects, elements and features of the disclosed invention also include the more limited aspects of “consisting essentially of” and “consisting of.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items.

It will be understood that, although the terms “first,” “second,” etc., may be used herein to describe various elements, components, regions, layers and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein interpreted accordingly.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to indicate that the recited component is not intentionally batched and added to the composition, but can be present as an impurity along with other components being added to the composition. In such aspects, the term “substantially free” is intended to refer to trace amounts that can be present in the batched components, for example, it can be present in an amount that is less than about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation. Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may, in some cases, be rearranged or performed concurrently. Further, descriptions and disclosures provided in association with one particular embodiment are not limited to that embodiment and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

### Methods of Forming an Impact Weld

As summarized above, disclosed herein is a method for producing an impact weld between a first metal part and a second metal part, comprising: providing the first metal part having a first surface and an opposed second surface; wherein the first metal part has a first central axis positioned along the length of the first metal part; providing the second metal part having a first surface and an opposed second surface; wherein the second metal part has a second central axis positioned along the length of the second metal part; wherein the first metal part has a thickness t₁ and density ρ₁ that are substantially similar or smaller than a thickness t₂ and density ρ₂ of the second metal part respectively; positioning the first surface of the first metal part to overlay the second surface of the second metal part such that i) substantially no gap is formed between at least a first portion of the first surface of the first metal part and at least a second portion of the second surface of the second metal part; or ii) wherein a gap having up a height h₁≤t₁ is formed between the at least the first portion of the first surface of the first metal part and the at least the second portion of the second surface of the second metal part; wherein the first portion is defined by a first dimension and wherein the second portion is defined by a second dimension; positioning an auxiliary multilayer member having a third dimension such that a first layer of the auxiliary multilayer member at least partially overlays at least a portion of the second surface of the first metal part and wherein the third dimension is projected onto a plane parallel to the first surface of the first metal part and is within the first dimension of the first portion; accelerating an outer surface of the first layer of the auxiliary multilayer member that at least partially overlays at least a portion of the second surface of the first metal part, thereby directing the first portion of the first surface of the first metal part toward the second portion of the second surface of the second metal part to form a metallurgical bond; wherein the auxiliary multilayer member is consumable; and wherein the first surface of the second metal part substantially is not altered after the metallurgical bond is formed.

In still further aspects, the product of the thickness and the density can affect the effectiveness of the methods disclosed herein.

It is understood that in some aspects, both the thickness and the density of each metal part can affect the formed metallurgical bond.

It is further understood that the methods disclosed herein can be used for welding the metal parts having different surface finishes. For example, and without limitations, in some aspects, at least a portion of the second portion of the second surface of the second metal part is substantially flat. In yet other aspects, any portion of the second surface of the second metal part can be substantially flat.

Yet, in other aspects, at least a portion of the second portion of the second surface of the second metal part is has a roughness having an aspect ratio smaller than or equal to t₁. In yet other aspects, any portion of the second surface of the second metal part can have a roughness having an aspect ratio smaller than or equal to t₁. It is understood that the roughness, as disclosed herein, can be a natural characteristic of the metal that was not polished or processed, for example. Yet, in other aspects, the roughness can be intentionally introduced. Yet, in still further aspects, the roughness can be a part of the metal part design. In still further aspects, the roughness can have any desired shape. For example, and without limitations, the roughness can have a saw-like shape.

In still further aspects, the step of accelerating can comprise imparting to at least a portion of the auxiliary multilayer member and at least a portion of the first metal part a speed from about 200 m/s to about 800 m/s, including exemplary values of about 250 m/s, about 300 m/s, about 350 m/s, about 400 m/s, about 450 m/s, about 500 m/s, about 550 m/s, about 600 m/s, about 650 m/s, about 700 m/s, and about 750 m/s towards at least a portion of the second metal.

Also disclosed herein are the methods further comprising a step of accelerating the first surface of the second metal part. In such aspects, the step of accelerating the first surface of the second metal part comprises imparting to at least a portion of the second metal part a speed from about 200 m/s to about 800 m/s, including exemplary values of about 250 m/s, about 300 m/s, about 350 m/s, about 400 m/s, about 450 m/s, about 500 m/s, about 550 m/s, about 600 m/s, about 650 m/s, about 700 m/s, and about 750 m/s.

Without wishing to be bound by any theory, it is understood that imparting such a high speed to the colliding parts allows obtaining a strong metallurgical bond.

It is also understood that in some aspects, where the step of accelerating the first surface of the second metal part also occurs, the method can comprise the use of an additional auxiliary multilayer member disposed on the first surface of the second metal part. Yet, in other aspects, accelerating the first surface of the second metal part can occur without the use of the add additional auxiliary multilayer member disposed on the first surface of the second metal part.

In still further aspects, the accelerating the first surface of the second metal part is done simultaneously with the accelerating of the outer surface of the first layer of the auxiliary multilayer member. While in other aspects, it is done consequently in any order. For example, in some aspects, first, the accelerating of the outer surface of the first layer of the auxiliary multilayer member is performed, which is followed by accelerating the first surface of the second metal part. Yet, in other aspects, it can also be done in a different order.

In still further aspects, the accelerating of either surface can comprise utilizing an energy source. In such exemplary and unlimiting aspects, the energy source can comprise an electrical current, laser, electromagnetic source, detonation of an explosive and/or energetic material, electromagnetic repulsion, projectile of gun powder, spring projectile, or a combination thereof. In some aspects, the energy source is a capacitor or a plurality of capacitor banks arranged to be in communication with one or more auxiliary multilayer members. In yet other aspects, the energy source is a laser. It is understood that the energy source used for accelerating the outer surface of the first layer of the auxiliary multilayer member that at least partially overlays at least a portion of the second surface of the first metal part and/or the first surface of the second metal part can be the same or different.

In still further aspects, the energy source can provide energy from about 1 J to about 300 kJ, including exemplary values of about 10 J, about 20 J, about 30 J, about 40 J, about 50 J, about 60 J, about 70 J, about 80 J, about 90 J, about 100 J, about 150 J, about 200 J, about 250 J, about 500 J, about 750 J, about 1 kJ, about 10 kJ, about 20 kJ, about 50 kJ, about 80 kJ, about 100 kJ, about 125 kJ, about 150 kJ, about 180 kJ, about 200 kJ, about 225 kJ, about 250 kJ, and about 280 kJ. It is understood that the energy source can provide energy having a value between any two foregoing values.

In still further aspects, the energy source can provide energy from about 0.1 kJ to about 10 kJ, including the exemplary value of about 0.5 kJ, about 1 kJ, about 1.5 kJ, about 2 kJ, about 2.5 kJ, about 3 kJ, about 3.5 kJ, about 4 kJ, about 4.5 kJ, about 5 kJ, about 5.5 kJ, about 6 kJ, about 6.5 kJ, about 7 kJ, about 7.5 kJ, about 8 kJ, about 8.5 kJ, about 9 kJ, and about 9.5 kJ. It is understood that the energy source can provide energy having a value between any two foregoing values.

In still further aspects, the first and second metal parts can comprise a steel or aluminum alloy. In some aspects, the steel comprises a High-Strength Low-Alloy (HSLA) steel. In yet other aspects, the aluminum alloy comprises Al 6022-T4 or Al6HS2.

In yet other aspects, the t₁ and t₂ can have a thickness from about 1 mm to about 3 mm, including exemplary values of about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, and about 2.9 mm.

In still further aspects, the first surface and/or the second surface of the first metal part and the second metal part can comprise a first coat layer and a second coat layer, respectively.

In certain aspects, the first coat layer and/or the second coat layer can comprise an inorganic material, organic material, or a combination thereof.

In some aspects, when at least a portion of the first surface and the second surface has the first coat layer, the first coat layer of the first surface is the same or different as the first coat layer of the second surface and is selected from an e-coating, a galvanized coating, galvannealed coating, paint, adhesive, sealant, or any combination thereof.

In yet other aspects, when at least a portion of the first surface and the second surface has the second coat layer, the second coat layer of the first surface is the same or different as the second coat layer of the second surface and is selected from an e-coating, a galvanized coating, galvannealed coating, paint, adhesive, sealant or any combination thereof.

It is understood that disclosed herein are the aspects where the first coat layer and the second coat layer are the same. Also disclosed are the aspects where the first coat layer and the second coat layer are different.

Also disclosed herein are aspects where the first coat layer has a thickness from about 10 microns to about 50 microns, including exemplary values of about 15 microns, about 20 microns, about 30 microns, about 35 microns, about 40 microns, and about 45 microns. In still further aspects, the second coat layer can have a thickness from about 10 microns to about 50 microns, including exemplary values of about 15 microns, about 20 microns, about 30 microns, about 35 microns, about 40 microns, and about 45 microns.

It is further understood that the terms “first dimension,” “second dimension,” and “third dimension” refer to the overall spatial shape and representation of the disclosed part. In such aspects, the term “dimension” can comprise various possible surface roughness, and additional features present on the surface or within the referred part, possible bent portions, and the like.

In certain aspects, the first metal part is preformed to the first dimension. Yet, in other aspects, the second metal part is preformed to the second dimension. In still further aspects, the auxiliary multilayer member can be preformed to provide the third dimension that is effective to align the first metal part and the second metal part such that substantially no deformation is furnished to any portion of the first surface and/or the second surface of the first metal part and/or the first surface and/or the second surface of the second metal part outside of the first portion of the first surface of the first metal part and the second portion of the second surface of the second metal part where the metallurgical bond is formed.

In certain aspects, the first dimension of the first metal part can comprise, for example, a first wave initiator feature positioned within the first portion of the first surface of the first metal part. In yet other aspects, the second dimension of the second metal part can comprise a second wave initiator feature positioned within the second portion of the second surface of the second metal part. Yet still, in further aspects, at least a portion of the auxiliary multilayer member comprises a third wave initiator feature positioned at at least one layer such that the third wave initiator feature is disposed between the first and the second portions of the first metal part and the second metal part respectively.

It is understood that in some aspects, only the first wave initiator present. Yet, in other aspects, only the second wave initiator is present. In still other aspects, only the third wave initiator is present. However, also disclosed are aspects where any or all of the wave initiators are present.

In some aspects, the first, second, and/or third wave initiator features can be the same or different and can have a shape of a protrusion, or an indentation positioned anywhere within the first or the second portions, or between the first and the second portion. It is further understood that the wave initiator is not limited by a protrusion or indentation shape and can have any shape that can provide for the desired result.

Also disclosed herein are the methods where the first portion of the first surface of the first metal part is altered prior to the step of providing the first force to decrease a thickness of the first portion as compared to the t₁ of the first metal part. In yet other aspects, the second portion of the second surface of the second metal part can also be altered prior to the step of providing the first force to decrease a thickness of the second portion as compared to the t₂ of the second metal part. It is understood that such a step can be done by any known in the art methods, such as, for example, and without limitation, mechanical polishing, chemical polishing, grinding, sawing, and the like.

In certain exemplary and unlimiting aspects, the first coat layer can be at least partially removed from the first portion of the first surface of the first metal part. While in other aspects, the second coat layer can be at least partially removed from the second portion of the second surface of the second metal part.

Also disclosed herein are aspects where the first metal part and/or the second metal part are annealed prior to the step of accelerating. It is understood that in some aspects, annealing allows softening of the metal parts and thus improves the welding process and/or reduces the propensity for cracking of a deforming body.

In still further aspects, the first portion and/or the second portion are aligned at an angle relative to each other. In yet other aspects, the first portion can be positioned at an angle relative to the central axis of the second portion. While in other aspects, the second portion can be positioned at an angle relative to the central axis of the first portion. It is understood that such an alignment can be achieved by any known in the art methods. In some aspects, the first metal part and the second metal parts can be positioned such that the angle is formed between the first portion and the second portion. In such exemplary aspects, the first and second metal parts can have any shape or design.

In yet other aspects, the first portion can be bent at an angle relative to the first central axis of a reminder of the first metal part. While in other aspects, the second portion can be bent at an angle relative to the second central axis of a reminder of the second metal part. It is understood that in addition to the bend within the first portion and/or the second portion, the first metal part and/or the second metal parts can have additional bends or any other deformations or configurations anywhere within the part. In still further aspects, the second portion can be bent while the first portion is not bent relative to the first central axis of a reminder of the first metal part. Also disclosed are the aspects where the first portion can be bent while the second portion is not bent relative to the second central axis of a reminder of the first, second metal part.

In sone exemplary and unlimiting aspects, the first portion and/or the second portion can also be asymmetrically bent to form two or more segments having one or more angles relative to the first central axis of a reminder of the first metal part and/or the second central axis of a reminder of the second metal part respectively.

Also disclosed are aspects wherein the first portion is aligned and/or bent at an angle relative to the second central axis of the second metal part. Yet, in other aspects, the second portion is aligned and/or bent at an angle relative to the first central axis of the first metal part.

In still further aspects, the alignment/bending angles disclosed herein can be in the range from about 2 to about 40 degrees, including exemplary values of about 5 degrees, about 7 degrees, about 10 degrees, about 12 degrees, about 15 degrees, about 17 degrees, about 20 degrees, about 22 degrees, about 25 degrees, about 27 degrees, about 30 degrees, about 35 degrees, and about 37 degrees, relative to the central axis of the part.

In the aspects where more than one segments are present in the first or the second parts, each segment can have an angle in the range of from about 2 degrees to about 40 degrees, including exemplary values of about 5 degrees, about 7 degrees, about 10 degrees, about 12 degrees, about 15 degrees, about 17 degrees, about 20 degrees, about 22 degrees, about 25 degrees, about 27 degrees, about 30 degrees, about 35 degrees, and about 37 degrees relative to the first central axis of the remainder of the first metal part or to the second central axis of the remainder of the second metal part respectively.

Also disclosed herein are methods where at least one segment of the two or more segments is substantially parallel to the first central axis of a reminder of the first metal part or to the second central axis of the remainder of the second metal part, respectively.

In still further aspects, also the auxiliary multilayer member is preformed to the third dimension such that it substantially conforms to the first portion.

In still further aspects, the energy source is aligned relative to the first portion and/or the second portion such that an energy pulse supplied by the energy source is substantially normal to the first portion and/or the second portion.

In certain aspects, the first layer of the auxiliary multilayer member that at least partially overlays at least a portion of the second surface of the first metal part is an ablative material configured to vaporize during the accelerating step. In some aspects, the first layer of the auxiliary multilayer member can be referred to as a foil. In still some other aspects, the methods comprising of the auxiliary multilayer member having an ablating and vaporizing the first layer can be referred to as vaporizing foil actuator welding or VFAW.

In such exemplary and unlimiting aspects, the first layer of the auxiliary multilayer member can have a thickness from about 10 μm to about 10 mm, including exemplary values of about 15 μm, about 20 μm, about 30 μm, about 50 μm, about 70 μm, about 100 μm, about 150 μm, about 200 μm, about 250 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, and about 9 mm.

In certain aspects, the first layer of the auxiliary multilayer member can comprise any conductive material that can be vaporized under effective conditions. In still further aspects, the first layer of the auxiliary multilayer member can comprise aluminum, steel, copper, magnesium, zinc, or any combination thereof.

In yet other aspects, the outer surface of the first layer of the auxiliary multilayer member can comprise an insulating coating. Any known in the art insulating coatings or layers can be utilized.

In some exemplary and unlimiting aspects, the outer surface of the first layer of the auxiliary multilayer member can also comprise one or more alignment features. It is understood that these alignment features can be used to properly position the first and metal parts relatively to each other such that the first portion and the second portion are reproducibly aligned to provide for the desired metallurgical bond. Any known in the art alignment features can be utilized, for example, the alignment features can comprise markings, shapes such as various protrusions or indentations, apertures, or any combination thereof.

In still further aspects, the auxiliary multilayer member as disclosed herein can further comprise a second layer configured to be positioned between the first portion of the first metal part and the second portion of the metal part. A physical connection between the first layer and the second layer can provide alignment. In certain aspects, the second layer can add other functionalities and multi-functionalities and can be generally be referred to as an interlayer. If the third wave initiator as disclosed above is present, in some aspects, this third wave initiator can be positioned at least at a portion of the second layer of the auxiliary multilayer member such that the third wave initiator is aligned between the first portion of the first metal part and the second portion of the metal part.

In still further aspects, the second layer or the interlayer can comprise any desired material. In certain aspects, the second layer can serve as a spacer to create a gap between the first portion and the second portion. Yet, in other aspects, the second layer can comprise an adhesive material to help adhere to different portions of the different metal parts. In still further aspects, the second layer can comprise sealants, for example, and without limitations, corrosive sealants. In still further aspects, the second layer can comprise an insulator. In still further aspects, the second layer can comprise a metal, adhesive material, sealing material, or any combination thereof.

It is understood that the second layer can have the same shape as the first layer. In yet other aspects, the second layer can have a shape that is different from the first layer.

Also disclosed herein are the aspects where the second layer comprises one or more alignment features. These alignment features can be the same or different from the alignment features present on the first layer. It is also understood that disclosed herein are aspects where the alignment features are present either on the first layer or the second layer or both layers. Any of the disclosed above alignment features can also be present on the second layer.

In exemplary and unlimiting aspects, the second layer of the auxiliary multilayer member can have a thickness from about 10 μm to about 10 mm, including exemplary values of about 15 μm, about 20 μm, about 30 μm, about 50 μm, about 70 μm, about 100 μm, about 150 μm, about 200 μm, about 250 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, and about 9 mm.

Also disclosed are the methods, where the auxiliary multilayer member comprises a third layer configured to overlay at least a portion of the first surface of the second metal part. It is understood that this third layer can have any desired functionality. In some aspects, the third layer can be configured to protect the first surface of the second metal part from deformation. Yet, in other aspects, the third layer can be configured to provide an additional sealing or adhesion, or any desired function. In some aspects, the third layer can comprise a metal, a polymer, an elastomer, a cushioning material, or any combination thereof. In such exemplary and unlimiting aspects, the third layer can comprise polyethylene, polypropylene, polyether ketone (PEEK), polyethylene terephthalate (PET), silicone, rubber, polyurethane, styrene-butadiene-styrene (SBS) elastomer, or any combination thereof.

If present, the third layer can have a thickness from about 10 μm to about 10 mm, including exemplary values of about 15 μm, about 20 μm, about 30 μm, about 50 μm, about 70 μm, about 100 μm, about 150 μm, about 200 μm, about 250 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, and about 9 mm.

In some aspects, each layer in the auxiliary multilayer member is at least partially coupled to each other and are configured to form a gap between each layer, wherein the gap is configured to accommodate the first metal part and/or the second metal part. It is understood that such coupling can be present at any portion of any layer of the auxiliary multilayer member. In some aspects, the layer of the auxiliary multilayer member can be coupled at at least a portion of one edge of the auxiliary multilayer member. It is further understood that any coupling can be utilized as long as each of the layers can be separated from each other to form a predetermined gap. In such exemplary and unlimiting aspects, the layers can have at least one point of contact that does not prevent layers from separating from each other.

In still further aspects, each layer in the auxiliary multilayer member is discrete and is configured to be individually positioned.

In still further aspects, where the gap is formed between the at least the first portion of the first surface of the first metal part and the at least the second portion of the second surface of the second metal part, the method comprises insertion of one or more spacers configured to maintain the gap. It is understood, and as disclosed above, the one or more spacers can be at least a part of the second layer of the auxiliary multilayer member. While in other aspects, the one or more spacers can be added in addition to the second layer of the auxiliary multilayer member. In still further aspects, the one or more spacers are also configured to provide one or more alignment features, corrosion seal, an interconnecting material. If the spacers comprise one or more alignment features, any one of the disclosed above alignment features can be utilized. In some aspects, the spacer can also be referred to as standoffs.

In the methods disclosed herein, the first coat layer present on the second surface of the first metal part is substantially undamaged after the metallurgical bond is formed. In still further aspects, the second coat layer present on the first surface of the second metal part is substantially undamaged after the metallurgical bond is formed.

Also disclosed are methods where the first coat layer present on the first surface of the first metal part outside of the first dimension of the first portion of the first surface of the first metal part is substantially undamaged after the metallurgical bond is formed. While in other aspects, the second coat layer present on the second surface of the second metal part outside of the second dimension of the second portion of the second surface of the second metal part is substantially undamaged after the metallurgical bond is formed.

In still further aspects, the metallurgical bond formed by the disclosed herein methods exhibits an average failure load from 10 kN to 50 kN, including exemplary values of about 15 kN, about 20 kN, about 25 kN, about 30 kN, about 35 kN, about 40 kN, and about 45 kN. Yet in other aspects, wherein the metallurgical bond formed by the disclosed herein methods exhibits a max failure load from 10 kN to 50 kN, including exemplary values of about 15 kN, about 20 kN, about 25 kN, about 30 kN, about 35 kN, about 40 kN, and about 45 kN.

Further disclosed herein is a method for producing an impact weld between a first metal part and a second metal part, comprising: providing a first metal part having a first surface and an opposed second surface and a second metal part having a first surface and an opposed second surface; positioning the first metal part and the second metal part such that the first surface of the first metal is facing the second surface of the second metal part and wherein a first portion of the first surface of the first part and a first portion of the second surface of the second metal part form a gap; wherein the first portion of the first surface is defined by a first area and the first portion of the second surface is defined by a second area; directing an energy source to the second surface of the first metal part at a predetermined location, such that the energy emitted from the energy source is applied to a second portion of the second surface of the first metal part, wherein the second portion of the second surface is defined by the first area when it is projected to the second surface; and accelerating the first a portion of the first surface across the gap to form a metallurgical bond with the first portion of the second surface of the second metal part.

It is understood that the gap can be formed by any method. For example, and without limitations, the gap can be formed by a recession within the first portion of the second surface of the second metal part. Yet, in other aspects, the gap can be formed by the insertion of one or more spacers between the first portion of the first surface of the first metal part and the first portion of the second surface of the second metal part. In such aspects, the one or more spacers can also be referred to as standoffs.

Yet, in other aspects, the first metal part can have at least two segments, wherein a first segment has a main axis and wherein a second segment is bent at a predetermined angle relative to the main axis of the first segment. In such exemplary and unlimiting aspects, the first portion of the first surface of the first metal can be positioned within the second segment of the first metal.

While in other aspects, the second metal can have at least one segment. In some exemplary aspects, where the second metal has one segment, the segment is planar and is positioned substantially parallel to the main axis of the first segment of the first metal part. While in still other aspects, where the second metal has at least two segments. In such an aspect, a first segment of the second metal part has a main axis while a second segment of the second metal part bent at a predetermined angle relative to the main axis of the first segment of the second metal part.

In certain aspects, the gap is not uniform and is defined by a narrow portion and a wide portion and ranges from about 0.1 mm to about 5 mm, including the exemplary value of about 0.5 mm, about 1 mm, about 1.5 mm, about 2 mm, about 2.5 mm, about 3 mm, about 3.5 mm, about 4 mm, and about 4.5 mm.

In some aspect, the first metal part and/or the second metal can have a thickness of up to about 1 mm, including exemplary values of about 0.05 mm, about 0.1 mm, about 0.2 mm, about 0.3 mm, about 0.5 mm, about 0.6 mm, about 0.7 mm, about 0.8 mm, and about 0.9 mm

In some aspect, the first metal part and/or the second metal can have a thickness from about 0.1 mm to about 5 mm, including the exemplary value of about 0.5 mm, about 1 mm, about 1.5 mm, about 2 mm, about 2.5 mm, about 3 mm, about 3.5 mm, about 4 mm, and about 4.5 mm.

In still further aspects, these methods can comprise an auxiliary multilayer member overlying the second portion of the second surface of the first metal part. In such exemplary and unlimiting aspects, the auxiliary multilayer member can overly the second segment of the first metal part.

In some aspects, the auxiliary multilayer member comprises a first layer that is at least partially transparent. In yet other aspects, the first layer is substantially transparent. In some aspects, the first layer of the auxiliary multilayer member can comprise a glass or a polycarbonate. Yet, in other aspects, any substantially transparent materials can be used. It is understood that in some aspects and without wishing to be bound by any theory, at least partial transparency is needed to efficiently transfer laser energy. The common parameters of the laser energy are bursts of optical energy in a range of about 10 ns to about 200 ns, including exemplary values of about 20 ns, about 30 ns, about 40 ns, about 50 ns, about 60 ns, about 70 ns, about 80 ns, about 90 ns, about 100 ns, about 110 ns, about 120 ns, about 130 ns, about 140 ns, about 150 ns, about 160 ns, about 170 ns, about 180 ns, and about 190 ns, with a power density from 1 to 20 GW/cm², including exemplary values of about 2 GW/cm², about 3 GW/cm², about 4 GW/cm², about 5 GW/cm², about 6 GW/cm², about 7 GW/cm², about 8 GW/cm², about 9 GW/cm², about 10 GW/cm², about 11 GW/cm², about 12 GW/cm², about 13 GW/cm², about 14 GW/cm², about 15 GW/cm², about 16 GW/cm², about 17 GW/cm², about 18 GW/cm², and about 19 GW/cm².

In still further aspects, the first layer of the auxiliary multilayer member is a high shock impedance material. In such aspects, the first layer of the auxiliary multilayer member comprises glycerin, water, or a combination thereof.

It is understood that in some aspects, the first layer of the auxiliary multilayer member is thicker than the first metal part. In yet other aspects, the first layer of the auxiliary multilayer member has a thickness that is substantially identical to the first metal part or the second part.

The auxiliary multilayer member used in these methods can further comprise a second layer and wherein the second layer is interposed between the first layer of the auxiliary multilayer member and the second surface of the first metal part. In such exemplary aspects, the second layer can comprise sodium azide, nitromethane comprising material, one or more oxidants or oxidizing materials, or any combination thereof.

In some aspects, the second layer has a thickness from about 10 microns to about 1 cm, including exemplary values of about 50 microns, about 100 microns, about 500 microns, about 1 mm, about 5 mm, and about 9 mm.

In some methods, as disclosed herein, the auxiliary multilayer member can be preformed, and each of the layers is formed and assembled prior to the welding process. Yet in other aspects, the first and/or the second layers of the auxiliary multilayer members can be formed in-situ, for example, by providing a first stream of glycerin, water or a combination thereof and a second stream of sodium azide, nitromethane comprising material, one or more oxidants or oxidizing materials, or any combination thereof. In such aspects, the stream of the each material can form the respective layer on the site just before the welding process.

In still further aspects, the auxiliary multilayer member can further comprise an adhesive layer interposed between the first layer material and the second surface of the first metal part. In such aspects, the adhesive layer can be interposed between the second layer and the second surface of the first metal part.

In still further aspects, the thickness of the first layer is larger than the thickness of the first metal part. For example, and without limitations, the thickness of the first layer can be larger by up to a factor of two relative to the thickness of the first metal part.

In some other aspects, the thickness of the second layer is from about 10 microns to about 200 microns, including exemplary values of about 20 microns, about 40 microns, about 60 microns, about 80 microns, about 100 microns, about 120 microns, about 140 microns, about 160 microns, and about 180 microns.

In yet further aspects, the thickness of the third layer can be between 1 micron to about 100 microns, including exemplary values of about 2 microns, about 5 microns, about 10 microns, about 20 microns, about 30 microns, about 40 microns, about 50 microns, about 60 microns, about 70 microns, about 80 microns, and about 90 microns.

Yet, in still further aspects, the first layer and second layer adhere to the second surface of the first metal part with the adhesive layer.

In the methods disclosed herein, the energy source can be, for example, a laser capable of emitting light in a predetermined range of wavelength. In some aspects, the laser emits from about 1 to about 100 joules per microsecond, including exemplary values of about 5 joules per microsecond, about 1 joule per microsecond, about 20 joules per microsecond, about 30 joules per microsecond, about 40 joules per microsecond, about 50 joules per microsecond, about 60 joules per microsecond, about 70 joules per microsecond, about 80 joules per microsecond, and about 90 joules per microsecond.

In still further aspects, the laser emits light in pulses. For example, in some aspects, the laser provides at least one pulse. Yet, in other aspects, the laser provides at least 2 pulses, at least 5 pulses, at least 10 pulses, at least 20 pulses, at least 100 pulses. In yet other aspects, the laser can emit light in a series of pulses, for example, up to 10 pulses per second in a sequence.

In some aspects, the at least one pulse has a predetermined laser pulse duration. In some aspects, the predetermined laser pulse duration can be anywhere between about 10 ns to about 500 ns, including exemplary values of about 20 ns, about 30 ns, about 40 ns, about 50 ns, about 60 ns, about 70 ns, about 80 ns, about 90 ns, about 100 ns, about 120 ns, about 150 ns, about 180 ns, about 200 ns, about 220 ns, about 250 ns, about 270 ns, about 300 ns, about 320 ns, about 350 ns, about 370 ns, about 400 ns, about 420 ns, about 450 ns, and about 470 ns.

In still further aspects, the energy source is directed to the second surface of the first metal for a first duration. In such exemplary and unlimiting aspects, the first duration can be between about 10 ns to about 30 μs depending on the energy source and specific auxiliary multilayer member. For example, in the aspects where the comprises an ablating material (such as ablating and vaporizing foil), the energy is directed to the surface for a time between 1 μs to about 30 μs, including exemplary values of about 2 μs, about 5 μs, about 7 μs, about 10 μs, about 12 μs, about 15 μs, about 17 μs, about 20 μs, about 22 μs, about 25 μs, and about 27 μs. Yet, in other aspects, where the auxiliary multilayer member comprises a transparent first layer and an energy source is a laser, the energy is directed to the surface for a time between about 10 ns to about 500 ns, including exemplary values of about 20 ns, about 30 ns, about 40 ns, about 50 ns, about 60 ns, about 70 ns, about 80 ns, about 90 ns, about 100 ns, about 120 ns, about 150 ns, about 180 ns, about 200 ns, about 220 ns, about 250 ns, about 270 ns, about 300 ns, about 320 ns, about 350 ns, about 370 ns, about 400 ns, about 420 ns, about 450 ns, and about 470 ns.

In still further aspects, the energy source can be aligned relative to the second segment of the first metal part such that the emitted energy is substantially normal to the bent segment of the first metal part.

In some aspects, the step of accelerating the at least a portion of the first surface across the gap to form a metallurgical bond with the at least a portion of the second surface of the second metal part occurs at a predetermined collision speed. In such exemplary and unlimiting aspects, the collision speed is anywhere between about 200 m/s to about 800 m/s, including exemplary values of including exemplary values of about 250 m/s, about 300 m/s, about 350 m/s, about 400 m/s, about 450 m/s, about 500 m/s, about 550 m/s, about 600 m/s, about 650 m/s, about 700 m/s.

In still further aspects, the second layer is capable of augmenting energy emitted from the energy source to provide augmented energy. In such exemplary and unlimiting aspects, the augmented energy is from 50 J/cm² to about 5,000 J/cm², including exemplary values of about 100 J/cm², about 200 J/cm², about 300 J/cm², about 400 J/cm², about 500 J/cm², about 600 J/cm², about 700 J/cm², about 800 J/cm², about 900 J/cm², about 1000 J/cm², about 1100 J/cm², about 1200 J/cm², about 1300 J/cm², about 1400 J/cm², about 1500 J/cm², about 1600 J/cm², about 1700 J/cm², about 1800 J/cm², about 1900 J/cm², about 2000 J/cm², about 2100 J/cm², about 2200 J/cm², about 2300 J/cm², about 2400 J/cm², about 2500 J/cm², about 2600 J/cm², about 2700 J/cm², about 2800 J/cm², about 2900 J/cm², about 3000 J/cm², about 3100 J/cm², about 3200 J/cm², about 3300 J/cm², about 3400 J/cm², about 3500 J/cm², about 33600 J/cm², about 700 J/cm², about 3800 J/cm², about 3900 J/cm², about 4000 J/cm², about 4100 J/cm², about 4200 J/cm², about 4300 J/cm², about 4400 J/cm², about 4500 J/cm², about 4600 J/cm², about 4700 J/cm², about 4800 J/cm², and about 4900 J/cm².

In yet further aspects, the augmented energy is a function of a thickness of the second layer.

In still further aspects, in any of the disclosed herein methods, the process can be adapted to welding more than one pair at a time. In yet other aspects, one energy source can be configured to move from one welding pair to another welding pair automatically. Yet, in other aspects, several energy sources can be used simultaneously. In still further aspects, the methods disclosed herein can be performed manually. While in other aspects, the methods can be fully or partially automated.

### Auxiliary Multilayer Member

Also disclosed are aspects directed to an auxiliary multilayer member having an overall predetermined dimension and configured to assist in a welding process comprising: a first layer having a first dimension and comprising an ablating material, wherein the first layer is configured to be positioned on an outermost surface of a first metal part; a second layer having a second dimension and comprising aluminum, steel, copper, magnesium, zinc, or any combination thereof, wherein the second layer is configured to be positioned between an inner surface of the first metal part and an inner surface of a second metal part; and wherein the first layer is configured to absorb the energy needed to form a metallurgical bond between the inner surface of the first metal part and the inner surface of the second metal part.

In such aspects, the overall predetermined dimension is adapted to a dimension of at least a portion of the first metal part and/or to a dimension of at least a portion of the second metal part.

In such exemplary and unlimiting aspects, the first layer of the auxiliary multilayer member can have a thickness from about 10 μm to about 10 mm, including exemplary values of about 15 μm, about 20 μm, about 30 μm, about 50 μm, about 70 μm, about 100 μm, about 150 μm, about 200 μm, about 250 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, and about 9 mm.

In certain aspects, the first layer of the auxiliary multilayer member can comprise any conductive material that can be vaporized under effective conditions. In still further aspects, the first layer of the auxiliary multilayer member can comprise aluminum, steel, copper, magnesium, zinc, or any combination thereof. In still further aspects, the ablating material is configured to evaporate when kinetic energy as measured from 1 to 1000 kJ/cm², including exemplary values of about 5 kJ/cm², about 10 kJ/cm², about 50 kJ/cm², about 100 kJ/cm², about 200 kJ/cm², about 300 kJ/cm², about 400 kJ/cm², about 500 kJ/cm², about 600 kJ/cm², about 700 kJ/cm², about 800 kJ/cm², and about 900 kJ/cm² is imparted to the outermost surface of the first layer.

Also disclosed are aspects where the outer surface of the outermost layer comprises an insulating coating. Any known in the art insulating coatings or layers can be utilized.

In some exemplary and unlimiting aspects, the outer surface of the first layer of the auxiliary multilayer member can also comprise one or more alignment features. It is understood that these alignment features can be used to properly position the first and metal parts relatively to each other such that the first portion and the second portion are aligned to provide for the desired metallurgical bond. Any known in the art alignment features can be utilized, for example, the alignment features can comprise markings, shapes such as various protrusions or indentations, apertures, or any combination thereof.

In still further aspects, the second layer can have a thickness from about 10 μm to about 10 mm, including exemplary values of about 15 μm, about 20 μm, about 30 μm, about 50 μm, about 70 μm, about 100 μm, about 150 μm, about 200 μm, about 250 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, and about 9 mm.

In still further aspects, the second layer can comprise a wave initiator feature. Any of the disclosed above wave initiators shapes can be utilized.

In some aspects, the auxiliary multilayer member can further comprise a third layer having a third dimension, wherein the third layer is configured to be positioned on an outermost surface of the second metal part.

In still further aspects, the overall dimension is defined by the first dimension of the first layer, the second dimension of the second layer, the third dimension of the third layer, or a combination thereof.

It is understood that in some aspects, the first dimension of the first layer, the second dimension of the second layer, and/or the third dimension of the third layer are the same or different.

In some aspects and as disclosed above, each layer of the auxiliary multilayer member has at least partially coupled to each other. Yet, in other aspects, and as also disclosed above, each layer of the auxiliary multilayer member is discrete.

In some exemplary and unlimiting aspects, the second and/or the third layer of the auxiliary multilayer member can also comprise one or more alignment features. Any known in the art alignment features can be utilized, for example, the alignment features can comprise markings, shapes such as various protrusions or indentations, apertures, or any combination thereof. It is further understood that the one or more alignment features are configured to assist to form the metallurgical bond.

### Welded Product

As summarized above, disclosed herein is a welded product comprising: a first metal part having a first surface and an opposed second surface, and having a thickness from about 1 mm to about 3 mm; a second metal part having a first surface and an opposed second surface, and having a thickness from about 1 mm to about 3 mm; wherein a portion of the first surface of the first metal part is metallurgically welded to a portion of the second surface of the second metal part; wherein the first surface of the second metal part is substantially flat; and wherein the welded product exhibits an average failure load from 10 kN to 50 kN.

In such aspects, and as disclosed above, the first metal part can have a thickness from about 1 mm to about 3 mm, including exemplary values of about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, and about 2.9 mm.

In yet other aspects, and as disclosed above, the second metal part can have a thickness from about 1 mm to about 3 mm, including exemplary values of about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, and about 2.9 mm.

In still further aspects, the welded product can exhibit an average failure load from 10 kN to 50 kN, including exemplary values of about 15 kN, about 20 kN, about 25 kN, about 30 kN, about 35 kN, about 40 kN, and about 45 kN.

In certain aspects, the first and second metal parts can comprise any materials described above.

It is understood that the welded products disclosed herein can be utilized in any desired industry, for example, and without limitations, it can be utilized in the auto industry, aircraft, medical, defense, or spacecraft industries.

### System

Still further disclosed herein is a system comprising: a first member comprising: a body having a central axis along a length of the body and a first surface, wherein at least a portion of the surface defines a recess having a first dimension and comprising two or more segments, wherein the segments are not substantially symmetrical to each other in a plane bisecting the recess; and a second member comprising: a mount having a second dimension configured to be substantially fit within the recess; a first metal part and a second metal part wherein the second metal part has at least a portion positioned within the recess and having a third dimension substantially identical to the first dimension; and wherein the first metal part is positioned on a surface of the body such that it has at least one point of contact with the surface of the body outside of the recess, and wherein at least a portion of the first metal part is disposed above at least a portion of the second metal part that is positioned within the recess; an auxiliary multilayer member having a fourth dimension such that a first layer of the auxiliary multilayer member at least partially overlays at least a portion of an outermost surface of the first metal part; and wherein the second member is configured to be positioned such that it overlays the first member. In still further aspects, the systems disclosed herein can also comprise an energy source configured to be in electrical communication with at least an auxiliary multilayer member.

The system disclosed herein further comprises an energy source configured to be in electrical communication with at least the auxiliary multilayer member.

In some aspects, the recess can be defined by a perimeter or a circumference when it is observed from a top view of the first surface.

In still further aspects, a first segment of the two more segments has a first angle relative to the central axis of the body. Yet, in other aspects, a second segment of the two or more segments can have a second angle relative to the central axis of the body. In still further aspects, a third segment of the two or more segments can have a third angle relative to the central axis of the body.

It is understood that in some exemplary and unlimiting aspects, the first, second, and third angles are different. However, there also disclosed are aspects, where, for example, the first and the second angles are the same, and the third angle is different; or wherein the first and the third angles are the same and the second is different, or wherein the second and the third angles are the same and different from the first angle.

In some aspects, at least one segment of the two or more segments are parallel to the central axis of the body.

In some aspects, the first angle, the second angle, and/or the third angle are from 0 to about 90 degrees, including exemplary values of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, and about 85 degrees.

In still other aspects, at least a portion of the first segment adjacent to the first angle has a length from about 0.5 mm to about 20 mm, including exemplary values of about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, and about 19 mm.

In still further aspects, the second segment is positioned between the first and the third segment and is parallel to the central axis of the body. In such exemplary and unlimiting aspects, the second segment can have a length of about 0.5 mm to about 20 mm, including exemplary values of about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, and about 19 mm.

Yet in still further aspects, the at least a portion of the third segment adjacent to the third angle has a length from about 0.5 mm to about 20 mm, including exemplary values of about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, and about 19 mm.

In still further aspects, the system is configured to form a metallurgical bond between at least a portion of the first metal part and at least a portion of the second metal part. In such exemplary and unlimiting aspects, the at least a portion of the second metal part positioned within the recess comprises two or more segments substantially identical to the two or more segments of the recess.

In some aspects, the second metal part is preformed. Still, in other aspects, the second metal part is positioned such that a gap is formed between at least a portion of the second metal part and at least a portion of the first metal part positioned within the recess. In still further aspects, the gap is not uniform.

In some aspects, one segment of the two or more segments of the at least a portion of the first metal positioned within the recess is parallel to the central axis of the body; the gap is measured between this segment and the at least a portion of the second metal part. In such exemplary and unlimiting aspects, the gap can be from about 0.1 mm to about 5 mm, including exemplary values of about 0.5 mm, about 1 mm, about 1.5 mm, about 2 mm, about 2.5 mm, about 3 mm, about 3.5 mm, about 4 mm, and about 4.5 mm.

It is understood that the first and the second metal parts of the disclosed system can comprise any of the disclosed above materials.

In yet further aspects, the energy source can comprise an electrical current, laser, electromagnetic source, detonation of an explosive and/or energetic material, electromagnetic repulsion, projectile of gun powder, spring projectile, or a combination thereof.

Also disclosed herein is a system comprising: a) a first metal part having a first surface and an opposed second surface; wherein the first metal part has a first central axis positioned along the length of the first metal part; b) a second metal part having a first surface and an opposed second surface; wherein the second metal part has a second central axis positioned along the length of the second metal part; wherein the first metal part has a thickness t₁ and density ρ₁ that are substantially similar or smaller than a thickness t₂ and density ρ₂ of the second metal part respectively; wherein the first surface of the first metal part overlays the second surface of the second metal part such that i) substantially no gap is formed between at least a first portion of the first surface of the first metal part and at least a second portion of the second surface of the second metal part; or ii) wherein a gap having up a height h₁≤t₁ is formed between the at least the first portion of the first surface of the first metal part and the at least the second portion of the second surface of the second metal part; wherein the first portion is defined by a first dimension and wherein the second portion is defined by a second dimension; c) an auxiliary multilayer member having a third dimension such that a first layer of the auxiliary multilayer member at least partially overlays at least a portion of the second surface of the first metal part and wherein the third dimension is projected onto a plane parallel to the first surface of the first metal part and is within the first dimension of the first portion; and d) an energy source configured to accelerate an outer surface of the first layer of the auxiliary multilayer member that at least partially overlays at least a portion of the second surface of the first metal part and to direct the first portion of the first surface of the first metal part toward the second portion of the second surface of the second metal part and thereby to form a metallurgical bond.

In still further aspects, the recess can be defined by a perimeter or a circumference when it is observed from a top view of the first surface. In still further aspects, a first segment of the two more segments has a first angle relative to the central axis of the body. In yet other aspects, a second segment of the two or more segments has a second angle relative to the central axis of the body. In still further aspects, a third segment of the two or more segments has a third angle relative to the central axis of the body. In still further aspects, the first, second, and third angles are different. In yet other aspects, at least one segment of the two or more segments is parallel to the central axis of the body.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: A New Approach for Dissimilar Aluminum-Steel Impact Spot Welding Using Vaporizing Foil Actuators

### Materials and Experimental Procedures

The broader goal of this example is to present the application of a new impact welding approach for dissimilar joining of different varieties of Al and HSLA steel. The Al alloys chosen for the example were heat-treatable AA6111-T4 and High-pressure vacuum die-cast Aural 2 Al alloy in the T5 temper. Three different varieties of HSLA 340 steel: bare, hot-dip galvanized (HDGI) at 50 g/m2 on each side, and e-coated were employed. The thickness of the Zn based galvanized coating, and the organic e-coat were close to 17 μm and 36 μm, respectively. The chosen materials and their mechanical properties are detailed in Table 1. Table 2 details the stack-ups welded.

TABLE 1
Materials Employed and Properties

| | | Yield | Ultimate | Total |
|---|---|---|---|---|
| | Thickness | strength | tensile | elongation |
| Material | (mm) | (MPa) | strength (MPa) | (%) |
| AA6111-T4 | 2.5 | 159 | 274 | 26 |
| Aural 2 | 3 | 160 | 290 | 9.5 |
| HSLA 340 | 2.5 | 390 | 465 | 27 |
| (bare, HDGI | | | | |
| and e-coated) | | | | |

TABLE 2
Stack-ups Welded

| Weld Pair | Combination |
|---|---|
| 1 | AA6111-T4-HSLA 340 bare |
| 2 | AA6111-T4-HSLA 340 HDGI |
| 3 | AA6111-T4-HSLA 340 e-coated |
| 4 | Aural 2-HSLA 340 HDGI |

FIG. 1A depicts the welding equipment and fixture used to produce the spot welds. The set up shown in FIG. 1A is for a lap-shear configuration; however, the same fixture was also used for the coach peel configuration. In all the cases, Al (both AA6111-T4 and Aural 2) was chosen as the flyer sheet, and steel (HSLA 340) was kept as the target sheet. Al was used as the flyer for exemplary purposes only. It is understood, and without wishing to be bound by any theory, since Al is considered to be a light material, it would allow achieving higher impact velocities at a given standoff compared to aspects where the steel member is used as a flyer. However, it is also understood that a steel member can be used as a flyer with no limitations if desired. Again, without wishing to be bound by any theory, it is understood that the impact velocity is one of the governing parameters in impact welding processes for achieving a metallurgical bond. In still further aspects, and as shown in this example, the use of Al as the flyer can allow the use of relatively low input energies, which can also be economically beneficial. In some aspects, it can also prolong the life of the capacitor bank. The Al sheet was driven towards the stationary steel target using an auxiliary multilayer member. In this example, the auxiliary multilayer member used was a foil actuator that can be rapidly vaporized, leading to the formation of a nominally solid-state joint. The actuator used was a 76 μm thick AA1100 foil, with geometry and dimensions as depicted in FIG. 1B. The foil follows a thin bridge shape design, with a narrowed region (marked as an active area in FIG. 1B) in the middle. The active area serves as the area of interest for pressure generation and leads to the generation of the weld type desired, i.e., a spot weld in this example. In this exemplary impact welding process, the flyer and target sheets are separated by a gap (standoff distance). This gap can allow the flyer to accelerate to a required velocity before it impacts the target sheet at an appropriate contact angle to form the joint. The flyer sheet was machined to create a pocket in the faying surface that provided the requisite standoff, as shown in FIGS. 1C-1E. The depth of the machined pocket was kept constant at 1.5 mm for all experiments in this example. A three-axis CNC mill (TORMACH 770M model) and a flat end mill with a shaft diameter of 3.175 mm were used for the purpose of machining the pocket. The design of the pocket and the machining toolpath was generated using the commercially available software Autodesk Inventor. The mill was operated at a spindle speed of 3250 rpm, and a smooth surface finish was obtained post-machining. It was found that in some aspects, the use of the machined pocket approach can be beneficial as it can produce a flat bottom surface without any protrusions, leave the coating on the bottom surface unperturbed. It can also work for thick workpieces and employ very low energy for producing the weld. If desired, this pocket can potentially be stamped. In addition to providing the standoff, the machining of the flyer sheet, in this example, effectively reduced its thickness to 1 mm for AA6111-T4 and 1.5 mm for Aural 2 at the location of the machined pocket.

It is understood that the specific shape, and geometry, and depth of the pocket can be decided based on the desired application. Exemplary and unlimiting shapes like a circular (15 mm and 20 mm diameter) and square (10 mm×10 mm, 15 mm×15 mm and 20 mm×20 mm) with different depths ranging from 1 mm to 1.5 mm were employed for coupon level samples. The trials demonstrated, however, that while the obtained bonding was good, the overall strength can be affected by the thinning of the flyer.

An example of the same has been provided in the form of a micrograph in FIG. 2. FIG. 1C depicts the set up used for AA61111-T4-HSLA 340 bare pair; FIG. 1D depicts the set up for AA61111-T4-HSLA 340 HDGI and Aural 2-HSLA 340 HDGI pairs; and FIG. 1E depicts the setup for AA61111-T4-HSLA 340 e-coated pair. As seen in FIG. 1D, a 0.5 mm thick AA3003 interlayer was introduced into the pocket, the interlayer being pre-deformed to a depth of 0.5 mm. Thus, for AA6111-T4-HSLA 340 HDGI and Aural 2-HSLA 340 HDGI pairs, there are effectively two weld interfaces, the first between the flyer Al and the interlayer and the second between the interlayer and the steel target. For the case of AA61111-T4-HSLA 340 e-coated pair as shown in FIG. 1E, the e-coat was locally machined off to a depth of 0.05 mm; no interlayer was used. The backing provided on the top of the target sheet was a heat-treated S7 steel die. Electric insulation between the anvil, foil and flyer sheet was provided with the use of polyester tape.

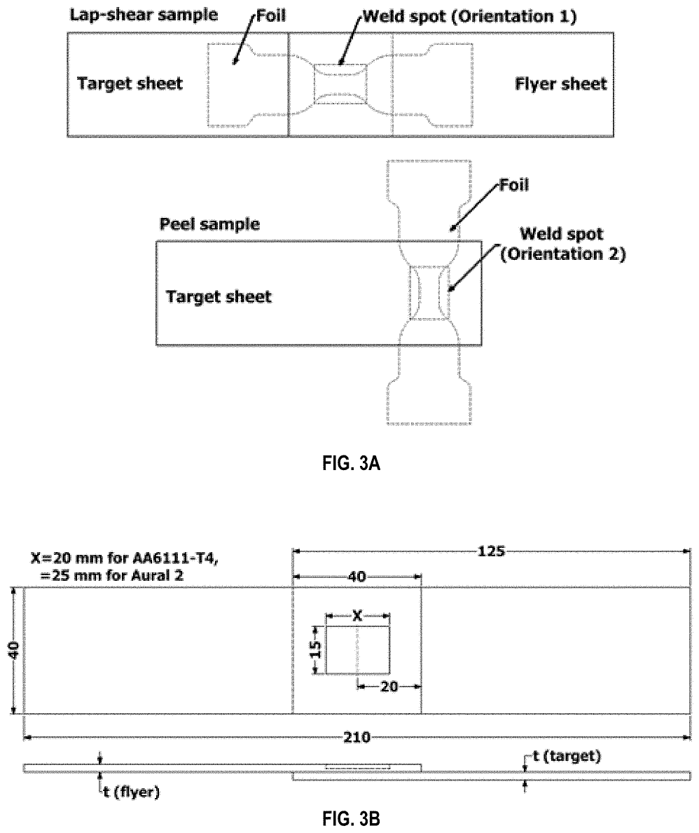

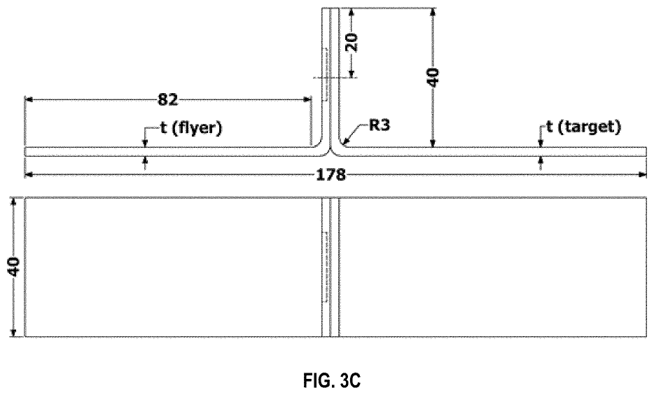

The ends of the foil actuator (or auxiliary multilayer member) were connected to an ultrafast capacitor bank. The bank had a current rise time of 6 μs, capacitance of 50 μF, inductance of 200 nH and maximum discharge energy of 4.2 kJ. The faying metal surfaces were cleaned with acetone to remove residual lubricants and debris prior to welding. The active area of the foil was centered over the machined pocket in the flyer prior to welding, as depicted in FIG. 3A. All the spot welds in this study were produced at an energy of 2.5 kJ. The welded samples were subjected to lap-shear and coach peel testing. The sample geometry and dimensions for lap-shear and coach peel configurations are shown in FIGS. 3B and 3C, respectively.

The properties of the welds were evaluated based on the results of the mechanical tests. The failure loads and fracture energies for the Al-steel samples were compared with the failure loads and fracture energies of the homogeneous Al—Al joints, and the failure modes were visually observed. Additional samples were prepared for each welding pair for cross-sectional microscopy. The centers of the welds were sectioned and subjected to a standard metallographic preparation. Macrographs of the weld cross-section were obtained, and the weld interface was observed. The macrographs were also observed for any damage around the deformed zone at the location of machined pocket.

### Mechanical Tests

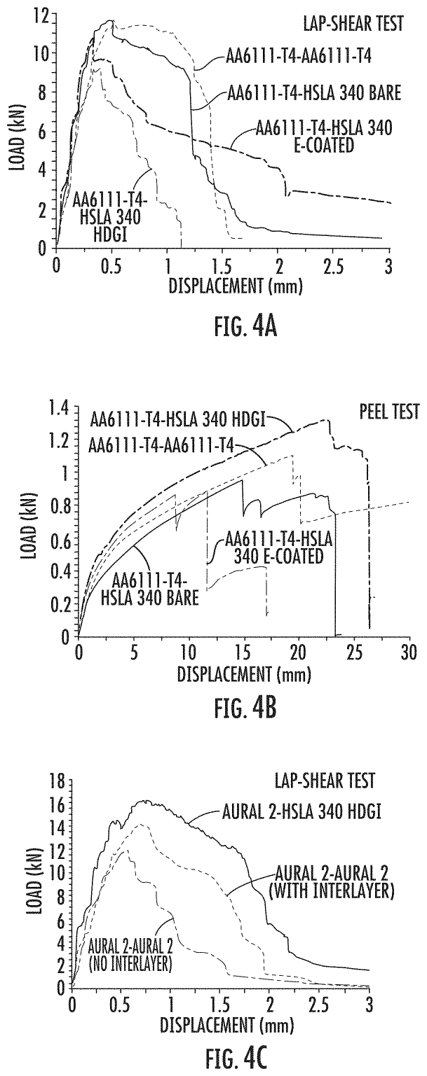

FIG. 4A depicts the representative load-displacement curves for AA61111-T4-HSLA 340 steel (bare, HDGI, e-coated) welded samples tested under lap-shear configuration, whereas FIG. 4B displays the curves for coach peel configuration.

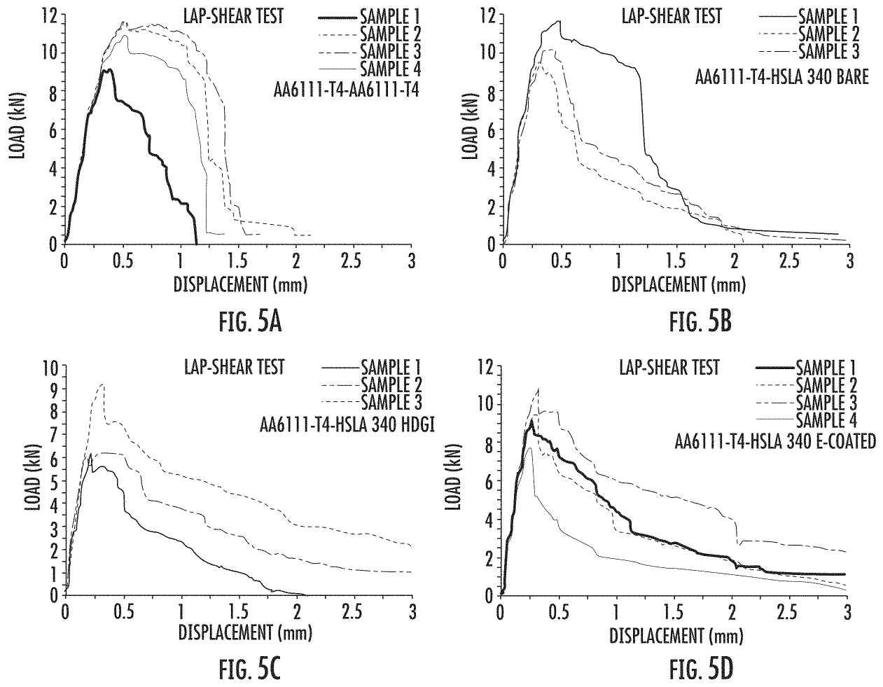

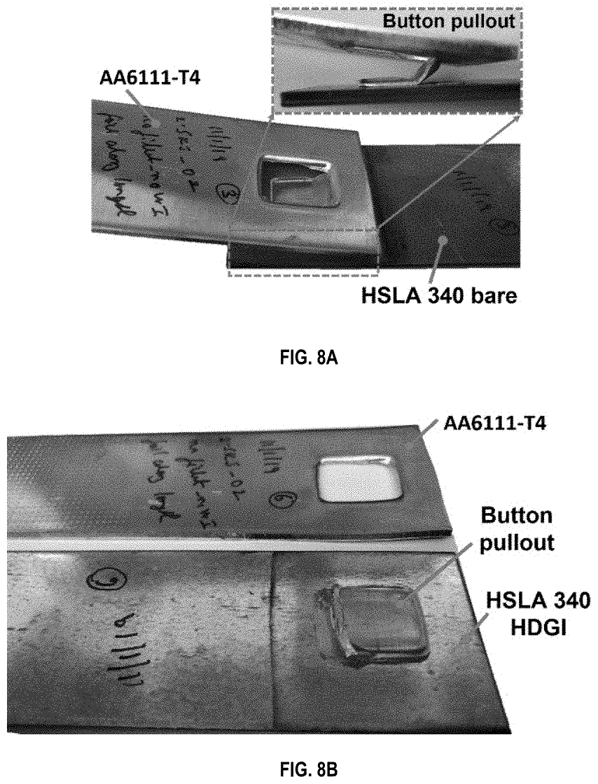

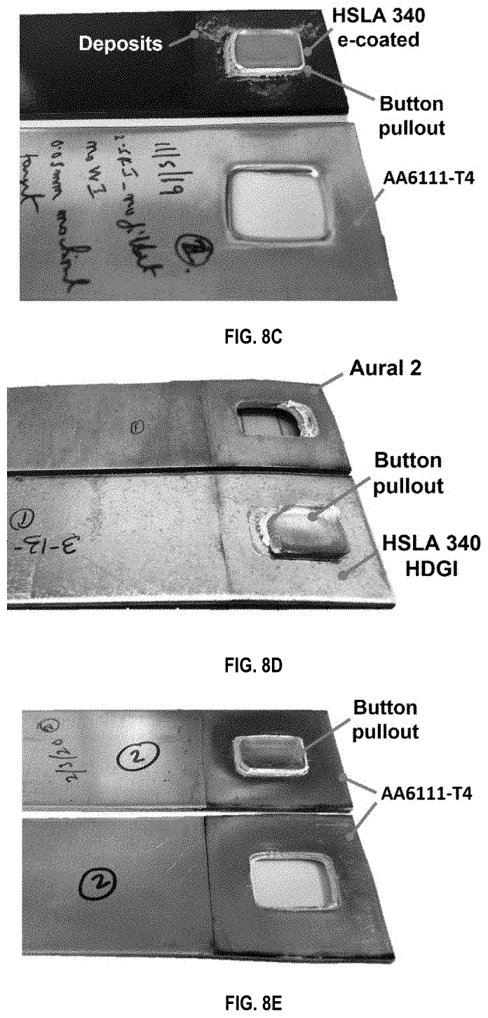

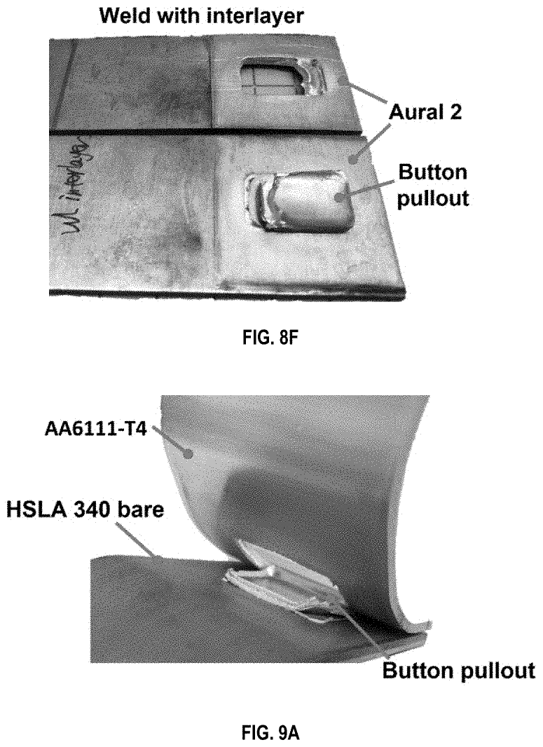

The curves in FIG. 4C depicts the data for Aural 2-HSLA 340 HDGI samples tested in the lap-shear configuration. The corresponding load-displacement curves for the similar Al—Al joints are also depicted in each figure. A minimum of three samples were tested for each material combination. The load-displacement curves for all the evaluated samples in both lap-shear and coach peel configurations, as shown in FIGS. 5A-7D and Tables 3-6. FIGS. 4A and 4C show that the load-displacement curves display a tail akin to the post-failure mode. Without wishing to be bound by any theory, it was attributed to the button pullout failure on all the lap-shear tested samples (on the target sheet, FIGS. 8A-8F) that allows the gradual decrease of load and continuous absorption of energy post-failure at peak load. Again, without wishing to be bound by any theory, it was hypothesized that such a characteristic load-displacement history could be desirable as it suggests higher energy absorption capacity.

TABLE 3
Summary of lap-shear tests

| | | | Average |
|---|---|---|---|
| | | Failure | failure |
| Material pair | Sample | load (kN) | load (kN) |
| AA6111-T4-AA6111-T4 | 1 | 9.18 | 10.86 |
| | 2 | 11.62 | |
| | 3 | 11.67 | |
| | 4 | 10.94 | |
| AA6111-T4-HSLA 340 bare | 1 | 11.71 | 10.47 |
| | 2 | 9.51 | |
| | 3 | 10.17 | |
| AA6111-T4-HSLA 340 HDGI | 1 | 6.21 | 7.23 |
| | 2 | 6.24 | |
| | 3 | 9.21 | |
| AA6111-T4-HSLA 340 e-coated | 1 | 9.12 | 9.29 |
| | 2 | 9.51 | |
| | 3 | 10.83 | |
| | 4 | 7.71 | |
| Aural 2-Aural 2 (no interlayer) | 1 | 11.95 | 11.23 |
| | 2 | 10.59 | |
| | 3 | 11.66 | |
| | 4 | 11.38 | |
| | 5 | 10.52 | |
| Aural 2-Aural 2 (with interlayer) | 1 | 14.28 | 13.67 |
| | 2 | 13.26 | |
| | 3 | 13.30 | |
| | 4 | 13.82 | |
| Aural 2-HSLA 340 HDGI | 1 | 16.32 | 15.61 |
| | 2 | 14.93 | |
| | 3 | 14.96 | |
| | 4 | 16.94 | |
| | 5 | 14.91 | |

TABLE 4
Summary of coach peel tests

| | | Failure | Average failure |
|---|---|---|---|
| Material pair | Sample | load (kN) | load (kN) |
| AA6111-T4-AA6111-T4 | 1 | 1.03 | 1.03 |
| | 2 | 0.93 | |
| | 3 | 0.97 | |
| | 4 | 1.11 | |
| | 5 | 1.11 | |
| AA6111-T4-HSLA 340 bare | 1 | 0.81 | 0.88 |
| | 2 | 0.93 | |
| | 3 | 0.81 | |
| | 4 | 0.95 | |
| AA6111-T4-HSLA 340 HDGI | 1 | 1.13 | 1.16 |
| | 2 | 1.32 | |
| | 3 | 1.08 | |
| | 4 | 1.09 | |
| AA6111-T4-HSLA 340 e- | 1 | 0.63 | 0.80 |
| coated | 2 | 0.88 | |
| | 3 | 0.86 | |

TABLE 5
Summary of energy absorbed calculated from lap-shear load
displacement curves

| | | Energy | |
|---|---|---|---|
| | | absorbed | Average energy |
| Material pair | Sample | (J) | absorbed (J) |
| AA6111-T4-AA6111-T4 | 1 | 2.164 | 3.31 |
| | 2 | 3.745 | |
| | 3 | 3.72 | |
| | 4 | 3.617 | |
| AA6111-T4-HSLA 340 bare | 1 | 3.86 | 2.79 |
| | 2 | 1.73 | |
| | 3 | 2.79 | |
| AA6111-T4-HSLA 340 HDGI | 1 | 0.76 | 1.38 |
| | 2 | 1.585 | |
| | 3 | 1.796 | |
| AA6111-T4-HSLA340 e- | 1 | 1.382 | 1.56 |
| coated | 2 | 1.683 | |
| | 3 | 2.028 | |
| | 4 | 1.165 | |
| Aural 2-Aural 2 (no interlayer) | 1 | 4.22 | 4.04 |
| | 2 | 3.65 | |
| | 3 | 4.6 | |
| | 4 | 3.83 | |
| | 5 | 3.92 | |
| Aural 2-Aural 2 (with | 1 | 6.22 | 6.02 |
| interlayer) | 2 | 6.03 | |
| | 3 | 5.53 | |
| | 4 | 6.28 | |
| Aural 2-HSLA 340 HDGI | 1 | 8.73 | 8.12 |
| | 2 | 8.12 | |
| | 3 | 7.1 | |
| | 4 | 9.1 | |
| | 5 | 7.54 | |

TABLE 6
Summary of energy absorbed calculated from coach peel load
displacement curves

| | | | Average |
|---|---|---|---|
| | | Energy | energy |
| Material pair | Sample | absorbed (J) | absorbed (J) |
| AA6111-T4-AA6111-T4 | 1 | 14.8 | 14.1 |
| | 2 | 13.4 | |
| | 3 | 12.5 | |
| | 4 | 14.9 | |
| | 5 | 14.83 | |
| AA6111-T4-HSLA 340 bare | 1 | 7.5 | 8.55 |
| | 2 | 8.78 | |
| | 3 | 8.45 | |
| | 4 | 9.46 | |
| AA6111-T4-HSLA 340 HDGI | 1 | 15.7 | 16.1 |
| | 2 | 21.0256 | |
| | 3 | 13.03 | |
| | 4 | 14.45 | |
| AA6111-T4-HSLA340 e- | 1 | 4.64 | 6.77 |
| coated | 2 | 7.66 | |
| | 3 | 8 | |

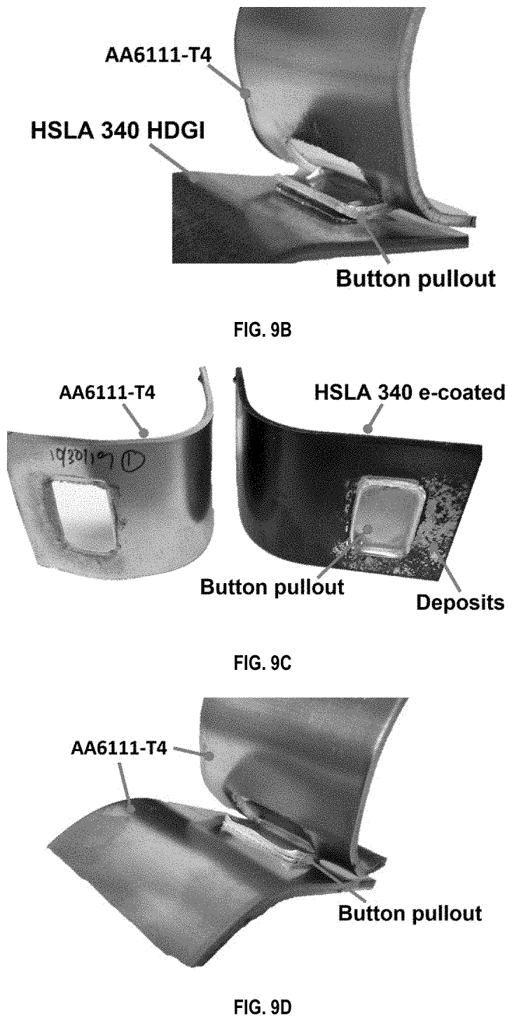

Considering the coach peel test load-displacement plots (FIG. 4B), it is seen that the curves display at least two peaks before the load drops to zero, where the first peak marks the initiation of the failure and the final peak corresponds to the complete separation. Similar to lap-shear samples, all the coach peel samples also displayed button pullout failure, leaving a button on the target sheet is shown in FIGS. 9A-9D. These observations show the production of very strong and repeatable joints irrespective of the weld pair and the surface condition/coating of the steel target. Also observed in FIGS. 4A-4C is the fact that the dissimilar Al-steel joint performance was on par and, in some cases, even better than those of homogeneous Al—Al joints. All the homogeneous Al—Al joints also failed by tearing of the base metal and left a nugget on the target sheet (FIGS. 8E, 8F, and 9D).

Although the characteristic shape of the load-displacement curves and failure modes were similar for all the investigated cases, there was a marked difference in other attributes like the peak elongation and energy absorbed among the weld pairs. Again, without wishing to be bound by any theory, it was hypothesized that this difference is due to two reasons, the first being the state of the surface on the steel target, i.e., bare, HDGI or e-coated, and the second being the welding approach used to produce the joints. In welding Al (both AA6111-T4 and Aural 2) to HDGI steel, an AA3003 interlayer was introduced, whereas for joining AA6111-T4 to e-coated steel, the e-coat was removed locally. These different approaches were reached upon after several trials with coupon samples, which were subjected to automotive industry-standard destructive pry testing. It was shown that in this example, the use of an interlayer was beneficial for joining AA6111-T4 and Aural 2 to HSLA 340 HDGI. It is understood that in some exemplary applications, such as, for example, welding of AA6111-T4-HSLA 340 HDGI pair, the high-speed impact of the Al flyer can lead to increased melting of the low melting point Zn (420° C.) coating layer on the steel target. The use of the interlayer, in some exemplary and unlimiting applications, in addition to controlling the heat input and the formation of IMC, can contribute to reducing the thinning of the flyer Al and thus lower any possible damage and stress concentrations. In the Aural 2-HSLA 340 HDGI pair, the use of interlayer shown to reduce the deformation of the low ductility Aural 2, thereby possibly reducing the stress concentrations in and around the deformed pocket. These observations are clearly stated and depicted in the weld cross-section micrographs in the succeeding subsection.

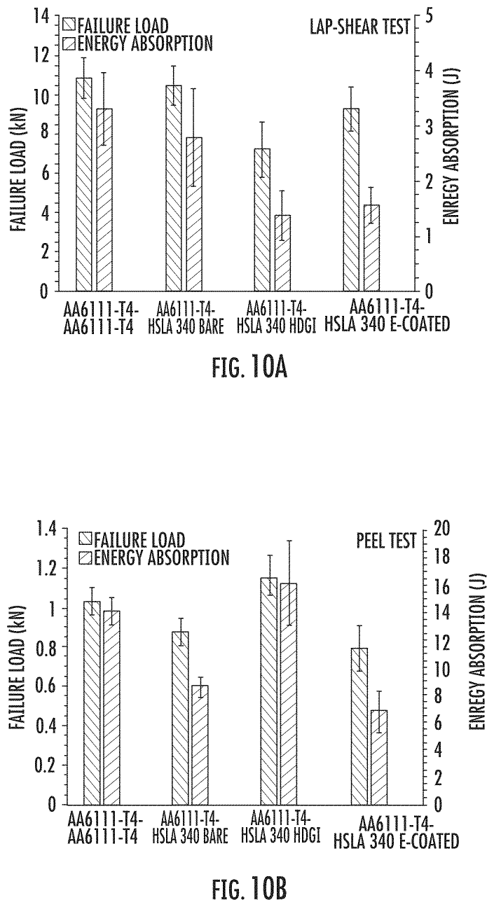

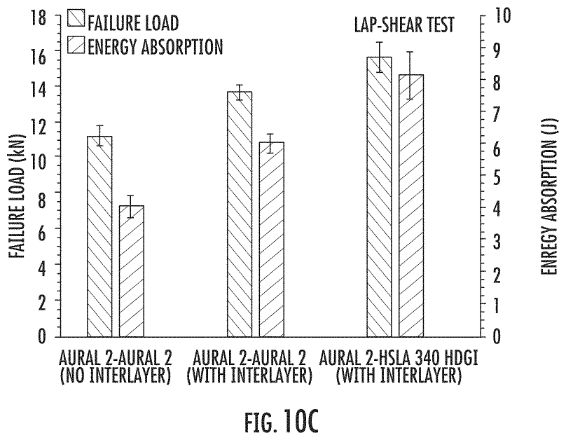

A summary of failure loads and energy absorption for the different samples evaluated is presented in FIGS. 10A-10C. For AA6111-T4-HSLA 340 steel joints, with regards to lap-shear testing, it was observed that the AA61111-T4-HSLA 340 bare pair performed better than AA6111-T4-HSLA 340 HDGI and AA6111-T4-HSLA 340 e-coated pairs. The properties of the similar Al—Al joints in the case of lap-shear were better than the Al-steel pairs (FIG. 10A). The AA6111-T4-HSLA 340 HDGI pair recorded the lowest strength and energy values (FIG. 10A). However, for coach peel testing, AA6111-T4-HSLA 340 HDGI pair performed the best, with strength and energy values even higher than Al—Al similar joint (FIG. 10B). From FIG. 10A, it can also be observed that the AA6111-T4-HSLA 340 bare pair had higher failure load and energy absorption values than the AA6111-T4-HSLA 340 e-coated pair. In the case of Al to e-coated steel welding, the foil and the machined pocket had to be additionally aligned manually with the locally machined steel target, and this led to the differences in the properties compared to AA6111-T4-HSLA 340 bare pair. Overall, it can be seen that the dissimilar Al-steel joint performance was similar to the homogeneous Al—Al counterpart in both loading configurations. Without wishing to be bound by any theory, as there is no interfacial failure, the strength and toughness are assumed to be dependent on the configuration and thinning of the corner of the aluminum pocket where rupture takes place. Again, without wishing to be bound by any theory, it was assumed that the lower load-bearing capability of coach peel samples is due to complicated stress states along with the larger bending moment applied during the test. The higher energy absorption of coach peel samples was a result of the bending induced large deformation of the samples. From FIG. 10C, it can be observed that the dissimilar Aural 2-HSLA 340 HDGI pair performed better than homogeneous Aural 2-Aural 2 pairs (with and without interlayer). Since all the three conditions shown in FIG. 10C had similar failure modes (button pullout), the properties of the joint were dependent on several factors, including the deformation and subsequent thinning of the flyer Al post-impact, the geometry and orientation of the machined pocket with respect to the foil, the stress concentrations in and around the machined pocket, instead of the nature of the weld interface.

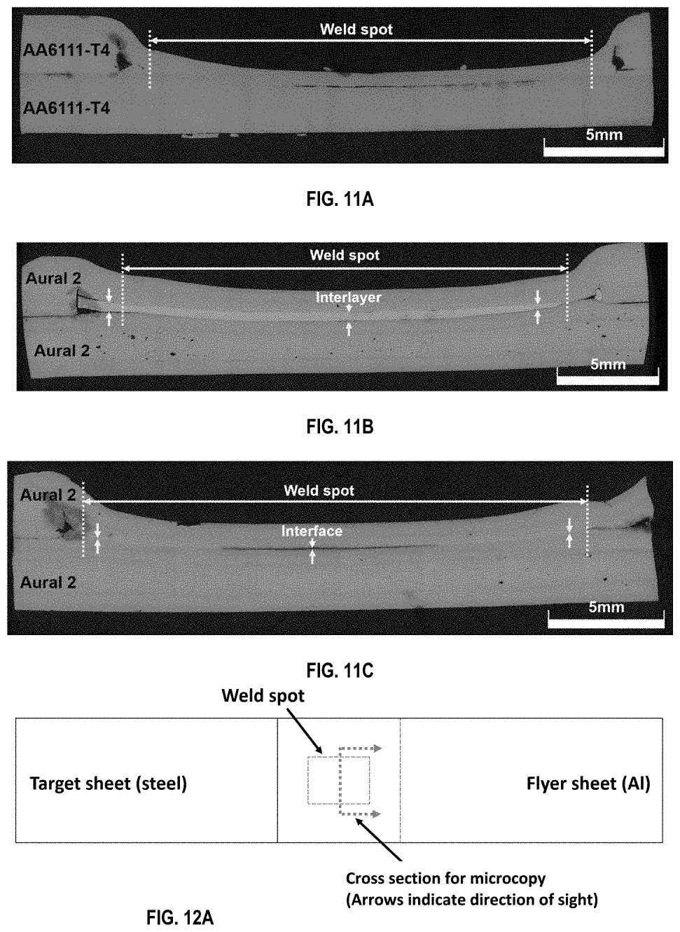

It was found that the Aural 2-Aural 2 joints prepared using the interlayer performed better than the Aural 2-Aural 2 joints without the interlayer, again, without wishing to be bound by any theory, owing to the reduced deformation-induced to the Al flyer when an interlayer was used. Also, the Aural 2-Aural 2 pair with the interlayer had a significantly reduced unbonded zone at the center compared to the Aural 2-Aural 2 pair without the interlayer, as shown in FIGS. 11B and 11C. However, the Aural 2-Aural 2 joints with the interlayer still had a performance slightly inferior to the Aural 2-HSLA 340 HDGI steel joints despite both pairs being welded under similar conditions. Without wishing to be bound by any theory, it could be explained by the fact that the Aural 2 flyer in the similar Al—Al joint deformed more than the flyer did in the case of the Al-Steel joint during the impact process owing to the higher stiffness of the steel target.

It is understood that the strength and energy absorption potential depend on the tearing behavior of the aluminum flyer, which is influenced by many different aspects like the orientation of the machined pocket with respect to the foil, the deformation or thinning of the flyer post-impact, the surface condition of the backing die and the anvil, the pressure used for confining the sample during welding and the formation of IMC's. The process-related variations in the measured properties, as is indicated by the error bars, are shown in FIGS. 10A-10C.

Without wishing to be bound by any theory, it is also hypothesized that the presence of zinc in HDGI steel in the dissimilar Al-Steel pair can also have a positive effect on the joint properties. This example shows that although weld pairs 1 to 3 (AA611-T4-HSLA steel) have the same base materials, changing the surface conditions and corresponding welding approaches, e.g., use of an interlayer for welding Al to galvanized steel or local machining to remove e-coat in Al-e-coated steel joint can affect the welding process and the resulting joint properties. The change in the properties is a result of the change of crucial process parameters: impact velocity and angle, which play a significant role in deciding the bonding quality or the weld structure.

### Metallographic Analysis

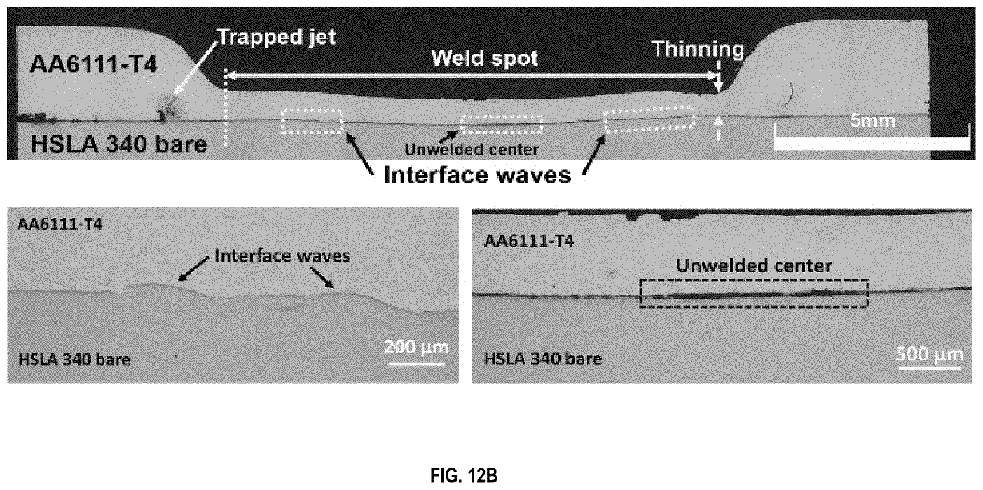

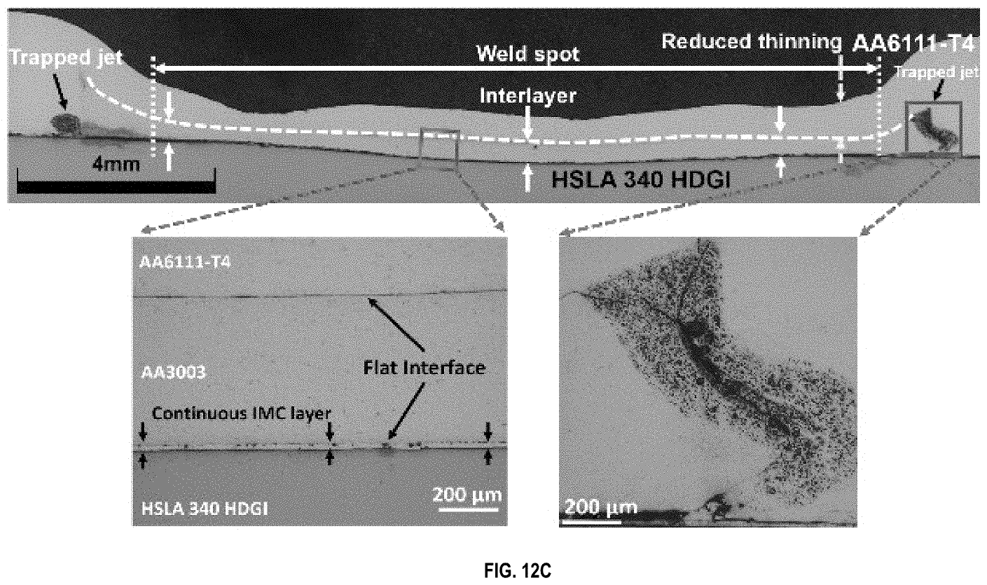

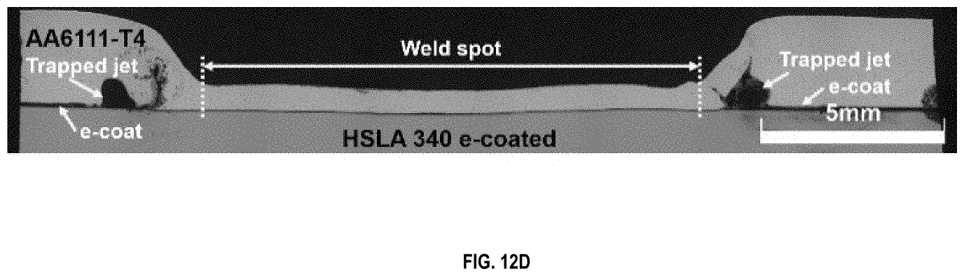

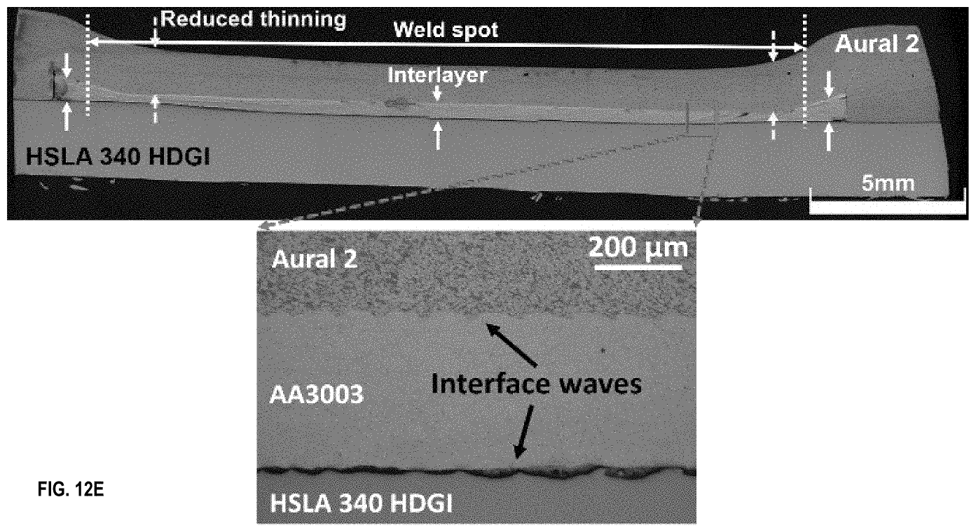

FIG. 12A depicts the schematic of a sample prepared for metallography, indicating the direction of sight of the weld cross-sections. FIGS. 12B-12E represent the micrographs depicting the overview of the weld interface for AA6111-T4-HSLA 340 bare, AA6111-T4-HSLA 340 HDGI, AA6111-T4-HSLA 340 e-coated and Aural 2-HSLA 340 HDGI pairs, respectively. The micrographs depicting the overview of the weld interface for the similar Al—Al weld joints (AA6111 T4-AA6111-T4 and Aural 2-Aural 2 with and without interlayer) have been provided in FIGS. 11A-11C. FIGS. 12C and 12E depict the use of an AA3003 interlayer in the AA6111-T4-HSLA 340 HDGI steel pair and Aural 2-HSLA 340 HDGI steel pair, respectively. It was found that the use of the interlayer for the AA6111-T4-HSLA 340 weld pair led to reduced thinning of the Al flyer at the location of the machined pocket (29% with interlayer and 36% without interlayer, FIGS. 12B and 12C) and enhancement of mechanical properties compared to the other weld pairs as discussed previously. Comparing micrographs for AA6111-T4-HSLA 340 bare and AA6111-T4-HSLA 340 HDGI pairs as shown in FIGS. 12B and 12C, respectively, it is quite clear that the use of interlayer significantly reduced the deformation or thinning of the Al flyer, which led to improved joint strength in coach peel configuration. The interface contains an unwelded center zone as depicted in FIG. 12B and is symmetric about the center with interface waves appearing on both sides of it. The waves in the interface are depicted in FIGS. 12B and 12E. The interface based on the combination of impact angle and velocity can also be flat with the presence of a continuous IMC layer as depicted in FIG. 12D. The weld is visibly free of any discontinuities, and the interface appears clean. The metal jet, an inherent characteristic of impact welding processes, is also noted in this example, as evidenced by the trapped jet marked in the figures. The jet gets trapped at the edges of the weld spot due to the nature of the welding approach employed. However, these trapped jet locations are outside the active weld zone and thus, very found to largely have little to no influence on the joints' mechanical properties. A close up of the trapped jet is presented in FIG. 12C. However, it would be interesting to understand the extent of the trapped jet along the length of the weld and its impact on fatigue. Also, ascertaining the location of the trapped jet relative to where the button pulls out would be useful, and the authors' are working on the same. Although local removal of coating for the e-coated steel was performed, it is seen from FIG. 12D that the coating is still intact outside the weld spot; additional details are provided in the following subsection

### Weld Sample Surface Appearance

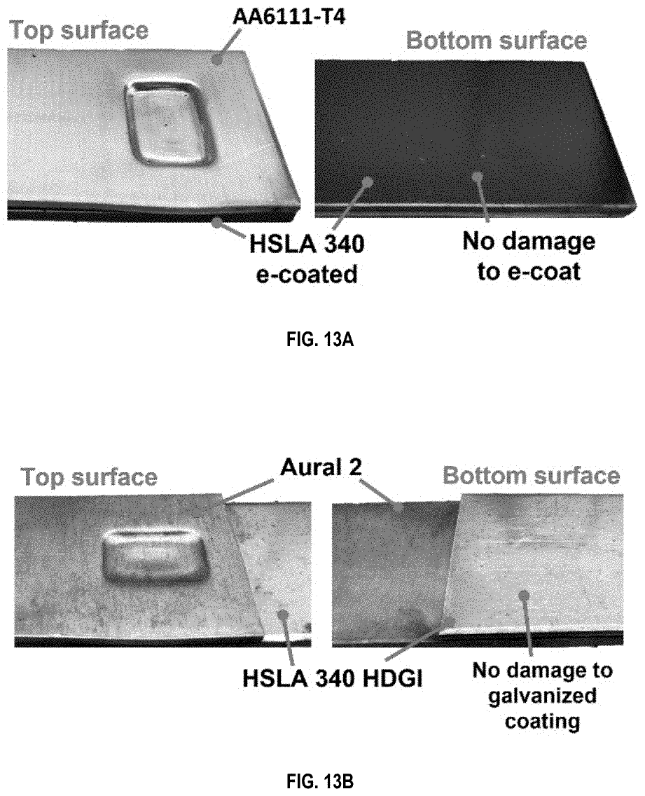

FIGS. 13A and 13B display the top and bottom surfaces of the welded samples for AA6111-T4-HSLA 340 HDGI and Aural 2-HSLA 340 HDGI pairs, respectively. The top surface represents the Al flyer, where the weld spot in the form of a deformed pocket can be seen. In both the weld pairs, the deformed pocket is visibly clean and free from damage, this being especially crucial for a low ductility alloy like Aural 2. Also, the flyer is not subjected to any macroscopic dimensional change in spite of the impact. The bottom surface, i.e., the surface of the target steel sheet, is also visibly free of any mechanical and dimensional damage. What may be quite significant is the ability to produce joints with flat lower surfaces, as seen in FIGS. 13A, and 13B. There is also no thermal damage, as it would be part of any fusion welding process. Another important aspect is that the coating on the bottom surface is left completely undamaged (through visual inspection) regardless of the nature of the coating (e-coat, galvanized). This can open opportunities for manufacturers to join pre-painted panels/sheets, which otherwise is a difficult to impossible proposition through the widely used resistance spot welding process. FIGS. 8A-9D, depicting the failed samples, provide an idea of the faying surfaces post welding. For all the weld pairs, the faying surfaces in and around the nugget also do not show any signs of damage. For AA6111-T4-HSLA 340 HDGI and Aural 2-HSLA 340 HDGI pairs, the galvanized coating on the faying surface of the steel is left unperturbed. For AA61111-T4-HSLA 340 e-coated pair, deposits are seen on the e-coated steel surface (FIGS. 8C and 9C), however, these are surface deposits only and do not penetrate the coating. The coating in and around the nugget still remains damage-free.

### Conclusions

A new impact welding approach utilizing VFAW was reported in this example. Such impact welding approach enables dissimilar spot welding of automotive-grade Al alloys (heat treatable AA6111-T4 and Aural 2) to three different varieties of HSLA 340 steel (bare, galvanized and e-coated). VFAW welds were successfully produced using low input energy of 2.5 kJ.

Further, the use of the machined pocket approach enabled the production of samples with flat bottom surfaces without any damage to the external coating. An interlayer was required for the joining of Al to galvanized steel. Prior to joining Al to e-coated steel, the e-coat on the faying surface can be removed locally via machining.

Also, standardized lap-shear and coach peel testing revealed strong Al-steel joints in all the welding pairs. All the tested samples displayed the preferred mode of button pullout failure. For AA61111-T4-HSLA 340 steel pairs, the failure loads were on par with similar Al—Al joint in both lap-shear and coach peel configurations, while for Aural 2-HSLA 340 HDGI, the failure loads were higher than homogeneous Al—Al joints.

In this example, the disclosed structure is inhomogeneous due to the presence of the wave structure. The machining of the flyer had minimal effect on the overall joint, as the failure was governed by tearing of the Al outside the pocket. Macroscopically, no visible damage was observed in the machined pocket region.

The results that are shown in this example open avenues for enabling joining of industrially relevant materials, including advanced and ultra-high-strength steels (>1 GPa strength) with or without pre-treatments, coatings, or paint to high-strength wrought and cast Al alloys.

### Example 2: Enabling Dissimilar Joining of Coated Steels to Aluminum Through Impact Spot Welding

### Materials and Experimental Procedures

The Al alloy chosen for this study was 0.9 mm thick Al 6022 T4, joined to 2.5 mm thick galvanized HSLA 350 steel (weld pair 1) and 1.2 mm thick galvannealed DP 590 (weld pair 2). The sheets were cut into dimensions of 125 mm×40 mm. The faying metal surfaces were cleaned with acetone only prior to welding. The coating on the steels was Zn based with thicknesses close to 17 μm and 6 μm on HSLA 350 and DP 590, respectively. FIG. 14A depicts the schematic of the weld setup used to produce the spot welds. For this study AA 6022 T4 was kept as the flyer sheet and was driven towards the preformed steel (target sheet) to create the joint by rapid vaporization of a foil actuator. The VFAW procedures have been published previously, for example, in Kapil et al. Journal of Materials Processing Technology 255, (2018): 219-233 and Kapil et al. Journal of Materials Processing Technology 37, (2019): 42-52 and are incorporated herein by reference. AA 1100 foil (0.0762 mm thick) was chosen as the foil actuator, with dimensions provided in inventors' previous study (Kapil et al. Journal of Materials Processing Technology 255, (2018): 219-233).

The weldability of the material members in an impact welding process like VFAW depends upon various factors, the most crucial, however, being the combination of angle and velocity at which the flyer sheet collides with the target sheet. The range of desirable angle and velocity varies with material pairs, however, ideally, sound joints have been found to form when the angle and velocity range between 5-200 and 300 to 1000 m/s, respectively. Without wishing to be bound by any theory, it is assumed that a combination of these two parameters can affect the weld morphology, the weld interface characteristic and eventually the properties of the joint. One of the ways these two parameters can be controlled is by the design of the standoff between the flyer and the target sheets. Variation in standoff changes the velocity and angle at which the flyer sheet impacts the target sheet. It has been previously found that lower standoffs lead to higher melting and lower wave amplitude, whereas higher standoffs reduce the melting and increase interface waviness, thereby aiding in the improvement of joint properties. A new asymmetric preform shape, as shown in FIG. 14A was used in this example, which gave control of the impact angle and provided a variable standoff during the weld progress. The target sheet was preformed to provide the requisite standoff (3 mm maximum, region 2, FIG. 14A) for the flyer to accelerate and impact the target. A heat-treated S7 steel asymmetric die that gave control of the initial impact angle (150 in inclined zone (region 1, FIG. 14A)) was used as the backing for the target sheet. The workpiece and the bottom anvil were electrically insulated from the foil with polyester tape. The ends of the foil were connected to a Maxwell-Magneform capacitor bank, with a maximum discharge energy of 16 kJ. The foil active area was centered towards the inclined zone. Weld pairs 1 and 2 were produced at energies of 6 and 8 kJ, respectively. FIG. 14B depicts the schematic arrangement of welding for lap-shear configuration, whereas FIG. 14C and FIG. 14D show representative images of welded samples in lap-shear and coach-peel configuration, respectively.

Spot welded samples were subjected to rate controlled (0.1 mm/s) lap-shear and coach-peel tests using an MTS 810 mechanical test frame to evaluate the failure loads and modes. During the testing, shims were placed in the grips of the test frame to maintain coplanar alignment. To evaluate the performance of the dissimilar Al-coated steel joints, similar Al—Al welds were also prepared (at 6 kJ input energy) and subjected to lap-shear and coach-peel tests. Additional samples were prepared for each weld pair under the same operating parameters and were sectioned using an abrasive saw, mounted and polished to 1 μm finish using standard metallographic procedures. Backscattered-electron imaging of the weld interface was conducted using an FEI Apreo field emission scanning electron microscope.

### Mechanical Testing

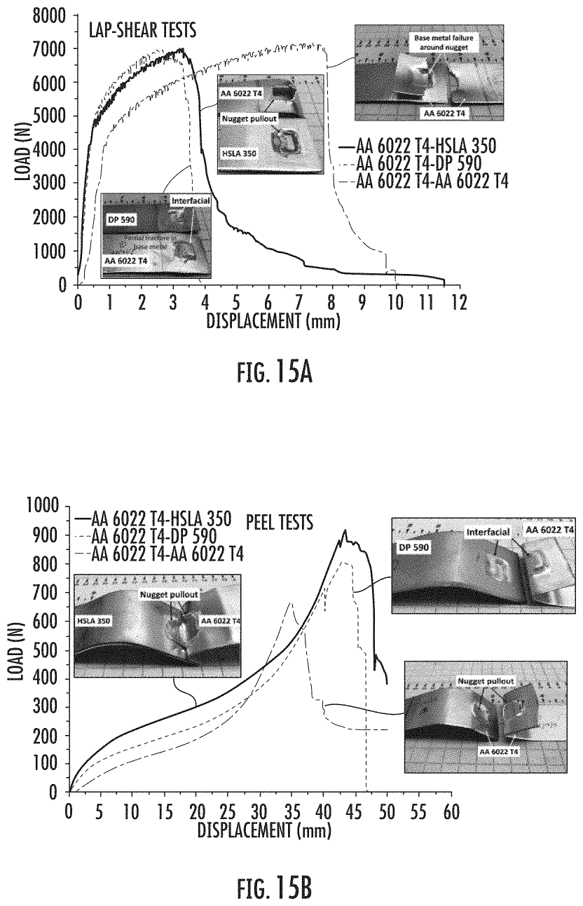

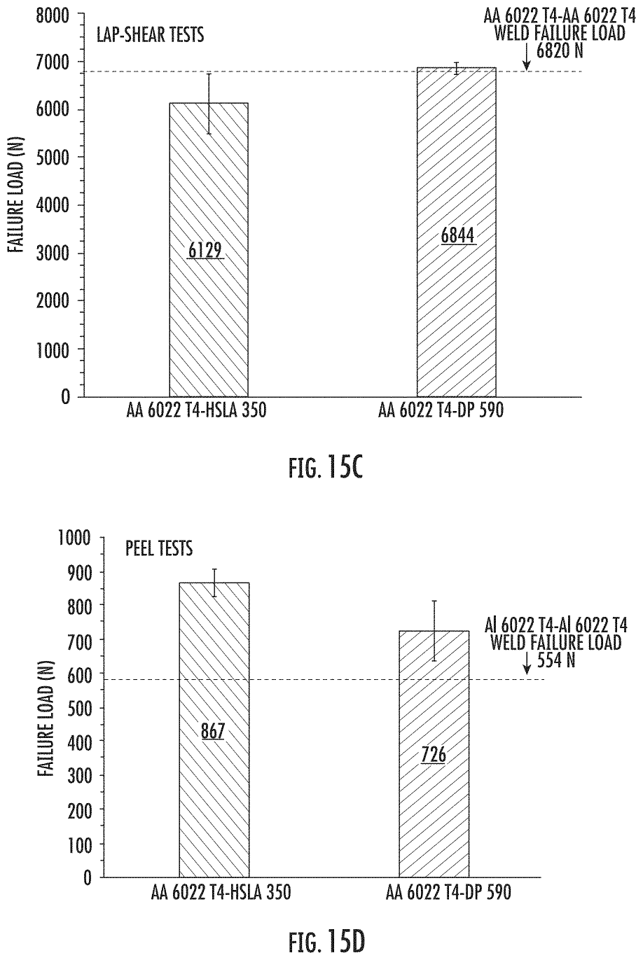

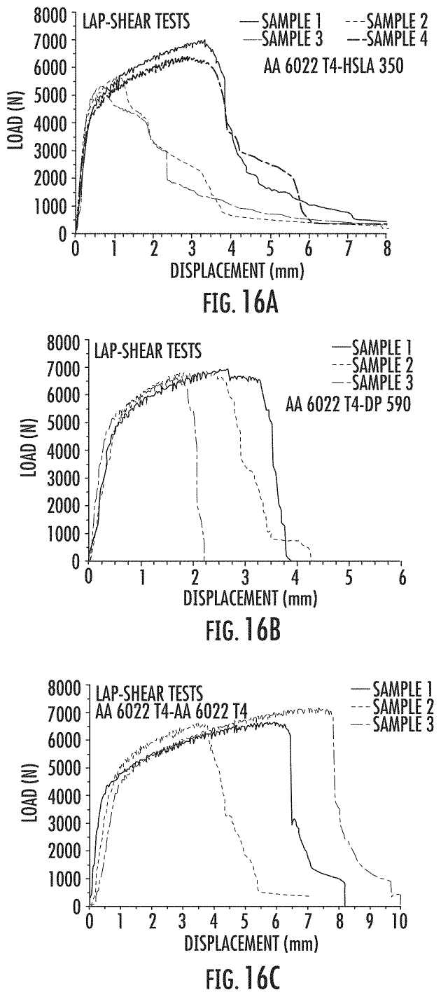

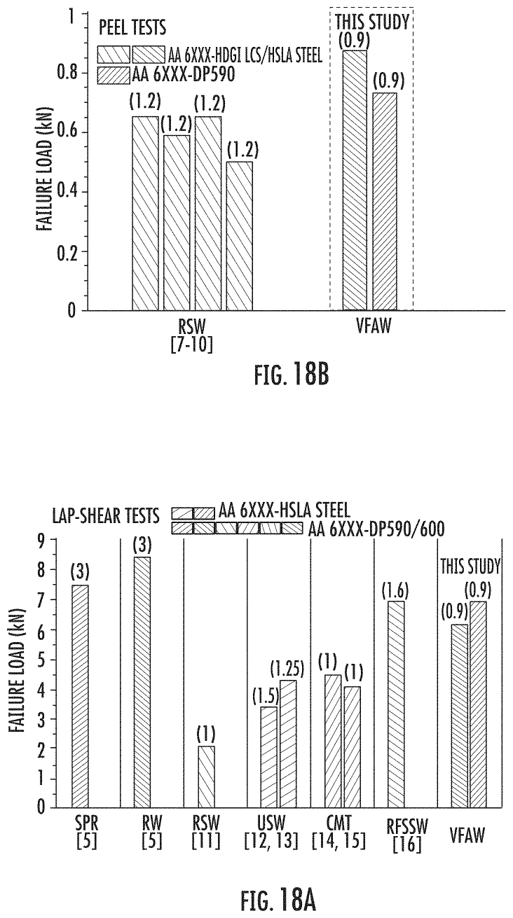

FIGS. 15A and 15B present the representative load-displacement curves and the photographs of the corresponding failed samples for lap-shear and coach-peel configuration, respectively, for both the weld pairs and similar Al—Al joint. The load-displacement curves for all the evaluated samples in both lap-shear and peel configurations are presented in supplementary data along with a summary of all the conducted tests (see FIGS. 16A-C and 17A-C and Tables 7 and 8). AA 6022 T4-HSLA 350 joint failed with a nugget pullout mode in both lap-shear and peel tests. The AA 6022 T4-DP 590 joint had an interfacial failure in both testing modes, however, a partial fracture in the Al base metal was initiated during the lap-shear test. The corresponding AA 6022 T4-Al 6022 T4 similar joint failed in the base metal around the nugget in lap-shear, whereas in peel tests, it left a complete nugget. The failure modes in all the tested samples were found to be consistent with the representative modes depicted in FIGS. 15A, and 15B. A summary of the failure loads for the joints evaluated is presented in FIGS. 15C and 15D. The AA 6022 T4-HSLA 350 pair failed at average loads of 6.1 kN and 0.86 kN in lap-shear and coach-peel, respectively, whereas the AA 6022 T4-DP 590 failed at average loads of 6.8 kN and 0.73 kN in lap-shear and coach-peel, respectively. Both the dissimilar weld pairs performed better than the similar Al—Al joint in coach-peel configuration and had almost similar performance in the lap-shear configuration. It was noted that the performance of the joints (failure load and mode) was also affected by the extent of thinning and damage to the mating members due to deformation and impact. From FIGS. 18A and 18B, it can be observed that as compared to competing welding techniques, the VFAW Al-coated steel welds displayed higher failure loads in most cases for both lap-shear and coach-peel configurations, however, the biggest advantage of the welding approach presented in this study over other techniques was the ability to weld through coatings and avoiding any pre-weld surface preparation. Table 9 supplements the data presented in FIGS. 18A, and 18B.

TABLE 7
Summary of lap-shear tests

| | | Failure load | Average failure |
|---|---|---|---|
| Material pair | Sample | (kN) | load (kN) |
| AA 6022 T4-HSLA 350 | 1 | 7.01 | 6.1 |
| | 2 | 5.71 | |
| | 3 | 5.37 | |
| | 4 | 6.41 | |
| AA 6022 T4-DP 590 | 1 | 6.97 | 6.84 |
| | 2 | 6.89 | |
| | 3 | 6.66 | |
| AA 6022 T4-AA 6022 T4 | 1 | 6.65 | 6.81 |
| | 2 | 6.62 | |
| | 3 | 7.17 | |

TABLE 8
Summary of peel tests

| | | Failure load | Average failure |
|---|---|---|---|
| Material pair | Sample | (kN) | load (kN) |
| AA 6022 T4-HSLA 350 | 1 | 0.92 | 0.86 |
| | 2 | 0.62 | |
| | 3 | 0.82 | |
| | 4 | 0.85 | |
| AA 6022 T4-DP 590 | 1 | 0.81 | 0.72 |
| | 2 | 0.63 | |
| AA 6022 T4-AA 6022 T4 | 1 | 0.46 | 0.55 |
| | 2 | 0.52 | |
| | 3 | 0.67 | |

TABLE 9
Material data and other attributes for comparison of peak failure
load of VFAW spot joints with other joining techniques. All steels
mentioned in comparison are coated. (The table supplements the data
presented in FIGS. 18A and 18B.) Regarding Acronyms: SPR =
Self-piercing riveting, RW = Rivet welding, RSW = Resistance
spot welding, USW = Ultrasonic spot welding, CMT = Cold metal
transfer, RFSSW = Refill friction stir spot welding, VFAW =
Vaporizing foil actuator welding, BP = Button pullout, IF =
Interfacial.

| | | | | |
|---|---|---|---|---|
| | | Coupon | Failure | |
| | Materials | dimension | load | |
| Process | (thickness) | (mm × mm) | (kN) | Failure mode |

Lap-Shear Tests

| | | | | |
|---|---|---|---|---|
| SPR^{a} | AA 6061 T6 (3 | 130 × 38 | 7.5 | Not mentioned |
| | mm) | | | |
| | DP590 (1.2 mm) | | | |
| RW^{a} | AA 6061 T6 (3 | 125 × 40 | 8.4 | Separation of |
| | mm) | | | steel form rivet |
| | DP590 (1.2 mm) | | | and AI |
| RSW^{b} | AA 6061 T6 (1 | 130 × 30 | 2.1 | IF |
| | mm) | | | |
| | DP590 (1.6 mm) | | | |
| USW^{c,d} | AA6061 T6 (1.5 | 60 × 15 | 3.4 | IF and through |
| | mm) | | | thickness |
| | HSLA steel (1.5 | | | |
| | mm) | | | |
| | AA6111 T4 (1.25 | 60 × 15 | 4.3 | IF and BP |
| | mm) | | | |
| | HSLA steel (1.2 | | | |
| | mm) | | | |
| CMT^{e,f} | AA 6061 T6 (1 | 130 × 38 | 4.5 | BP |
| | mm) | | | |
| | DP590 (1.2 mm) | | | |
| | AA 6061 T6 (1 | 130 × 38 | 4.1 | BP |
| | mm) | | | |
| | DP590 (1.2 mm) | | | |
| RFSSW^{g} | AA 6022 T6 (1.6 | 100 × 30 | 6.95 | IF and BP |
| | mm) | | | |
| | DP600 (2 mm) | | | |
| VFAW | AA 6022 T4 (0.9 | 125 × 40 | 6.2 | BP |
| | mm) | | | |
| | HSLA 350 steel | | | |
| | (2.5 mm) | | | |
| | AA6022 T4 (0.9 | 125 × 40 | 6.9 | IF |
| | mm) | | | |
| | DP590 (1.2 mm) | | | |

Peel Tests

| | | | | |
|---|---|---|---|---|
| RSW^{h,i,j,k} | AA 6022 T4 (1.2 | 80 × 38 | 0.65 | IF and Partial |
| | mm) | | | BP |
| | Low carbon steel | | | |
| | (2 mm) | | | |
| | AA 6022 T4 (1.2 | 126 × 38 | 0.58 | BP |
| | mm) | | | |
| | Low carbon steel | | | |
| | (2 mm) | | | |
| | AA 6022 T4 (1.2 | 126 × 38 | 0.65 | Partial BP |
| | mm) | | | |
| | Low carbon steel | | | |
| | (2 mm) | | | |
| | AA 6022 T4 (1.2 | 127 × 38 | 0.5 | BP |
| | mm) | | | |
| | Low carbon steel | | | |
| | (2 mm) | | | |
| VFAW^{l} | AA6022 T4 (0.9 | 125 × 40 | 0.87 | BP |
| | mm) | | | |
| | HSLA 350 steel | | | |
| | (2.5 mm) | | | |
| | AA6022 T4 (0.9 | 125 × 40 | 0.73 | IF |
| | mm) | | | |
| | DP590 (1.2 mm) | | | |

The comparative results are related to the following references:
^{a}Lou et al., Journal of Materials Processing Technology 214, no. (10) (2014): 2119-2126.;
^{b}Zhang et al., Journal of Manufacturing Processes 44, (2019): 19-27;
^{c}Mirza et al., Materials Science and Engineering: A 690, (2017): 323-336;
^{d}Macwan et al., Materials & Design 113, (2017): 284-296;
^{e}Lei et al., Journal of Manufacturing Science and Engineering 137, no. 5 (2015): 051028-1-051028-10;
^{f}Lei et al., Journal of Manufacturing Science and Engineering 138, no. 7 (2016): 071009-1-071009-13;
^{g}Shen et al., Science and Technology of Welding and Joining 23, no. 6 (2018): 462-477;
^{h}Chen et al., Journal of Materials Processing Technology 265, (2019): 158-172;
ⁱRao et al., International Journal of Fatigue 116, (2018): 13-21;
^{j}Chen et al., Journal of Materials Processing Technology 252, (2018): 348-361;
^{k}Chen et al., Materials Science and Engineering: A 735, (2018): 145-153;
^{l}Present example.

### Weld Morphology

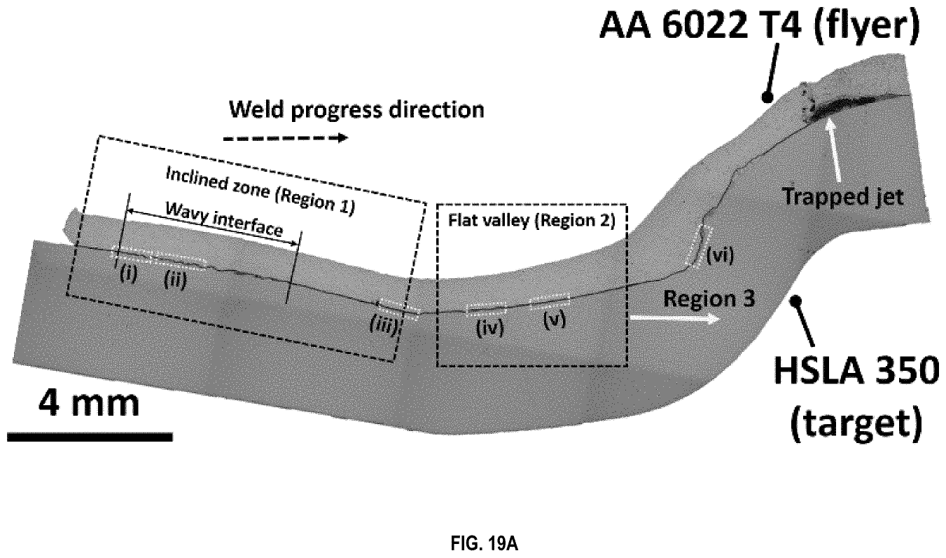

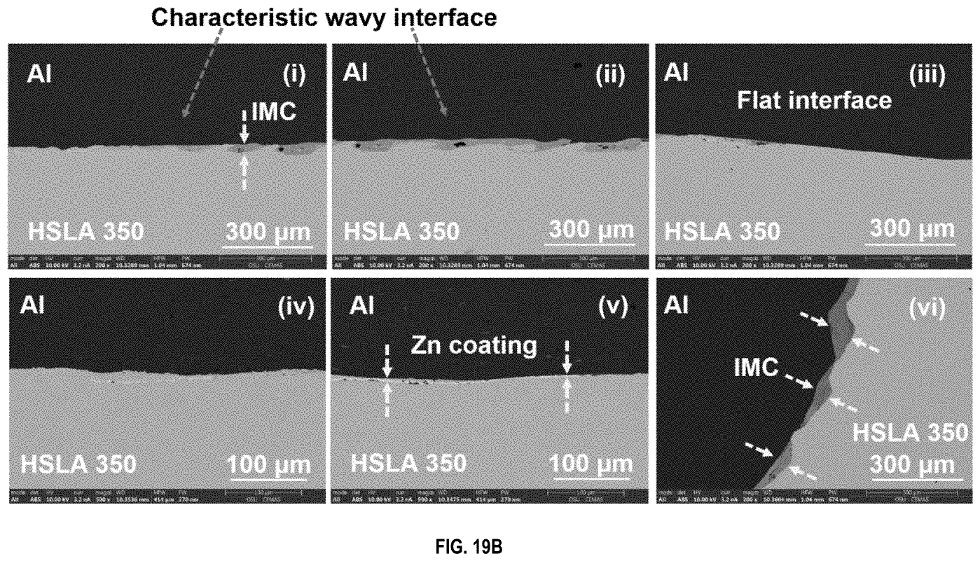

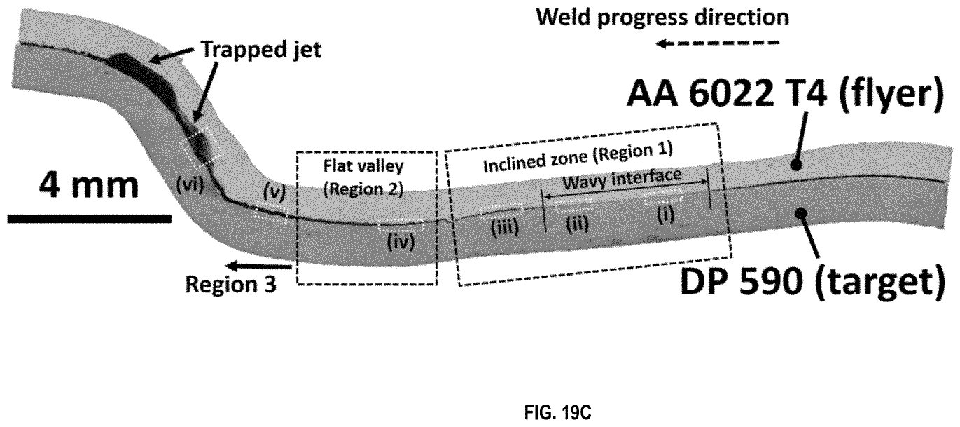

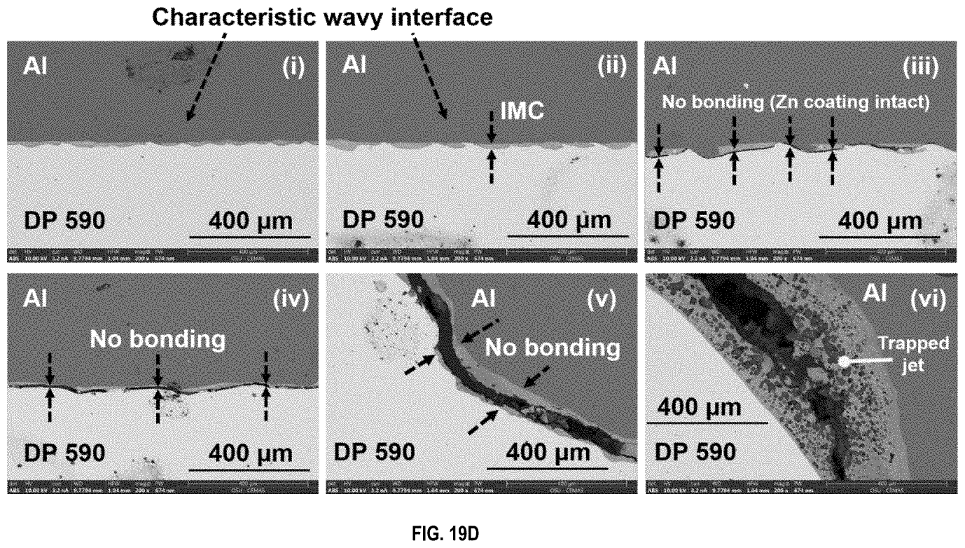

FIGS. 19A and 19C depict an overview of the weld interface for AA 6022 T4-HSLA 350 and AA 6022 T4-DP 590 welded spot joints, respectively. The non-homogeneous nature of the weld can be clearly observed, suggesting that the collision propagated in a non-uniform way along the interface. The absence of a heat affected zone, negligible thinning and effective metallurgical bonding in the welded area is clearly visible in both the macrographs. The inclined zone (region 1) where the initial impact of flyer Al with target steel took place displayed typical wavy morphology in both weld pairs (FIGS. 19B(i and ii) and 19D(i and ii)), the waves being more pronounced in AA 6022 T4-HSLA 350 pair. The presence of the wavy interface is a feature discrete to impact welding and indicates successful joining. It can also be observed from the macrographs that there is a certain incubation distance from the initial point of impact for the steady waves to initiate. In the flat valley (region 2), the interface changed from wavy to flat due to the change of impact angle. In this region, the AA 6022 T4-HSLA 350 pair had continuously bonded regions, unlike the AA 6022 T4-DP 590 pair. Without wishing to be bound by any theory, this was assumed to be due to the fact that the coating was still intact or could not be jetted off in for the later weld pair (harder galvannealed layer), as seen from the SEM micrographs in FIGS. 19B(iv) and 19D(iv and v). Another possible and unlimiting reason for the presence of unbonded regions could have been a change of impact angles towards lower values as the weld progressed. In the case of the AA 6022 T4-HSLA 350 pair, the bonding in region 2 was also due to the possible formation Al—Zn—Fe intermetallic compound (IMC). Thus, the effective weld region/area for the AA 6022 T4-DP 590 pair is less and could be one of the exemplary and unlimiting reasons for lower failure loads in peel. Region 3 in both cases remains unbonded and displays the presence of IMC's as well as trapped jet. Due to the design of the asymmetric die, the jetted metal gets trapped at the edges of the weld spot, however, the locations of these trapped jets are outside the active weld zone and thus assumed to largely have very little influence on the mechanical properties of the joint.

### Conclusions

In this example new impact welding approach in VFAW that utilized an asymmetric die design shown to enable direct spot welding of AA 6022 T4 Al alloy to two varieties of steel: galvanized HSLA 350 and galvannealed DP 590.

Further, this example has shown that in the reported welding approach, any pre weld surface preparation can be avoided, providing, for the first time, the ability to spot weld through coatings.

Also, standardized mechanical testing revealed strong Al-coated steel joints with failure loads higher in coach-peel and similar in lap-shear can be formed when compared with similar Al—Al joints. The performance of the VFAW joints was better in most cases when compared with other competing welding techniques.

The weld interface, in this example, displayed a hierarchical structure with the presence of a typical wavy morphology for both the weld pairs. Without wishing to be bound by any theory, it was assumed that the asymmetric design can enable the coating to be jetted off during the high-speed impact leading to metallurgical bonding.

The results that are shown in this example open avenues for enabling joining of industrially relevant materials, including advanced and ultra-high-strength steels (>1 GPa strength) with or without pre-treatments, coatings, or paint to high-strength wrought and cast Al alloys

### Example 3: Joining Aluminum Alloy to Ultrahigh-Strength Boron Steel Through an Impact Welding Approach

### Materials and Experimental Procedures

The materials used in this study were 1 mm thick Al alloy 6022-T4, and 1.4 mm thick Usibor. FIG. 20A presents a schematic cross-section depicting the welding configuration employed. Unlike previous VFAW studies, a new approach of creating the standoff was employed in this study. The target sheet (Usibor) was machined to create a pocket in the faying surface that provided the requisite standoff, as shown in FIG. 20A. The depth of the machined pocket was 0.7 mm for all experiments. In commercial production, this pocket could possibly be stamped. According to some of these procedures, the Al sheet was driven towards the steel target by the rapid vaporization of a foil actuator, leading to the formation of a nominally solid-state joint. FIGS. 20B and 20C depict the geometry and dimensions of the foil actuator and the weld specimen, respectively. FIG. 20D depicts the configuration of the machined pocket with respect to the foil. An ultrafast capacitor bank with a current rise time of 6 μs, capacitance of 50 μF, inductance of 200 nH and maximum discharge energy of 4.2 kJ was employed. The faying metal surfaces were cleaned with acetone prior to welding. All the spot welds in this study were produced at an energy level of 2 kJ. This example employed an ultrafast capacitor bank with a rise time of 6 μsit was found that increasing the current deposition rate in the foil actuator can significantly increase the efficiency of the process. The welded samples were subjected to lap-shear testing with a stroke rate of 0.1 mm/sec. The properties of the welds were evaluated based on the results of the mechanical tests. The failure loads for the VFAW joints were compared with the other competing joining techniques.

### Results and Discussions

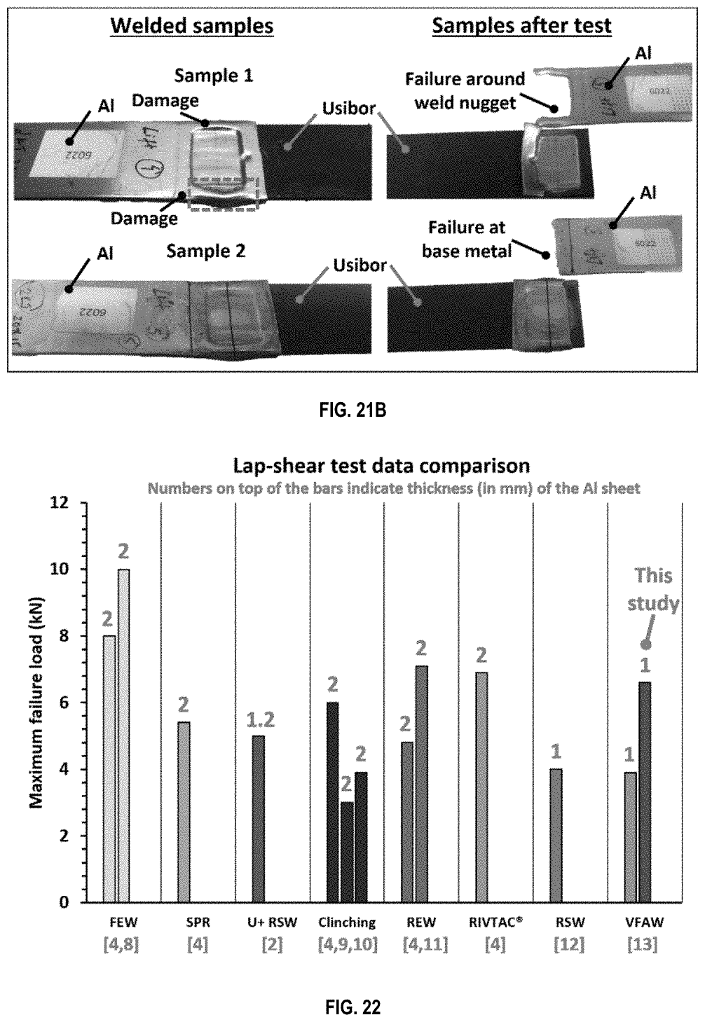

FIG. 21A depicts the load-displacement curves for Al 6022-T4-Usibor welded samples, whereas FIG. 21B displays the samples in the as-welded and post-failure states. The tested samples reported failure loads of 5.6 kN and 6.6 kN, respectively, with failure occurring at the Al base metal (BM) outside the weld spot, thereby leaving a complete nugget in both cases. The failure mode corresponds with the load-displacement curves where significant deformation before failure could be seen. Such characteristic curves are desirable as they allow higher energy absorption capabilities as well as transmission of higher forces. It is, however, to be noted that the joint performance in impact welding processes like VFAW can also be controlled by the amount of thinning and damage to the mating members due to the inherent nature of the process. In this example, the difference in the failure loads between the tested members was also caused by the state of the deformed Al flyer post-impact, as seen by the damage and shearing of the Al sheet around the edges of the weld spot, as marked in FIG. 21B. It was found, however, that the damage of the mating members can be optimized by modifying the geometry and dimensions of the machined pocket and is part of the authors' ongoing work.

A comparison of the lap-shear failure loads for dissimilar 6XXX series Al alloy-boron steel joints created by different joining techniques with VFAW is presented in FIG. 22. However, it is to be noted that the different compared processes had variation in material combinations, thicknesses, geometries, failure modes etc., and thus, the comparison is only approximate and requires additional studies to provide an exact picture. The joint failure loads were compared in this study instead of the strength values. This is because the failure occurred in the base metal in almost all the compared processes, making it difficult to accurately calculate the actual bonding area. Also, in the case of impact welded joints like VFAW, the joint consists of an unbonded zone at the center, the size of which varies according to the input parameters, and thus it is difficult to measure the actual bond area if the failure is at the base metal and not interfacial. The attributes for all the processes compared are presented in Table 10. It can be observed from FIG. 22 that the VFAW welds produced in this work performed better than most processes, however the biggest breakthrough achieved in this work was the ability to produce the joints in a single step at a minimal energy level of 2 kJ, without the introduction of an auxiliary element or a metal insert.

TABLE 10
Material data and other attributes for comparison of peak failure load of
dissimilar VFAW spot joints with other joining techniques. This table supplements the
data shown in FIG. 22. Regarding Acronyms: FEW= Friction element welding, SPR =
Self-piercing riveting, U + RSW = Ultrasonic plus resistance spot welding, REW =
Resistance element welding, RSW = Resistance spot welding, VFAW = Vaporizing
foil actuator welding, BP = Button pullout, BM = Base metal.

| | | Coupon | Failure | | |
|---|---|---|---|---|---|
| | Materials | dimension | load | Failure | |
| Process | (thickness) | (mm × mm) | (kN) | mode | Attributes |
| FEV^{m,n} | AI 6016 TC | 105 × 45 | 8 | Failure in | Welded joints heat |
| | (2 mm) | | | AI BM | treated at 180° C. |
| | 22MnB5 | | | | for 30 minutes |
| | (1.5 mm) | | | | |
| | AI 6005 T5 | Not | 10 | Partial | Use of Cr—Mo steel |
| | (2 mm) | mentioned | | thickness | friction element |
| | Usibor | | | with BP | |
| | 1500 (1.4 | | | | |
| | mm) | | | | |
| SPR^{m} | AI 6016 T6 | 105 × 45 | 5.4 | Failure in | Welded joints heat |
| | (2 mm) | | | AI BM | treated at 180° C. |
| | 22MnB5 | | | | for 30 minutes |
| | (1.5 mm) | | | | |
| U + RSW^{o} | AA 6022 T4 | 125 × 38 | 5 | BP | Two stage process, |
| | (1.2 mm) | | | | use of SS316 |
| | Usibor | | | | insert |
| | 1500 (1.4 | | | | |
| | mm) | | | | |
| Clinching^{m,p,q} | AI 6016 T6 | 105 × 45 | 6 | Failure in | Welded joints heat |
| | (2 mm) | | | AI BM | treated at 180° C. |
| | 22MnB5 | | | | for 30 minutes |
| | (1.5 mm) | | | | |
| | AI 6061 T4 | 100 × 25 | 3 | Failure in | Hole clinching |
| | (2 mm) | | | AI BM | |
| | 22MnB5 | | | | |
| | (1.6 mm) | | | | |
| | AI 6016 T4 | 105 × 45 | 3.9 | Failure in | Single-stage shear |
| | (2 mm) | | | AI BM | clinching |
| | 22MnB5 | | | | |
| | (1.5 mm) | | | | |
| REW^{m,r} | AI 6016 T6 | 105 × 45 | 4.8 | Failure in | Welded joints heat |
| | (2 mm) | | | AI BM | treated at 180° C. |
| | 22MnB5 | | | | for 30 minutes |
| | (1.5 mm) | | | | |
| | AI 6061 T4 | 100 × 25 | 7.1 | Failure in | Use of auxiliary |
| | (2 mm) | | | AI BM | element in the form |
| | 22MnNoB | | | | of a steel rivet |
| | (1.8 mm) | | | | |
| RIVTAC ® ^{m} | AI 6016 T6 | 105 × 45 | 6.9 | Failure in | Welded joints heat |
| | (2 mm) | | | the insert | treated at 180° C. for |
| | 22MnB5 | | | element | 30 minutes |
| | (1.5 mm) | | | | |
| RSW^{s} | AI 6016 T4 | 100 × 35 | 4 | Interfacial | Two stage process, |
| | (1 mm) | | | | use of Cu and Fe |
| | 22MnB5 | | | | based inserts |
| | (1.5 mm) | | | | |
| VFAW^{t,u} | AI 6111 T4 | Not | 3.9 | Failure in | Direct welding, high |
| | (1 mm) | mentioned | | AI BM | input energy |
| | 22MnB5 | | | | |
| | (1.2 mm) | | | | |
| | AA 6022 T4 | 100 × 25 | 6.6 | Failure in | Direct welding of AI |
| | (1 mm) | | | AI BM | to Usibor, low input |
| | Usibor | | | | energy |
| | 1500 (1.4 | | | | |
| | mm) | | | | |

The comparative results are related to the following references:
^{m}Meschut et al., J Mater Eng Perform 2014; 23(5): 1515-23;
ⁿOliveira et al., J Mater Process Tech 2019; 273, 116192;
^{o}Lu et al. Metall Mater Trans A 2020; 51(1): 93-8;
^{p}Lee et al., J Mater Process Tech 2014; 214(10): 2169-78;
^{q}Hörhold et al. Weld World 2016; 60(3): 613-20;
^{r}Ling et al. Mater Manuf Process, 2016; 31(16): 2174-80;
^{s}Zvorykina et al., J Mater Process Tech 2020; 116680;
^{t}Liu et at, Metall Mater Trans A 2018; 49(3): 899-907;
^{u}Present example

### Conclusions

In this example, an innovative impact welding approach using VFAW was reported. It was shown that this approach enabled direct spot welding of 6022-T4 Al alloy to ultrahigh-strength Usibor steel. All the welds were successfully produced in a single step at an energy of 2 kJ without the use of any metal insert and resulted in an undisturbed back surface of the Usibor target plate, which can have practical advantages in joining to coated materials while maintaining aesthetics and corrosion resistance.

Further, the lap-shear testing revealed strong dissimilar Al-steel joints with a peak failure load of 6.6 kN. Tested samples failed in the Al BM, leaving a complete nugget.

Also, the disclosed example shows further options for the development of more robust welding pairs, including UHSS with coatings or pre-treated surfaces to other varieties of high-strength Al alloys.

### Example 4

Some exemplary systems 100 disclosed in FIG. 23. For example, the first metal (flyer) 102 shown in this example is flat relative to the central axis of this metal. The second metal (target) 106 that is positioned on the support 108, however, has a bent second portion. The two pieces are aligned to form a gap that is also maintained by the spacers 104. The welded pair in this example is HSLA 350 (bare)-6HS2-T4, and the energy used to form the weld is 8 kJ. The photographs of the formed and separated weld are shown on the right side of the figure. It was found that the bending angle on the target part 106 can be optimized to achieve a better weld.

### Example 5

Referring to FIG. 24 This example shows the welding process utilizing the laser as an energy source. A second metal part (target) 204 is aligned with a first metal (flyer) 202 such that a gap 205 is formed between the first portion of the first surface 201 of the first metal part and a first portion of the second surface 203 of the second metal part.

An energy source 214 is applied to the second surface 207 of the first metal part 202 at a predetermined location. This metal part 202 comprise at least two segments 202a and 202b, wherein a first segment 202a has a main axis 209 and wherein a second segment 202b is bent at a predetermined angle 211 relative to the main axis 209 of the first segment 202a. In this specific example, the second metal part has one segment 204 that is in parallel to the main axis 209 of the first segment 202a of the first metal part 202. The example further shows a first layer 208, a second layer 210 and a third layer 212 of the auxiliary multilayer member. The welding sticker 206 provides confinement to the plasma generated from the interaction of the laser beam and metal surface so as to provide a force between the backing and metal. Further, energetic chemical compounds, or second layer (210) can also generate a high-pressure gas that can further move the first metal part (202) downward at high speed.

FIG. 25 shows a system where the first metal part has only one segment 202 that is parallel to the second metal part 204, and the gap 216 is formed by a recess within the second metal part 204.

### Example 6

Referring to FIG. 26. FIG. 26 shows a first member 302 of an exemplary system 300, a body having a central axis 306 along a length of the body and a first surface 307, wherein at least a portion of the surface defines a recess 301 having a first dimension and comprising two or more segments (303 and 305), wherein the segments are not substantially symmetrical to each other in a plane bisecting the recess and a second member 304 comprising a mount 309 having a second dimension configured to be substantially fit within the recess.

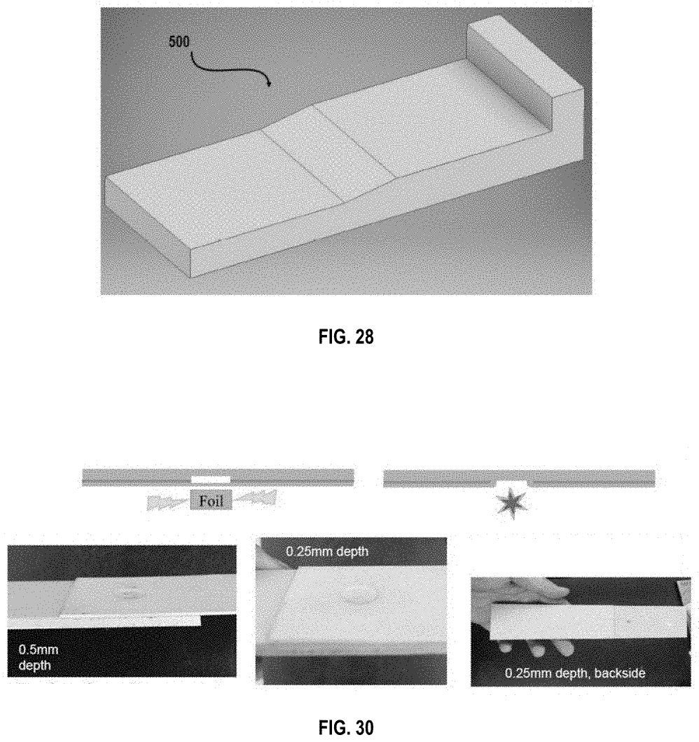

FIG. 27 shows a body (die) 402 having two or more segments 403. The second metal 408 is positioned within the recess. The first metal 406 is disposed on the at least a portion of the second metal part to form a gap 407. The auxiliary multilayer member 410 is positioned on the first metal such that the active area 412 of the auxiliary multilayer member is positioned below the gap, preferably offset toward the angled edge of the second metal. FIG. 28 shows an additional die 500 that can be used in any aspect.

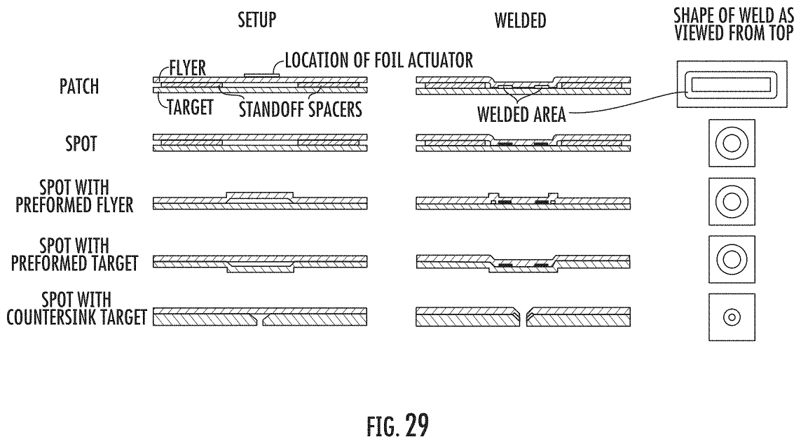

FIG. 29 shows various configurations of the first (flyer) metal part and the second (target) metal part and standoff spacers and the resulting shape of the weld as viewed from the top.

FIG. 30 shows a schematic representation of the disclosed herein methods and the weld obtained on the coated surfaces. In this specific example, a small grove of about 10 mm diameter was machined in the target (7075), and a small amount of the coating was eliminated in the faying area of the flyer (7075). The auxiliary member (foil) was used to assist in forming the weld. Energies between 1.6 kJ and 2.4 kJ were used. It can be seen that substantially no deformation was provided to any portion of the target or the flyer outside of the welded portion.

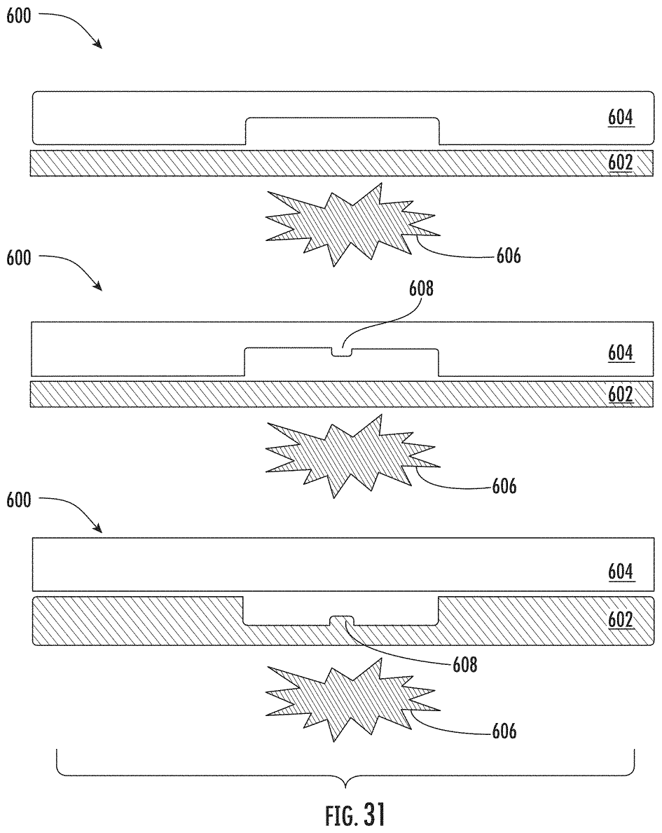

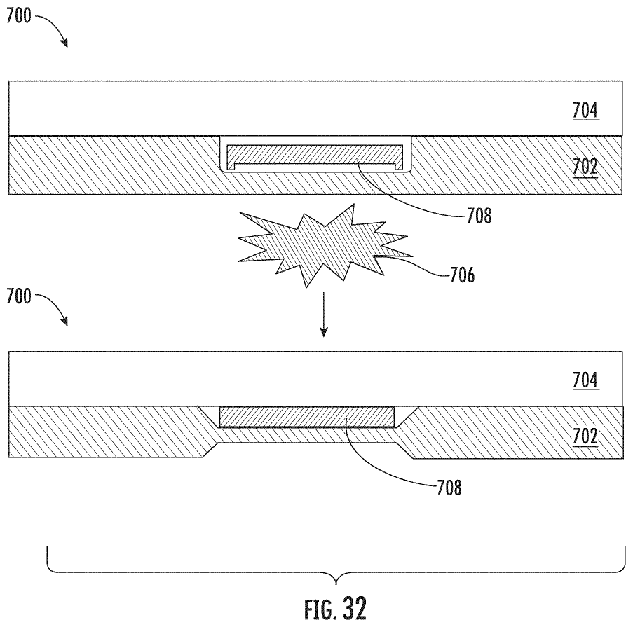

Additional welding configurations with and without wave initiators are shown in FIGS. 31 and 32.

Referring to FIG. 31, top system 600 shows a steel target 604 and a flyer 602 where the ablating material 606 is used to assist in the weld formation. The system does not comprise wave initiators. The middle system 600 shows a target 604 having a wave initiator 608 incorporated within the welding area, and the bottom system 600 has a wave initiator 608 incorporated within the flyer 602.

FIG. 32 shows the presence of the first layer (ablating material) 706 and the second layer 708 of the auxiliary multilayer member, wherein the second layer 708 is positioned between the target 704 and the flyer 702. In this example, the welded product has substantially no deformation on any surface of the target or the flyer outside the welded portion.

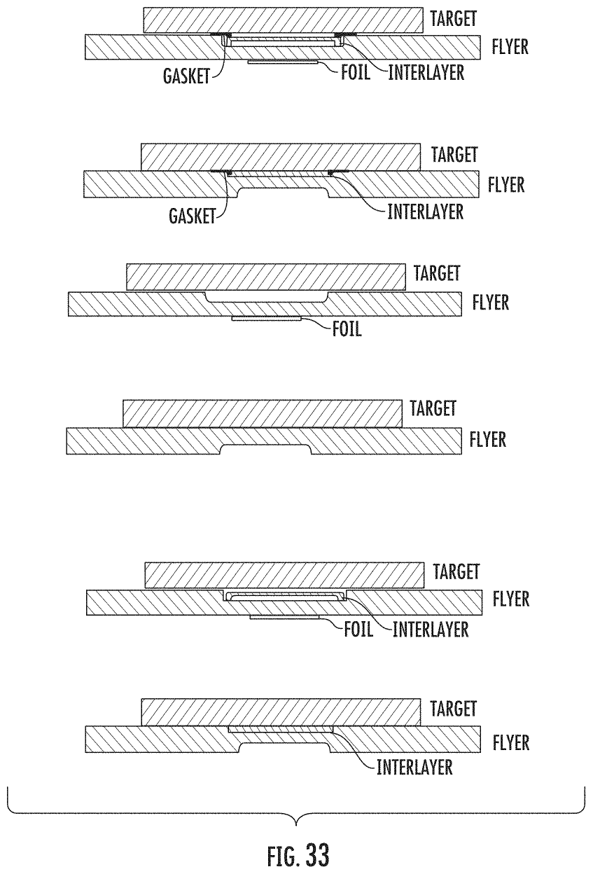

FIG. 33 shows an example where the auxiliary member comprises a first layer (foil) and a second layer (interlayer).

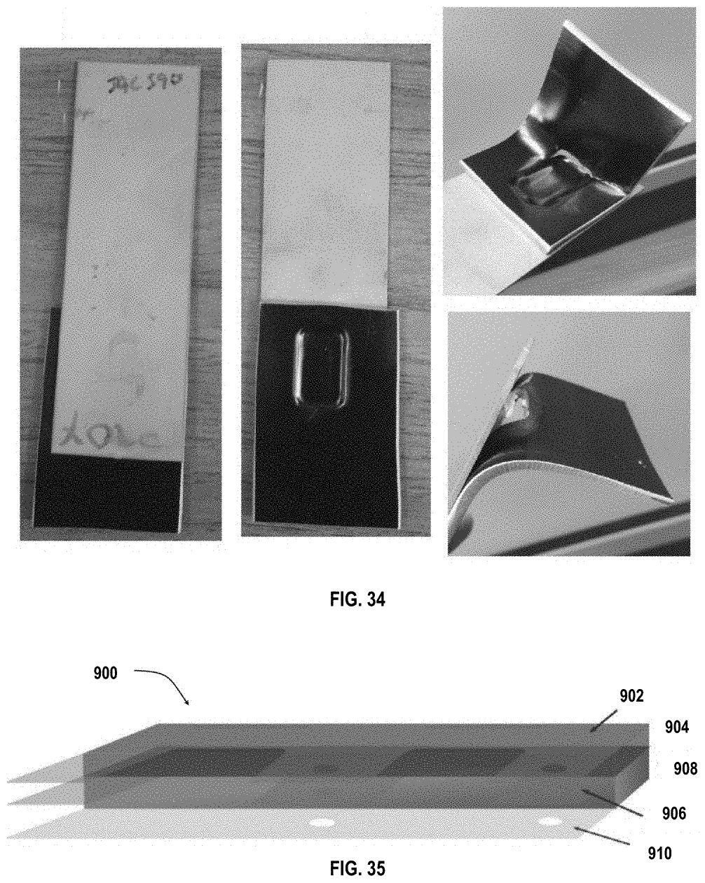

FIG. 34 shows exemplary photographs of the welds obtained by the disclosed herein methods.

### Example 7

FIG. 35 shows a system 900 comprising an exemplary auxiliary multilayer member, a flyer, and a target. The auxiliary multilayer member has a first layer (foil) 902 positioned on flyer 904. An interlayer 906 is positioned between the flyer 904 and the target 908. This exemplary auxiliary multilayer member further comprises a third layer 910 that, in this example, is represented by an alignment marker.

### Example 8

FIG. 36 shows a system where a single capacitor bank simultaneously vaporizes a plurality of foils (the first layer of the auxiliary multilayer member). This can be done with foils in parallel or series circuits or using multiple capacitor banks switched to separate foils.

FIG. 37 shows an exemplary method of forming ready to weld flyer material by casting, masking and coating. A pre-made interlayer insert can be used with a built-in gasket to hermetically seal the joint after the welding is completed.

The above specification and examples provide a complete description of the structure and use of illustrative embodiments. Although certain embodiments have been described above with a certain degree of particularity or with reference to one or more individual embodiments, those skilled in the art could make numerous alterations to the disclosed embodiments without departing from the scope of this invention. As such, the various illustrative embodiments of the devices are not intended to be limited to the particular forms disclosed. Rather, they include all modifications and alternatives falling within the scope of the claims, and embodiments other than the one shown may include some or all of the features of the depicted embodiment. For example, components may be omitted or combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

### REFERENCES

The Minerals, Metals & Materials Society (TMS), 2018, Harnessing Materials Innovations to Support Next Generation Manufacturing Technologies.
Lou M, Li Y, Wang Y, Wang B, Lai X., Influence of resistance heating on self-piercing riveted dissimilar joints of AA6061-T6 and galvanized DP590. Journal of Materials Processing Technology 214, no. (10) (2014): 2119-2126.
Beals R, Conklin J, Skszek T, Zaluzec M, Wagner D., Aluminum High Pressure Vacuum Die Casting Applications for the Multi Material Lightweight Vehicle Program (MMLV) Body Structure. In Light Metals, 2015; 215-221. Springer, Cham.
Conklin J, Beals R, Brown Z., BIW design and CAE (No. 2015-01-0408). SAE Tech. Pap. 2015.
Smith K, Zhang Y., MMLV: corrosion design and testing (No. 2015-01-0410). SAE Tech. Pap. 2015.
Sun X, Stephens E V, Khaleel M A, Shao H, Kimchi M., Resistance spot welding of aluminum alloy to steel with transition material—from process to performance-part I: experimental study. Weld. J. 2004; 83: 188-S.
Qiu R, Satonaka S, Iwamoto C., Effect of interfacial reaction layer continuity on the tensile strength of resistance spot welded joints between aluminum alloy and steels. Mater. Design. 2009; 30(9): 3686-89.
Abe Y, Kato T, Mori K, Self-piercing riveting of high tensile strength steel and aluminium alloy sheets using conventional rivet and die. J. Mater. Process. Technol. 2009; 209(8): 3914-22.
Qiu R, Iwamoto C, Satonaka S., Interfacial microstructure and strength of steel/aluminum alloy joints welded by resistance spot welding with cover plate. J. Mater. Process. Technol. 2009; 209(8): 4186-93.
Qiu R, Iwamoto C, Satonaka, S., The influence of reaction layer on the strength of aluminum/steel joint welded by resistance spot welding. Mater. Charact. 2009; 60(2): 156-9.
Cai W, Daehn G, Vivek A, Li J, Khan H, Mishra R S Komarasamy M., A state-of-the-art review on solid-state metal joining. J. Manuf. Sci. Eng. 2019; 141(3).
Haghshenas M, Gerlich A P., Joining of automotive sheet materials by friction-based welding methods: a review. Eng. Sci. Technol. Int J. 2018; 21(1): 130-48.
Gullino A, Matteis P, D'Aiuto F., Review of aluminum-To-steel welding technologies for car-body applications. Metals, 2019; 9(3): 315.
Thurston B P, Vivek A, Nirudhoddi B S, Daehn G S., Vaporizing foil actuator welding. MRS Bull. 2019; 44(8): 637-42.
Mirza F A, Macwan A, Bhole S D, Chen D L, Chen X G., Microstructure, tensile and fatigue properties of ultrasonic spot-welded aluminum to galvanized high-strength-low-alloy and low-carbon steel sheets. Mater. Sci. Eng., A. 2017; 690: 323-36.
Macwan A, Kumar A, and Chen D L., Ultrasonic spot welded 6111-T4 aluminum alloy to galvanized high-strength low-alloy steel: Microstructure and mechanical properties. Mater. Design. 2017; 113: 284-96.
Wu F, Gibbs J, Kleinbaum S, Schutte C., FY2017 Materials Annual Progress Report, 398-417, United States.
Kapil A, Lee T, Vivek A, Bockbrader J, Abke T, Daehn G., Benchmarking strength and fatigue properties of spot impact welds, J. Mater. Process. Technol. 2018; 255: 219-33.
Kapil A, Lee T, Vivek A, Cooper R, Hetrick E, Daehn G., Spot impact welding of an age-hardening aluminum alloy: Process, structure and properties. J. Manuf. Process. 2019; 37: 42-52.
Vivek A, Hansen S R, Liu B C, Daehn G S., Vaporizing foil actuator: A tool for collision welding. J. Mater. Process. Technol. 2013; 213(12): 2304-11.
Vivek A, Wight S M, Lee T, Taber G A, Daehn G S., Low-Energy Impact Spot Welding of High-Strength Aluminum Alloys. Weld. J. 2016; 95(2): 32-4.
Liu B, Vivek A, Lin W, Prothe C, Daehn G S., Solid-state dissimilar joining of Ti—Fe with Nb and Cu interlayers. Weld. J. 2015; 94(7): 219s-24s.
Zhang W, Sun D, Han L, Liu D., Interfacial microstructure and mechanical property of resistance spot welded joint of high strength steel and aluminium alloy with 4047 AlSi12 interlayer. Mater. Design. 2014; 57: 186-94.
Chen J, Yuan X, Hu Z, Li T, Wu K, Li C, Improvement of resistance-spot-welded joints for D P 600 steel and A5052 aluminum alloy with Zn slice interlayer. J. Manuf. Process. 2017; 30: 396-405.
Watanabe T, Sakuyama H, Yanagisawa A., Ultrasonic welding between mild steel sheet and Al—Mg alloy sheet. J. Mater. Process. Technol. 2009; 209(15-16): 5475-80.
Lee T, Mao Y, Gerth R, Vivek A, Daehn G., Civilized explosive welding: Impact welding of thick aluminum to steel plates without explosives. J. Manuf. Process. 2018; 36: 550-556.
Carvalho GHSFL, Galväo I, Mendes R, Leal R M, Loureiro, A, Microstructure and mechanical behaviour of aluminium-carbon steel and aluminium-stainless steel clads produced with an aluminium interlayer. Mater. Charact. 2019; 155: 109819.
Izuma T, Hokamoto K, Fujita M, Aoyagi M., Single-shot explosive welding of hard-to-weld A5083/SUS304 clad using SUS304 intermediate plate, Weld. Int. 1992; 6(12): 941-6.
Saravanan S, Raghukandan K., Influence of interlayer in explosive cladding of dissimilar metals. Mater. Manuf. Process. 2013; 28(5): 589-94.
Chen S, Huang J, Ma K, Zhang H, Zhao X., Influence of a Ni-foil interlayer on Fe/Al dissimilar joint by laser penetration welding. Mater. Lett. 2012; 79: 296-99.
Manikandan P, Hokamoto K, Fujita M, Raghukandan K, Tomoshige R., Control of energetic conditions by employing interlayer of different thickness for explosive welding of titanium/304 stainless steel. J. Mater. Process. Technol. 2008; 195(1-3): 232-40.
Manikandan P, Hokamoto K, Deribas A A, Raghukandan K, Tomoshige R., Explosive welding of titanium/stainless steel by controlling energetic conditions. Mater. Trans. 2006; 47(8): 2049-55.
Mahmood Y, Guo B, Chen P, Zhou Q, Bhatti A A., Numerical study of an interlayer effect on explosively welded joints. Int. J. Multiphys. 2020; 14(1).
Saravanan S, Raghukandan K, Hokamoto K., Improved microstructure and mechanical properties of dissimilar explosive cladding by means of interlayer technique. Arch. Civ. Mech. Eng. 2016; 16(4): 563-8.
Izuma T, Hokamoto K, Fujita M, Niwatsukino T., Improvement of bond strength of Al/Cu transition joints made by a single-shot explosive welding technique using a Cu intermediate plate. Weld. Int. 1994; 8(8): 618-22.
Blazynski T Z., Explosive welding, forming and compaction, Springer Science & Business Media. 2012; 10.1007/978-94-011-9751-9.
Pouranvari M, Marashi S P H., Failure of resistance spot welds: tensile shear versus coach peel loading conditions. Ironmak. Steelmak. 2012; 39(2): 104-11.
Chen N, Wang H P, Carlson B E, Sigler D R, Wang M., Fracture mechanisms of A/steel resistance spot welds in coach peel and cross tension testing. J. Mater. Process. Technol. 2018; 252: 348-61.
Arghavani M R, Movahedi M, Kokabi A H., Role of zinc layer in resistance spot welding of aluminium to steel. Mater. Design. 2016; 102:106-14.
Liu Y, Bian X, Zhang K, Yang C, Feng L, Kim H S, Guo J., Interfacial microstructures and properties of aluminum alloys/galvanized low-carbon steel under high-pressure torsion. Mater. Design. 2014; 64: 287-93.
Ma J, Harooni M, Carlson B, Kovacevic R, Dissimilar joining of galvanized high-strength steel to aluminum alloy in a zero-gap lap joint configuration by two-pass laser welding. Mater. Design. 2014; 58: 390-401.
Jiang W, Fan Z, Li G, Li C., Effects of zinc coating on interfacial microstructures and mechanical properties of aluminum/steel bimetallic composites. J. Alloy. Compd. 2016; 678: 249-57.
Li J, Schneiderman B, Song S, Gilbert S M, Vivek A, Yu Z, Dong P, Daehn G S., High strength welding of Ti to stainless steel by spot impact: microstructure and weld performance. Int. J. Adv. Manuf. Tech. 2020;
Li J, Schneiderman B, Gilbert S M, Vivek A, Yu Z, Daehn G., Process characteristics and interfacial microstructure in spot impact welding of titanium to stainless steel. J. Manuf. Process. 2020; 50: 421-9.
Lee T, Zhang S, Vivek A, Daehn G, Kinsey B, Wave formation in impact welding: Study of the Cu—Ti system. CIRP Ann-Manuf. Techn. 2019; 68(1): 261-264.
Kumar, P., and Sinha, A. N, Studies of temperature distribution for laser welding of dissimilar thin sheets through finite element method, Journal of the Brazilian Society of Mechanical Sciences and Engineering 40, no. (9) (2018): 455.
Kumar, P., Sinha, A. N., Effect of pulse width in pulsed Nd: YAG dissimilar laser welding of austenitic stainless steel (304 L) and carbon steel (st37), Lasers in Manufacturing and Materials Processing 5, no. (4) (2018): 317-334.
Haddadi, F., Strong, D. and Prangnell, P. B., Effect of zinc coatings on joint properties and interfacial reactions in aluminum to steel ultrasonic spot welding, JOM 64, no. (3) (2012): 407-413.
Chen, N., Wang, H. P., Wang, M., Carlson, B. E. et al., Schedule and electrode design for resistance spot weld bonding Al to steels, Journal of Materials Processing Technology 265, (2019): 158-172.
Rao, H. M., Kang, J., Shi, L., Sigler, D. R. et al., Effect of specimen configuration on fatigue properties of dissimilar aluminum to steel resistance spot welds, International Journal of Fatigue 116, (2018): 13-21.
Chen, N., Wang, H. P., Carlson, B. E., Sigler, D. R. et al., Fracture mechanisms of Al/steel resistance spot welds in coach peel and cross tension testing, Journal of Materials Processing Technology 252, (2018): 348-361.
Chen, J., Feng, Z., Wang, H. P., Carlson, B. E. et al., Multi-scale mechanical modeling of Al-steel resistance spot welds, Materials Science and Engineering: A 735, (2018): 145-153.
Zhang, G., Zhao, H., Xu, X., Qiu, G. et al., Metallic bump assisted resistance spot welding (MBaRSW) of AA6061-T6 and Bare DP590: Part II-joining mechanism and joint property, Journal of Manufacturing Processes 44, (2019): 19-27.
Lei, H., Li, Y., Carlson, B. E. and Lin, Z., Cold metal transfer spot joining of AA6061-T6 to galvanized DP590 under different modes, Journal of Manufacturing Science and Engineering 137, no. 5 (2015): 051028-1-051028-10.
Lei, H., Li, Y., Carlson, B. E. and Lin, Z., Microstructure and mechanical performance of cold metal transfer spot joints of AA6061-T6 to Galvanized DP590 using edge plug welding mode, Journal of Manufacturing Science and Engineering 138, no. 7 (2016): 071009-1-071009-13.
Shen, Z., Chen, J., Ding, Y., Hou, J. et al., Role of interfacial reaction on the mechanical performance of Al/steel dissimilar refill friction stir spot welds, Science and Technology of Welding and Joining 23, no. 6 (2018): 462-477.
Zhou, W., Ai, S., Chen, M., Zhang, R. et al., Preparation and thermodynamic analysis of the porous ZrO2/(ZrO2+Ni) functionally graded bolted joint, Composites Part B: Engineering 82, (2015): 13-22.
Zhou, W., Zhang, R., Ai, S., He, R. et al., Load distribution in threads of porous metal-ceramic functionally graded composite joints subjected to thermomechanical loading, Composite Structures, 134, (2015): 680-688.
Zhou, W., Zhang, R., and Fang, D., Design and analysis of the porous ZrO2/(ZrO2+Ni) ceramic joint with load bearing-heat insulation integration, Ceramics International 42, no (1) (2016): 1416-1424.
Vivek, A., Liu, B. C., Hansen, S. R., Daehn, G. S., Accessing collision welding process window for titanium/copper welds with vaporizing foil actuators and grooved targets. Journal of Materials Processing Technology 214, no. 8 (2014): 1583-1589.
Gupta, V., Lee, T., Vivek, A., Choi, K. S. et al., A robust process-structure model for predicting the joint interface structure in impact welding, Journal of Materials Processing Technology 264, (2019): 107-118.
Nassiri, A., Chini, G., Vivek, A., Daehn, G. et al., Arbitrary Lagrangian-Eulerian finite element simulation and experimental investigation of wavy interfacial morphology during high velocity impact welding, Materials & Design 88, (2015): 345-358.
Meschut G, Matzke M, Hoerhold R, Olfermann T., Hybrid technologies for joining ultra-high-strength boron steels with aluminum alloys for lightweight car body structures. Procedia Cirp 2014; 23(19):10-1016.
Lu Y, Walker L, Kimchi M, Zhang, W., Microstructure and Strength of Ultrasonic Plus Resistance Spot Welded Aluminum Alloy to Coated Press Hardened Boron Steel. Metall Mater Trans A 2020; 51(1): 93-8.
Meschut G, Janzen V, Olfermann T., Innovative and highly productive joining technologies for multi-material lightweight car body structures. J Mater Eng Perform 2014; 23(5): 1515-23.
Ding Y, Shen Z, Gerlich A P., Refill friction stir spot welding of dissimilar aluminum alloy and AlSi coated steel. J Manuf Process 2017; 30: 353-360.
Shen Z, Ding Y, Chen J, Amirkhiz B S, Wen J Z, Fu L, Gerlich A P., Interfacial bonding mechanism in Al/coated steel dissimilar refill friction stir spot welds. J Mater Sci Technol 2019; 35(6): 1027-38.
Da Silva A A M, Aldanondo E, Alvarez P, Arruti E, Echeverria A., Friction stir spot welding of AA 1050 Al alloy and hot stamped boron steel (22MnB5). Sci Technol Weld Joi 2010; 15(8): 682-7.
Oliveira J P, Ponder K, Brizes E, Abke T, Edwards P, Ramirez A J., Combining resistance spot welding and friction element welding for dissimilar joining of aluminum to high strength steels. J Mater Process Tech 2019; 273, 116192.
Lee C J, Lee J M, Ryu H Y, Lee K H, Kim B M, Ko D C., Design of hole-clinching process for joining of dissimilar materials-A16061-T4 alloy with DP780 steel, hot-pressed 22MnB5 steel, and carbon fiber reinforced plastic. J Mater Process Tech 2014; 214(10): 2169-78.
Hörhold R, Müller M, Merklein M, Meschut G., Mechanical properties of an innovative shear-clinching technology for ultra-high-strength steel and aluminium in lightweight car body structures. Weld World 2016; 60(3): 613-20.
Ling Z, Li Y, Luo Z, Feng Y, Wang Z., Resistance element welding of 6061 aluminum alloy to uncoated 22MnMoB boron steel. Mater Manuf Process, 2016; 31(16): 2174-80.
Zvorykina A, Sherepenko O, Neubauer M, Jüttner S., Dissimilar metal joining of aluminum to steel by hybrid process of adhesive bonding and projection welding using a novel insert element. J Mater Process Tech 2020; 116680.
Liu B, Vivek A, Presley M, Daehn G S., Dissimilar impact welding of 6111-T4, 5052-H32 aluminum alloys to 22MnB5, DP980 steels and the structure-property relationship of a strongly bonded interface. Metall Mater Trans A 2018; 49(3): 899-907.
Chau H H, Dittbenner G, Hofer W W, Honodel C A, Steinberg D J, Stroud J R, Weingart R C, Lee R S., Electric gun: a versatile tool for high-pressure shock-wave research. Rev Sci Instrum 1980: 51(12): 1676-1681.
Vivek A, Taber G A, Johnson J R, Woodward S T, Daehn G S., Electrically driven plasma via vaporization of metallic conductors: A tool for impulse metal working. J Mater Process Tech 2013; 213(8): 1311-1326.

What is claimed is:

1. A method for producing an impact weld between a first metal part and a second metal part, comprising:
providing the first metal part having a first surface and an opposed second surface; wherein the first metal part has a first central axis positioned along the length of the first metal part;
providing the second metal part having a first surface and an opposed second surface; wherein the second metal part has a second central axis positioned along the length of the second metal part;
wherein the first metal part has a thickness t₁ and density ρ₁ that are substantially similar or smaller than a thickness t₂ and density ρ₂ of the second metal part respectively;
positioning the first surface of the first metal part to overlay the second surface of the second metal part such that
i) substantially no gap is formed between at least a first portion of the first surface of the first metal part and at least a second portion of the second surface of the second metal part; or
ii) wherein a gap is formed between the at least the first portion of the first surface of the first metal part and the at least the second portion of the second surface of the second metal part;
wherein the first portion is defined by a first dimension and wherein the second portion is defined by a second dimension;
positioning an auxiliary multilayer member having a third dimension such that a first layer of the auxiliary multilayer member at least partially overlays at least a portion of the second surface of the first metal part and wherein the third dimension is projected onto a plane parallel to the first surface of the first metal part and is within the first dimension of the first portion;
accelerating an outer surface of the first layer of the auxiliary multilayer member that at least partially overlays at least a portion of the second surface of the first metal part, thereby directing the first portion of the first surface of the first metal part toward the second portion of the second surface of the second metal part to form a metallurgical bond;
wherein the auxiliary multilayer member is consumable; and
wherein the first surface of the second metal part substantially is not altered after the metallurgical bond is formed.

2. (canceled)

3. The method of claim 1, wherein at least a portion of the second portion of the second surface of the second metal part is has a roughness having an aspect ratio smaller than or equal to t₁.

4. (canceled)

5. The method of claim 1, wherein the step of accelerating comprises imparting to at least a portion of the auxiliary multilayer member and at least a portion of the first metal part a speed from about 200 m/s to about 800 m/s towards at least a portion of the second metal.

6. The method of claim 1, further comprising accelerating the first surface of the second metal part.

7. The method of claim 6, wherein the step of accelerating the first surface of the second metal part comprises imparting to at least a portion of the second metal part a speed from about 200 m/s to about 800 m/s.

8. The method of claim 6, wherein accelerating the first surface of the second metal part is done simultaneously with the accelerating of the outer surface of the first layer of the auxiliary multilayer member.

9.-12. (canceled)

13. The method of claim 1, wherein at least a portion of the first surface and/or the second surface of the first metal part comprises a first coat layer, wherein when at least a portion of the first surface and the second surface has the first coat layer, the first coat layer of the first surface is the same or different as the first coat layer of the second surface, and is selected from an e-coating, a galvanized coating, galvannealed coating, paint, adhesive, sealant, or any combination thereof, and/or
wherein at least a portion of the first surface and/or the second surface of the second metal part comprises a second coat layer, wherein when at least a portion of the first surface and the second surface has the second coat layer, the second coat layer of the first surface is the same or different as the second coat layer of the second surface, and is selected from an e-coating, a galvanized coating, galvannealed coating, paint, adhesive, sealant or any combination thereof; and wherein the first coat layer and the second coat layer are the same or different; and
and/or wherein the first coat layer present on the first surface of the first metal part outside of the first dimension of the first portion of the first surface of the first metal part is substantially undamaged after the metallurgical bond is formed;
and/or wherein the second coat layer present on the second surface of the second metal part outside of the second dimension of the second portion of the second surface of the second metal part is substantially undamaged after the metallurgical bond is formed.

14.-20. (canceled)

21. The method of claim 1, wherein the auxiliary multilayer member is preformed to provide the third dimension that is effective to align the first metal part and the second metal part such that substantially no deformation is furnished to any portion of the first surface and/or the second surface of the first metal part and/or the first surface and/or the second surface of the second metal part outside of the first portion of the first surface of the first metal part and the second portion of the second surface of the second metal part where the metallurgical bond is formed.

22.-29. (canceled)

30. The method of claim 1, wherein the first metal part and/or the second metal part are annealed prior to the step of accelerating.

31. (canceled)

32. The method of claim 1, wherein the step of accelerating comprises utilizing an energy source, wherein the energy source comprises an electrical current, laser, electromagnetic source, detonation of an explosive and/or energetic material, electromagnetic repulsion, projectile of gun powder, spring projectile, or a combination thereof, and wherein the energy source provides energy from about 1 J to about 300 kJ.

33.-35. (canceled)

36. The method of claim 1, wherein the first portion and/or the second portion are aligned at an angle relative to each other, and wherein the angle is in the range of from about 2 to about 40 degrees.

37.-42. (canceled)

43. The method of claim 36 wherein the energy source is aligned relative to the first portion and/or the second portion such that an energy pulse supplied by the energy source is substantially normal to the first portion and/or the second portion.

44. (canceled)

45. The method of claim 1, wherein the first portion and/or the second portion are asymmetrically bent to form two or more segments having one or more angles relative to the first central axis of a reminder of the first metal part and/or the second central axis of a reminder of the second metal part respectively, and wherein each segment has an angle in the range of from about 2 degrees to about 40 degrees relative to the first central axis of the remainder of the first metal part or to the second central axis of the remainder of the second metal part respectively.

46. (canceled)

47. (canceled)

48. The method of claim 1, wherein the first layer of the auxiliary multilayer member that at least partially overlays at least a portion of the second surface of the first metal part is an ablative material configured to vaporize during accelerating step, and wherein the first layer of the auxiliary multilayer member has a thickness from about 10 μm to about 10 mm, and wherein the first layer comprises aluminum, steel, copper, magnesium, zinc, or any combination thereof.

49. (canceled)

50. (canceled)

51. The method of claim 1, wherein the outer surface of the first layer of the auxiliary multilayer member that at least partially overlays at least a portion of the second surface of the first metal part comprises an insulating coating.

52. (canceled)

53. The method of claim 1, wherein the auxiliary multilayer member further comprises a second layer configured to be positioned between the first portion of the first metal part and the second portion of the metal part, and wherein the second layer comprises a metal, adhesive material, sealing material, or any combination thereof.

54. (canceled)

55. (canceled)

56. (canceled)

57. The method of claim 53, wherein the second layer comprises one or more alignment features.

58. (canceled)

59. The method of claim 1, wherein the auxiliary multilayer member comprises a third layer configured to overlay at least a portion of the first surface of the second metal part, and wherein the third layer comprises a metal, a polymer, an elastomer, a cushioning material, or any combination thereof.

60. (canceled)

61. (canceled)

62. (canceled)

63. (canceled)

64. (canceled)

65. (canceled)

66. The method of claim 1, wherein when the gap is formed between the at least the first portion of the first surface of the first metal part and the at least the second portion of the second surface of the second metal part, the method comprises insertion one or more spacers configured to maintain the gap, and wherein the one or more spacers are further configured to provide one or more alignment features, corrosion seal, an interconnecting material.

67.-91. (canceled)

92. An auxiliary multilayer member having an overall predetermined dimension and configured to assist in a welding process comprising:
a first layer having a first dimension and comprising an ablating material, wherein the first layer is configured to be positioned on an outermost surface of a first metal part;
a second layer having a second dimension and comprising aluminum, steel, copper, magnesium, zinc, or any combination thereof, wherein the second layer is configured to be positioned between an inner surface of the first metal part and an inner surface of a second metal part;
and wherein the first layer is configured to absorb the energy needed to form a metallurgical bond between the inner surface of the first metal part and the inner surface of the second metal part.

93. (canceled)

94. The auxiliary multilayer member of claim 92, wherein the first layer has a thickness from about 10 μm to about 10 mm and/or wherein the second layer has a thickness from about 10 μm to about 10 mm.

95. The auxiliary multilayer member of claim 92, wherein the ablating material is configured to evaporate when kinetic energy as measured from 1 to 1000 kJ/cm² is imparted to the outermost surface of the first layer.

96. The auxiliary multilayer member of claim 92, wherein the outer surface of the outermost layer comprises an insulating coating.

97. (canceled)

98. (canceled)

99. The auxiliary multilayer member of claim 92, further comprising a third layer having a third dimension, wherein the third layer is configured to be positioned on an outermost surface of the second metal part.

100.-127. (canceled)

128. A system comprising:
a) a first metal part having a first surface and an opposed second surface; wherein the first metal part has a first central axis positioned along the length of the first metal part;
b) a second metal part having a first surface and an opposed second surface; wherein the second metal part has a second central axis positioned along the length of the second metal part;
wherein the first metal part has a thickness t₁ and density ρ₁ that are substantially similar or smaller than a thickness t₂ and density ρ₂ of the second metal part respectively;
wherein the first surface of the first metal part overlays the second surface of the second metal part such that
i) substantially no gap is formed between at least a first portion of the first surface of the first metal part and at least a second portion of the second surface of the second metal part; or
ii) wherein a gap is formed between the at least the first portion of the first surface of the first metal part and the at least the second portion of the second surface of the second metal part;
wherein the first portion is defined by a first dimension and wherein the second portion is defined by a second dimension;
c) an auxiliary multilayer member having a third dimension such that a first layer of the auxiliary multilayer member at least partially overlays at least a portion of the second surface of the first metal part and wherein the third dimension is projected onto a plane parallel to the first surface of the first metal part and is within the first dimension of the first portion; and
d) an energy source configured to accelerate an outer surface of the first layer of the auxiliary multilayer member that at least partially overlays at least a portion of the second surface of the first metal part and to direct the first portion of the first surface of the first metal part toward the second portion of the second surface of the second metal part and thereby to form a metallurgical bond.

129. A method for producing an impact weld between a first metal part and a second metal part, comprising:
providing a first metal part having a first surface and an opposed second surface and a second metal part having a first surface and an opposed second surface;
positioning the first metal part and the second metal part such that the first surface of the first metal is facing the second surface of the second metal part and wherein a first portion of the first surface of the first part and a first portion of the second surface of the second metal part form a gap;
wherein the first portion of the first surface is defined by a first area and the first portion of the second surface is defined by a second area;
directing an energy source to the second surface of the first metal part at a predetermined location, such that the energy emitted from the energy source is applied to a second portion of the second surface of the first metal part, wherein the second portion of the second surface is defined by the first area when it is projected to the second surface; and
accelerating the first portion of the first surface across the gap to form a metallurgical bond with the first portion of the second surface of the second metal part.

130. The method of claim 129, wherein the gap is formed by a recession within the first portion of the second surface of the second metal part or wherein the gap is formed by insertion of one or more spacers between the first portion of the first surface of the first metal part and the first portion of the second surface of the second metal part.

131. (canceled)

132. The method of claim 129, wherein the first metal part has at least two segments, wherein a first segment has a main axis and wherein a second segment is bent at a predetermined angle relative to the main axis of the first segment and/or wherein the second metal has at least one segment.

133. The method of claim 132, wherein the first portion of the first surface of the first metal is positioned within the second segment of the first metal.

134. (canceled)

135. The method of claim 132, wherein when the second metal has one segment, the segment is planar and is positioned substantially parallel to the main axis of the first segment of the first metal part or wherein the second metal has at least two segments, and wherein a first segment of the second metal part has a main axis and wherein a second segment of the second metal part bent at a predetermined angle relative to the main axis of the first segment of the second metal part; and wherein the gap is not uniform and is defined by a narrow portion and a wide portion and ranges from about 0.1 mm to about 5 mm.

136. (canceled)

137. (canceled)

138. (canceled)

139. (canceled)

140. The method of claim 129, further comprising an auxiliary multilayer member overlying the second portion of the second surface of the first metal part.

141. The method of claim 140, wherein the auxiliary multilayer member overlies the second segment of the first metal part.

142. The method of claim 140, wherein the auxiliary multilayer member comprises a first layer that is at least partially transparent.

143. (canceled)

144. The method of claim 140, wherein the first layer of the auxiliary multilayer member is a high shock impedance material comprising glycerin, water, or a combination thereof.

145. (canceled)

146. (canceled)

147. The method of claim 140, wherein the auxiliary multilayer member further comprises a second layer and wherein the second layer is interposed between the first layer of the auxiliary multilayer member and the second surface of the first metal part, and wherein the second layer comprises sodium azide, nitromethane comprising material, one or more oxidants or oxidizing materials, or any combination thereof.

148. (canceled)

149. (canceled)

150. The method of claim 144, wherein the first and/or the second layers of the auxiliary multilayer members are formed in-situ by providing a first stream of glycerin, water or a combination thereof and a second stream of sodium azide, nitromethane comprising material, one or more oxidants or oxidizing materials, or any combination thereof.

151. (canceled)

152. (canceled)

153. (canceled)

154. The method of claim 129, wherein the energy source is a laser capable of emitting light in a predetermined range of wavelength and wherein the laser emits from about 1 to about 100 joules per microsecond.

155. (canceled)

156. (canceled)

157. (canceled)

158. The method of claim 132, wherein the energy source is directed to the second surface of the first metal for a first duration and/or wherein the energy source is aligned relative to the second segment of the first metal part such that the emitted energy is substantially normal to the bent segment of the first metal part.

159. (canceled)

160. The method of claim 129, wherein the step of accelerating the at least a portion of the first surface across the gap to form a metallurgical bond with the at least a portion of the second surface of the second metal part occurs at a predetermined collision speed.

161. (canceled)

162. (canceled)

163. (canceled)

164. The method of claim 1, wherein
the first metal comprises two or more first portions and a second metal comprises two or more second portions;
wherein two or more auxiliary members are positioned such that the first layer of each of the two or more auxiliary multilayer members at least partially overlays at least a portion of the second surface of the first metal part and wherein the third dimension is projected onto a plane parallel to the first surface of the first metal part and is within the first dimension of each of the two or more first portions;
accelerating the outer surface of the first layer of each of the two or more auxiliary multilayer members that at least partially overlays at least a portion of the second surface of the first metal part, thereby directing each of the two or more first portions of the first surface of the first metal part toward each of the two or more second portions of the second surface of the second metal part to form two or more metallurgical bonds, respectively;
wherein accelerating of each of the two or more auxiliary multilayer members is done simultaneously;
wherein the auxiliary multilayer member is consumable; and
wherein the first surface of the second metal part substantially is not altered after the metallurgical bond is formed.
